(19) United States
(12) Patent Application Publication
(10) Pub. No.: US 2026/0267327 A1
(43) Pub. Date: Sep. 10, 2026

(54) SYSTEMS AND METHODS FOR REAL-TIME DETECTION OF ASSET PERFORMANCE DEGRADATION USING SENSOR-AGGREGATED TELEMETRY AND PEER-NORMALIZED EDGE INFERENCE

(71) Applicant: SAS INSTITUTE INC., Cary, NC (US)

(72) Inventors: Thomas Dale Anderson, Peoria, AZ (US); Bahar Biller, Carmel, IN (US); Shahrzad Azizzadeh, Apex, NC (US); Paul Venditti, Clifton Park, NY (US); Hardi Desai, Dunellen, NJ (US); Jonathan Lee Walker, Raleigh, NC (US); Varunraj Valsaraj, Cary, NC (US); Jinxin Yi, Cary, NC (US)

(73) Assignee: SAS Institute Inc., Cary, NC (US)

(21) Appl. No.: 19/442,274

(22) Filed: Jan. 7, 2026

Related U.S. Application Data
(60) Provisional application No. 63/827,797, filed on Jun. 20, 2025.

(30) Foreign Application Priority Data
Mar. 10, 2025 (IN) 202511021435

(51) Int. Cl. G05B 23/02

(52) U.S. Cl. CPC G05B 23/0283; G05B 23/0232; G05B 23/0264

(57) ABSTRACT

A system, method, and computer-program product includes receiving sensor data associated with one or more assets; computing a plurality of enriched features for the one or more assets; generating an analytical data structure including feature values of the plurality of enriched features and the plurality of sensor features for the one or more assets; generating, using an anomaly detection model and an asset performance prediction model, an asset performance output data structure extending the analytical data structure to include anomaly score values and predicted asset performance values; inserting, into the asset performance output data structure, performance disparity values computed based on the predicted asset performance values; detecting that a subset of the performance disparity values or of the anomaly score values satisfy one or more alerting thresholds; and generating, an asset maintenance alert for one or more assets associated with the detected subset.

### CROSS-REFERENCE TO RELATED APPLICATIONS

This application claims the benefit of priority to U.S. Patent Application No. 63/827,797, filed on Jun. 20 2025, and Indian Patent Application number 202511021435, filed on Mar. 10, 2025, each incorporated herein by reference in their entirety for all purposes.

### TECHNICAL FIELD

The embodiments described herein relate generally to computer-implemented monitoring and analytics systems and, more specifically, to systems and methods for asset anomaly detection and management.

### BACKGROUND

Industrial facilities (e.g., energy generation facilities) commonly include large numbers of distributed physical assets operating under variable environmental and operational conditions. Such assets may include turbines, generators, inverters, transformers, and associated subsystems instrumented with sensors that produce time-series data indicative of operational state, environmental conditions, and energy output. Effective monitoring of such assets enables maintaining of operational efficiency, reduced unplanned downtime, and extended asset service life.

Conventional asset monitoring approaches may rely on static thresholds, rule-based alarms, or retrospective analysis of historical data. Such approaches may fail to account for complex interactions among sensor measurements, evolving operating regimes, and gradual degradation patterns. As a result, abnormal behavior may not be detected until after a failure has occurred, leading to delayed maintenance actions.

### BRIEF SUMMARY OF THE INVENTION(S)

In some embodiments, a computer-program product may comprise a non-transitory machine-readable storage medium storing computer instructions that, when executed by processing circuitry, perform operations comprising: receiving, by the processing circuitry, sensor data associated with one or more assets in a target asset hierarchy; computing, by the processing circuitry, a plurality of enriched features for the one or more assets based on a plurality of sensor features included in the sensor data; generating, by the processing circuitry, an analytical data structure comprising feature values of the plurality of enriched features and the plurality of sensor features for the one or more assets over a time series; generating, by the processing circuitry using an anomaly detection model, an anomaly output data structure that extends the analytical data structure to include a set of anomaly score values corresponding to the one or more assets over the time series; generating, by the processing circuitry using an asset performance prediction model, an asset performance output data structure that extends the anomaly output data structure to include a plurality of predicted asset performance values for the one or more assets over the time series; inserting, into the asset performance output data structure by the processing circuitry, a plurality of performance disparity values computed based on the plurality of predicted asset performance values and the feature values of a respective sensor feature of the plurality of sensor features in the asset performance output data structure; detecting, by the processing circuitry using the asset performance output data structure, that a subset of the plurality of performance disparity values or a subset of the set of anomaly score values in the asset performance output data structure satisfy one or more alerting thresholds; and generating, by the processing circuitry, an asset maintenance alert for one or more assets associated with the subset of the plurality of performance disparity values or the subset of the set of anomaly score values in the asset performance output data structure.

In some embodiments, the computer instructions, when executed by the processing circuitry, perform the operations comprising: training, by the processing circuitry, the anomaly detection model by: generating, by the processing circuitry, a plurality of binary decision trees based on a corpus of historical sensor data associated with the one or more assets, determining, by the processing circuitry, an average path length associated with one or more respective historical sensor records of the corpus across the plurality of binary decision trees, and assigning, by the processing circuitry, an anomaly score value to the one or more respective historical sensor records based on the average path length of the one or more respective historical sensor records.

In some embodiments, the anomaly score value assigned to a first respective historical sensor record of the one or more respective historical sensor records is higher than the anomaly score value assigned to a second respective historical sensor record of the one or more respective historical sensor records when the average path length of the first respective historical sensor record is shorter than the average path length of the second respective historical sensor record, and the anomaly score value assigned to the first respective historical sensor record is lower than the anomaly score value assigned to the second respective historical sensor record when the average path length of the first respective historical sensor record is longer than the average path length of the second respective historical sensor record.

In some embodiments, the average path length of a respective historical sensor record of the one or more respective historical sensor records is determined based on a number of tree node traversals required to assign the respective historical sensor record to a terminal node in each of the plurality of binary decision trees.

In some embodiments, the computer instructions, when executed by the processing circuitry, perform the operations comprising: training, by the processing circuitry, the asset performance prediction model by: inputting, to the asset performance prediction model by the processing circuitry, one or more labeled sensor records comprising: a set of historical feature values associated with the plurality of sensor features and the plurality of enriched features for a respective asset at a respective historical time series value, and a performance label indicating an observed performance of the respective asset at the respective historical time series value; and iteratively fitting, by the processing circuitry, a plurality of decision trees to the one or more labeled sensor records, wherein each subsequent decision tree of the plurality of decision trees is fitted to residual errors associated with performance predictions made by one or more previously fitted decision trees of the plurality of decision trees.

In some embodiments, the analytical data structure comprises: one or more columns that correspond to a respective feature of the plurality of sensor features and the plurality of enriched features, and one or more rows that: corresponds to a respective asset of the one or more assets, corresponds to a respective timestamp of the time series, and includes a subset of the feature values that correspond to the respective asset at the respective timestamp.

In some embodiments, the anomaly output data structure that extends the analytical data structure includes: one or more second columns that corresponds to the one or more columns originating from the analytical data structure and an anomaly score column that stores the set of anomaly score values corresponding to the one or more assets over the time series, and one or more second rows that corresponds to the one or more rows originating from the analytical data structure and updated to include a respective anomaly score value corresponding to the respective asset at the respective timestamp.

In some embodiments, the asset performance output data structure that extends the anomaly output data structure includes: one or more third columns that correspond to: the one or more second columns originating from the anomaly output data structure; and a predicted asset performance column that stores the plurality of predicted asset performance values for the one or more assets over the time series, and one or more third rows corresponding to the one or more second rows originating from the anomaly output data structure and updated to include a respective predicted asset performance value corresponding to the respective asset at the respective timestamp.

In some embodiments, the target asset hierarchy includes: a root node identifying a deployment region associated with the one or more assets, and one or more child nodes corresponding to the one or more assets and hierarchically arranged under the root node.

In some embodiments, the target asset hierarchy further includes: one or more second child nodes hierarchically arranged under the one or more child nodes and correspond to one or more subsystems associated with the one or more assets, and one or more third child nodes hierarchically arranged under the one or more second child nodes and correspond to one or more components associated with the one or more subsystems.

In some embodiments, the sensor data comprises a plurality of time series sensor records received by a real-time or near real-time event streaming service, and a respective time series sensor record of the plurality of time series sensor records includes one or more of: a timestamp associated with the respective time series sensor record, a name of a respective asset associated with the respective time series sensor record, a name of a respective sensor feature associated with the respective time series sensor record, and a value of the respective sensor feature for the respective asset at the timestamp associated with the respective time series sensor record.

In some embodiments, a first plurality of time series sensor records of the sensor data is associated with a first timestamp of the time series and a first asset of the one or more assets, and a second plurality of time series sensor records of the sensor data is: associated with a second timestamp of the time series, different from the first timestamp, and associated with one of: the first asset or a second asset of the one or more assets.

In some embodiments, generating the analytical data structure at least includes: generating a first row of the analytical data structure that corresponds to the first asset at the first timestamp and comprises first features values for the plurality of sensor features included in the first plurality of time series sensor records, and generating a second row of the analytical data structure that corresponds to the first asset or the second asset at the second timestamp and comprises second feature values for the plurality of sensor features included in the second plurality of time series sensor records.

In some embodiments, generating the analytical data structure includes: detecting, by the processing circuitry, that a respective enriched feature of the plurality of enriched features has a first feature value in a first row of the analytical data structure, detecting, by the processing circuitry, that the respective enriched feature of the plurality of enriched features has a second feature value in a second row of the analytical data structure, determining that the first feature value of the respective enriched feature does not satisfy a filtering criterion and that the second feature value of the respective enriched feature satisfies the filtering criterion, in response to determining that the first feature value of the respective enriched feature does not satisfy the filtering criterion, removing the first row from the analytical data structure, and in response to determining that the second feature value of the respective enriched feature satisfies the filtering criterion, maintaining the second row in the analytical data structure.

In some embodiments, a respective performance disparity value of the plurality of performance disparity values: is computed based on a respective predicted asset performance value of a respective asset at a respective timestamp of the time series and a value of the respective sensor feature for the respective asset at the respective timestamp, and represents a ratio of the value of the respective sensor feature to the respective predicted asset performance value.

In some embodiments, the plurality of performance disparity values are inserted into the asset performance output data structure after the asset performance prediction model generates the asset performance output data structure, and inserting the plurality of performance disparity values into the asset performance output data structure includes: adding, by the processing circuitry, a performance disparity column to the asset performance output data structure, and updating, by the processing circuitry, one or more rows of the asset performance output data structure to include a respective performance disparity value corresponding to a respective asset at a respective timestamp of the time series.

In some embodiments, the asset performance output data structure comprises: a first performance disparity value in a first row associated with a respective asset at a first timestamp of the time series; and a second performance disparity value in a second row associated with the respective asset at a second timestamp of the time series, and the one or more alerting thresholds are satisfied when: the first performance disparity value and the second performance disparity value fall below a performance threshold, and the first timestamp and the second timestamp satisfy a threshold duration.

In some embodiments, the asset performance output data structure comprises a respective anomaly score value in the first row associated with the respective asset, and the one or more alerting thresholds are satisfied when one or more of a first criterion or a second criterion is satisfied, wherein: the first criterion is satisfied when: the first performance disparity value and the second performance disparity value fall below the performance threshold; and the first timestamp and the second timestamp satisfy the threshold duration, and the second criterion is satisfied when: the respective anomaly score value exceeds an anomaly threshold.

In some embodiments, the performance threshold and the threshold duration are extracted from a first file uploaded to a real-time or near real-time event streaming service, and the anomaly threshold is extracted from a second file, different from the first file, uploaded to the real-time or near real-time event streaming service.

In some embodiments, a first asset maintenance alert is generated for a respective asset in response to determining that a first row in the asset performance output data structure includes a first performance disparity value or a first anomaly score value that satisfies the one or more alerting thresholds, and the computer instructions, when executed by the processing circuitry, perform operations comprising: detecting a second row in the asset performance output data structure corresponds to the respective asset and includes a second respective anomaly score value or a second performance disparity value that satisfies the one or more alerting thresholds, determining a respective amount of time between a first timestamp of the time series associated with the first row and a second timestamp of the time series associated with the second row, and generating a second asset maintenance alert for the respective asset if: the respective amount of time exceeds a predefined alert persistence threshold, and a number of asset maintenance alerts generated for the respective asset over a specified time interval does not exceed a maximum alert count threshold.

In some embodiments, a respective performance disparity value in a respective row of the asset performance output data structure satisfies the one or more alerting thresholds, and generating the asset maintenance alert for a respective asset corresponding to the respective row includes: extracting, by the processing circuitry, the respective performance disparity value and one or more respective feature values of the plurality of enriched features and the plurality of sensor features from the respective row, providing, by the processing circuitry, the respective performance disparity value and the one or more respective feature values to a power prediction explainability algorithm, computing, by the processing circuitry using the power prediction explainability algorithm, a contribution value for the plurality of enriched features and the plurality of sensor features with respect to the respective performance disparity value, detecting, by the processing circuitry, that the contribution value of a subset of features in the plurality of enriched features and the plurality of sensor features satisfies a contribution threshold, and adding, to the asset maintenance alert by the processing circuitry, the subset of features identified as contributing to the respective performance disparity value.

In some embodiments, a respective anomaly score value in a respective row of the asset performance output data structure satisfies the one or more alerting thresholds, and generating the asset maintenance alert for a respective asset corresponding to the respective row includes: extracting, by the processing circuitry, the respective anomaly score value and one or more respective feature values of the plurality of enriched features and the plurality of sensor features from the respective row, providing, by the processing circuitry, the respective anomaly score value and the one or more respective feature values to an anomaly score explainability algorithm, computing, by the processing circuitry using the anomaly score explainability algorithm, a contribution value for the plurality of enriched features and the plurality of sensor features with respect to the respective anomaly score value, detecting, by the processing circuitry, that the contribution value of a subset of features in the plurality of enriched features and the plurality of sensor features satisfies a contribution threshold, and adding, to the asset maintenance alert by the processing circuitry, the subset of features identified as contributing to the respective anomaly score value.

In some embodiments, the asset maintenance alert generated for a respective asset is transmitted using an electronic messaging service and includes: a name of the respective asset, one or more features of the plurality of enriched features and the plurality of sensor features contributing to the asset maintenance alert, and a natural language explanation describing why the one or more features are behaving in an abnormal manner.

In some embodiments, a respective predicted asset performance value of the plurality of predicted asset performance values indicates an expected value for a feature of an asset at a respective time; a respective row of the asset performance output data structure at least includes: the respective predicted asset performance value, and an actual value of the feature at the respective time; and the computer instructions, when executed by the processing circuitry, perform the operations comprising: computing a prediction error value between the respective predicted asset performance value and the actual value of the feature, determining that the prediction error value exceeds a prediction error threshold for a predetermined number of periods, and in response to determining that the prediction error value exceeds the prediction error threshold for the predetermined number of periods: designating the asset performance prediction model as requiring retraining, and retraining the asset performance prediction model based on the designating.

In some embodiments, retraining the asset performance prediction model includes updating one or more parameters of the asset performance prediction model using a subset of the feature values included in the respective row as input variables and the actual value of the feature as a target variable.

In some embodiments, a computer-implemented method comprises: receiving, by the processing circuitry, sensor data associated with one or more assets in a target asset hierarchy; computing, by the processing circuitry, a plurality of enriched features for the one or more assets based on a plurality of sensor features included in the sensor data; generating, by the processing circuitry, an analytical data structure comprising feature values of the plurality of enriched features and the plurality of sensor features for the one or more assets over a time series; generating, by the processing circuitry using an anomaly detection model, an anomaly output data structure that extends the analytical data structure to include a set of anomaly score values corresponding to the one or more assets over the time series; generating, by the processing circuitry using an asset performance prediction model, an asset performance output data structure that extends the anomaly output data structure to include a plurality of predicted asset performance values for the one or more assets over the time series; inserting, into the asset performance output data structure by the processing circuitry, a plurality of performance disparity values computed based on the plurality of predicted asset performance values and the feature values of a respective sensor feature of the plurality of sensor features in the asset performance output data structure; detecting, by the processing circuitry using the asset performance output data structure, that a subset of the plurality of performance disparity values or a subset of the set of anomaly score values in the asset performance output data structure satisfy one or more alerting thresholds; and generating, by the processing circuitry, an asset maintenance alert for one or more assets associated with the subset of the plurality of performance disparity values or the subset of the set of anomaly score values in the asset performance output data structure.

In some embodiments, the computer-implemented method further comprises: training, by the processing circuitry, the anomaly detection model by: generating, by the processing circuitry, a plurality of binary decision trees based on a corpus of historical sensor data associated with the one or more assets, determining, by the processing circuitry, an average path length associated with one or more respective historical sensor records of the corpus across the plurality of binary decision trees, and assigning, by the processing circuitry, an anomaly score value to the one or more respective historical sensor records based on the average path length of the one or more respective historical sensor records.

In some embodiments of the computer-implemented method, the anomaly score value assigned to a first respective historical sensor record of the one or more respective historical sensor records is higher than the anomaly score value assigned to a second respective historical sensor record of the one or more respective historical sensor records when the average path length of the first respective historical sensor record is shorter than the average path length of the second respective historical sensor record, and the anomaly score value assigned to the first respective historical sensor record is lower than the anomaly score value assigned to the second respective historical sensor record when the average path length of the first respective historical sensor record is longer than the average path length of the second respective historical sensor record.

In some embodiments of the computer-implemented method, the average path length of a respective historical sensor record of the one or more respective historical sensor records is determined based on a number of tree node traversals required to assign the respective historical sensor record to a terminal node in each of the plurality of binary decision trees.

In some embodiments, a computer-implemented system comprises processing circuitry; a memory; and a computer-readable medium operably coupled to the processing circuitry the computer-readable medium having computer-readable instructions stored thereon that, when executed by the processing circuitry, cause a computing device to perform operations comprising receiving, by the processing circuitry, sensor data associated with one or more assets in a target asset hierarchy; computing, by the processing circuitry, a plurality of enriched features for the one or more assets based on a plurality of sensor features included in the sensor data; generating, by the processing circuitry, an analytical data structure comprising feature values of the plurality of enriched features and the plurality of sensor features for the one or more assets over a time series; generating, by the processing circuitry using an anomaly detection model, an anomaly output data structure that extends the analytical data structure to include a set of anomaly score values corresponding to the one or more assets over the time series; generating, by the processing circuitry using an asset performance prediction model, an asset performance output data structure that extends the anomaly output data structure to include a plurality of predicted asset performance values for the one or more assets over the time series; inserting, into the asset performance output data structure by the processing circuitry, a plurality of performance disparity values computed based on the plurality of predicted asset performance values and the feature values of a respective sensor feature of the plurality of sensor features in the asset performance output data structure; detecting, by the processing circuitry using the asset performance output data structure, that a subset of the plurality of performance disparity values or a subset of the set of anomaly score values in the asset performance output data structure satisfy one or more alerting thresholds; and generating, by the processing circuitry, an asset maintenance alert for one or more assets associated with the subset of the plurality of performance disparity values or the subset of the set of anomaly score values in the asset performance output data structure.

In some embodiments, a computer-program product may comprise a non-transitory machine-readable storage medium storing computer instructions that, when executed by processing circuitry, perform operations comprising: receiving, in real-time or near real-time, asset data associated with a plurality of distinct energy assets operating at an energy farm; computing, for each distinct energy asset of the plurality of distinct energy assets, an enriched set of attribute values derived from the asset data associated with the plurality of distinct energy assets; generating, by the processing circuitry, an energy farm behavior data structure using the asset data associated with the plurality of distinct energy assets and the enriched set of attribute values computed for the plurality of distinct energy assets, wherein each row of the energy farm behavior data structure includes: a respective energy asset identifier corresponding to one of the plurality of distinct energy assets, the asset data corresponding to the one of the plurality of distinct energy assets, and the enriched set of attribute values corresponding to the one of the plurality of distinct energy assets; in response to generating the energy farm behavior data structure: computing, using an anomaly detection model, an energy asset anomaly score for each distinct energy asset included in the energy farm behavior data structure; and computing, by a power prediction model, a predicted amount of electrical power to be generated by each distinct energy asset included in the energy farm behavior data structure; and generating a maintenance alert for a target energy asset of the plurality of distinct energy assets operating at the energy farm in response to detecting at least one of: the energy asset anomaly score computed for the target energy asset exceeds a predefined maximum anomaly score threshold, and an observed amount of electrical power generated by the target energy asset fails to satisfy a predetermined minimum power generation threshold for a predetermined time duration.

In some embodiments, the energy farm corresponds to a wind farm, the plurality of distinct energy assets correspond to a plurality of distinct wind turbines operating at the wind farm, the asset data corresponds to wind turbine data associated with the plurality of distinct wind turbines, the energy farm behavior data structure corresponds to a wind farm behavior data structure, the respective energy asset identifier included in each row of the energy farm behavior data structure corresponds to a respective wind turbine identifier corresponding to one of the plurality of distinct wind turbines, the anomaly detection model corresponds to a wind turbine anomaly detection model, the wind turbine anomaly detection model computes a wind turbine anomaly score for each distinct wind turbine of the plurality of distinct wind turbines included in the wind farm behavior data structure, the power prediction model corresponds to a wind turbine power prediction model, the wind turbine power prediction model computes a predicted amount of electrical power to be generated by each distinct wind turbine of the plurality of distinct wind turbines included in the wind farm behavior data structure, the maintenance alert corresponds to a wind turbine maintenance alert, and the target energy asset corresponds to a target wind turbine of the plurality of distinct wind turbines operating at the wind farm.

In some embodiments, the wind turbine data includes the observed amount of electrical power generated by the target wind turbine, the wind turbine maintenance alert was generated in response to detecting that the wind turbine anomaly score computed for the target wind turbine exceeds the predefined maximum anomaly score threshold, and the wind turbine maintenance alert generated for the target wind turbine includes: the respective wind turbine identifier corresponding to the target wind turbine, and one or more anomalous components of the target wind turbine.

In some embodiments, the wind turbine maintenance alert was generated in response to detecting that the observed amount of electrical power generated by the target wind turbine fails to satisfy the predetermined minimum power generation threshold for the predetermined time duration, and the wind turbine maintenance alert generated for the target wind turbine includes: the respective wind turbine identifier corresponding to the target wind turbine, and one or more anomalous components of the target wind turbine preventing the target wind turbine from satisfying the predetermined minimum power generation threshold.

In some embodiments, the wind turbine data includes: sensor data captured by a set of sensors positioned on each distinct wind turbine of the plurality of distinct wind turbines, environmental data indicative of atmospheric conditions observed at each distinct wind turbine of the plurality of distinct wind turbines, and turbine power data indicative of an actual amount of electrical power generated by each distinct wind turbine of the plurality of distinct wind turbines.

In some embodiments, each distinct wind turbine of the plurality of distinct wind turbines includes: a respective tower, a respective nacelle coupled to the respective tower, wherein the respective nacelle includes a gearbox, a generator, a transformer, and a hydraulic unit, and a respective rotor coupled to the respective nacelle, wherein the respective rotor includes a plurality of distinct rotor blades, and the sensor data captured by the set of sensors includes: rotor-related sensor data indicative of an operating state of the respective rotor associated with each distinct wind turbine of the plurality of distinct wind turbines, tower-related sensor data indicative of a structural state of the respective tower associated with each distinct wind turbine of the plurality of distinct wind turbines, and nacelle-related sensor data indicative of an operating state of the respective nacelle associated with each distinct wind turbine of the plurality of distinct wind turbines.

In some embodiments, computing the enriched set of attribute values includes: automatically computing, using the rotor-related sensor data, an enriched set of rotor blade attribute values for each distinct wind turbine of the plurality of distinct wind turbines, wherein the enriched set of rotor blade attribute values computed for a respective wind turbine of the plurality of distinct wind turbines represents a mechanical load experienced by the plurality of distinct rotor blades associated with the respective wind turbine.

In some embodiments, computing the enriched set of attribute values includes: automatically computing, using the nacelle-related sensor data, an enriched set of temperature-related attribute values for each distinct wind turbine of the plurality of distinct wind turbines, wherein the enriched set of temperature-related attribute values computed for a respective wind turbine of the plurality of distinct wind turbines represents a thermal state of the generator located within the respective nacelle of the respective wind turbine; and automatically computing, using the nacelle-related sensor data, an enriched set of electrical attribute values for each distinct wind turbine of the plurality of distinct wind turbines, wherein the enriched set of electrical attribute values computed for the respective wind turbine of the plurality of distinct wind turbines represents an electrical state of the generator located within the respective nacelle of the respective wind turbine.

In some embodiments, computing the enriched set of attribute values includes: automatically computing, using the nacelle-related sensor data, an enriched set of temperature-related attribute values for each distinct wind turbine of the plurality of distinct wind turbines, wherein the enriched set of temperature-related attribute values computed for a respective wind turbine of the plurality of distinct wind turbines represents a thermal state of the transformer included within the respective nacelle of the respective wind turbine; automatically computing, using the environmental data, a normalized wind speed for each distinct wind turbine of the plurality of distinct wind turbines, wherein the normalized wind speed mitigates a wake effect observed at the wind farm; automatically computing, using the turbine power data, a respective binary power status value for each distinct wind turbine of the plurality of distinct wind turbines, wherein the respective binary power status value computed for the respective wind turbine of the plurality of distinct wind turbines indicates whether the respective wind turbine is operating in a power-generating state or a non-power-generating state; and automatically computing, using the wind turbine data, a respective operating class value for each distinct wind turbine of the plurality of distinct wind turbines, wherein the respective operating class value computed for the respective wind turbine of the plurality of distinct wind turbines corresponds to one of a plurality of predetermined wind turbine operating region classes.

In some embodiments, the computer instructions, when executed by the processing circuitry, perform operations further comprising: before generating the wind farm behavior data structure: generating an original wind farm behavior data structure using the wind turbine data associated with the plurality of distinct wind turbines and the enriched set of attribute values computed for the plurality of distinct wind turbines, wherein the original wind farm behavior data structure includes: a first set of rows corresponding to a first subset of the plurality of distinct wind turbines that are operating in the power-generating state and have the respective operating class value that satisfies one of a first operating class criterion and a second operating class criterion, a second set of rows corresponding to a second subset of the plurality of distinct wind turbines that are operating in the non-power-generating state, and a third set of rows corresponding to a third subset of the plurality of distinct wind turbines having the respective operating region class value that does not satisfy the first operating class criterion and the second operating class criterion, wherein: the wind farm behavior data structure is generated based on a filtering of the original wind farm behavior data structure.

In some embodiments, the computer instructions, when executed by the processing circuitry, perform operations further comprising: receiving a natural language query associated with at least one energy asset of the plurality of distinct energy assets; generating, by the processing circuitry, a structured query based on the natural language query; executing, by the processing circuitry, the structured query to obtain a query result data structure derived from the energy farm behavior data structure, the energy asset anomaly scores output by the anomaly detection model, the predicted amounts of electrical power output by the power prediction model, or the maintenance alert; generating, by the processing circuitry, a response to the natural language query based on the query result data structure; and displaying the response to the natural language query via a user interface.

In some embodiments, the user interface is a graphical user interface, and wherein the graphical user interface includes: a conversational interaction region configured to receive the natural language input; an analytical context region distinct from the conversational interaction region, wherein the analytical context region displays one or more visualizations derived from previously generated energy farm behavior data structures, energy asset anomaly scores, predicted amounts of electrical power, or maintenance alerts; and a query transparency region configured to display the generated structured query or the obtained query result data structure.

In some embodiments, computing the wind turbine anomaly score for the target wind turbine includes: providing, as input to the wind turbine anomaly detection model, a respective row of the wind farm behavior data structure that corresponds to the target wind turbine, wherein the respective row includes one or more of: the rotor-related sensor data indicative of the operating state of the respective rotor of the target wind turbine, the tower-related sensor data indicative of the structural state of the respective tower of the target wind turbine, the nacelle-related sensor data indicative of the operating state of the respective nacelle of the target wind turbine, the enriched set of attribute values computed for the target wind turbine, the environmental data indicative of the atmospheric conditions observed at the target wind turbine, and the turbine power data indicative of the actual amount of electrical power generated by the target wind turbine; and in response to providing the respective row associated with the target wind turbine to the wind turbine anomaly detection model, computing, by the wind turbine anomaly detection model, the wind turbine anomaly score for the target wind turbine, wherein: the wind turbine anomaly detection model computed the wind turbine anomaly score for the target wind turbine based on the one or more of the rotor-related sensor data, the tower-related sensor data, the nacelle-related sensor data, the enriched set of attribute values, the environmental data, and the turbine power data included in the respective row corresponding to the target wind turbine.

In some embodiments, computing the predicted amount of electrical power to be generated by the target wind turbine includes: providing, as input to the wind turbine power prediction model, the respective row of the wind farm behavior data structure corresponding to the target wind turbine; and in response to providing the respective row associated with the target wind turbine to the wind turbine power prediction model, computing, by the wind turbine power prediction model, the predicted amount of electrical power to be generated by the target wind turbine, wherein: the wind turbine power prediction model computed the predicted amount of electrical power to be generated by the target wind turbine based on the one or more of the rotor-related sensor data, the tower-related sensor data, the nacelle-related sensor data, the enriched set of attribute values, and the environmental data included in the respective row corresponding to the target wind turbine.

In some embodiments, the environmental data included in the respective row corresponding to the target wind turbine includes: an ambient temperature value representing an air temperature measured at the target wind turbine, a wind direction value representing an angular direction from which wind approaches the target wind turbine, a wind speed value representing a speed of the wind observed at the target wind turbine, and a wind turbulence intensity value representing a degree of variability in the speed of the wind observed at the target wind turbine over a predetermined time span.

In some embodiments, the rotor-related sensor data included in the respective row corresponding to the target wind turbine includes: a first rotor blade load value representing a mechanical load experienced by a first rotor blade of the plurality of distinct rotor blades associated with the target wind turbine, a second rotor blade load value representing a mechanical load experienced by a second rotor blade of the plurality of distinct rotor blades associated with the target wind turbine, a third rotor blade load value representing a mechanical load experienced by a third rotor blade of the plurality of distinct rotor blades associated with the target wind turbine, a rotor blade pitch angle value representing an angular position of the plurality of distinct rotor blades associated with the target wind turbine, a rotor temperature value representing a temperature of the respective rotor of the target wind turbine, and a rotor speed value representing a rotational speed of the respective rotor of the target wind turbine.

In some embodiments, the tower-related sensor data included in the respective row corresponding to the target wind turbine includes: a first tower acceleration value representing an acceleration of the respective tower of the target wind turbine relative to a first axis of the target wind turbine, a second tower acceleration value representing an acceleration of the respective tower of the target wind turbine relative to a second axis orthogonal to the first axis, and a tower temperature value representing a temperature observed proximal to a bottom portion of the respective tower of the target wind turbine.

In some embodiments, the nacelle-related sensor data included in the respective row corresponding to the target wind turbine includes: a nacelle direction value representing an angular orientation of the respective nacelle of the target wind turbine, a nacelle temperature value representing a temperature of the respective nacelle of the target wind turbine, a first gearbox bearing temperature value representing a temperature observed at a first bearing located within the gearbox of the respective nacelle of the target wind turbine, a second gearbox bearing temperature value representing a temperature observed at a second bearing located within the gearbox of the respective nacelle of the target wind turbine, and a gearbox oil temperature value representing a temperature of oil circulating within the gearbox of the respective nacelle of the target wind turbine.

In some embodiments, the nacelle-related sensor data included in the respective row corresponding to the target wind turbine includes: a generator speed value representing a rotational speed of a generator shaft located within the generator of the respective nacelle of the target wind turbine, a first bearing temperature value representing a temperature observed at a first bearing located within the generator of the respective nacelle of the target wind turbine, a second bearing temperature value representing a temperature observed at a second bearing located within the generator of the respective nacelle of the target wind turbine, at least one stator winding temperature value representing a temperature observed at a stator winding located within the generator of the respective nacelle of the target wind turbine, a third bearing temperature value representing a temperature observed at a third bearing located within the generator of the respective nacelle of the target wind turbine, a fourth bearing temperature value representing a temperature observed at a fourth bearing located within the generator of the respective nacelle of the target wind turbine, at least one voltage value representing an amount of electrical voltage generated by the generator of the respective nacelle of the target wind turbine, at least one electrical current value representing an amount of alternating current produced by the generator of the respective nacelle of the target wind turbine, and an electrical frequency value representing a frequency of the alternating current produced by the generator of the respective nacelle of the target wind turbine.

In some embodiments, the nacelle-related sensor data included in the respective row corresponding to the target wind turbine includes: at least one transformer temperature value representing a temperature of the transformer located within the respective nacelle of the target wind turbine, a hydraulic pressure value representing a fluid pressure within the hydraulic unit of the respective nacelle of the target wind turbine, and a hydraulic oil temperature value representing a temperature of hydraulic oil used within the hydraulic unit of the respective nacelle of the target wind turbine.

In some embodiments, the computer instructions, when executed by the processing circuitry, perform operations further comprising: detecting the wind turbine anomaly score computed for the target wind turbine exceeds the predefined maximum anomaly score threshold; in response to detecting the wind turbine anomaly score computed for the target wind turbine exceeds the predefined maximum anomaly score threshold: providing, to an anomaly score explainability algorithm, (1) the wind turbine anomaly score computed for the target wind turbine and (2) a set of features the wind turbine anomaly detection model assessed to compute the wind turbine anomaly score for the target wind turbine, wherein each feature of the set of features includes a representation of a distinct piece of sensor data captured for a respective component of the target wind turbine; in response to providing the wind turbine anomaly score computed for the target wind turbine and the set of features to the anomaly score explainability algorithm, computing, for each feature of the set of features, a respective contribution value indicating an extent to which that respective feature contributed to the wind turbine anomaly score computed for the target wind turbine; detecting, by the processing circuitry, that the respective contribution value of at least one feature of the set of features satisfies an anomalous component criterion; and in response to detecting the respective contribution value of the at least one feature satisfies the anomalous component criterion, generating the wind turbine maintenance alert based in part on the respective component of the target wind turbine corresponding to the at least one feature.

In some embodiments, the wind turbine maintenance alert generated for the target wind turbine includes: the respective wind turbine identifier corresponding to the target wind turbine, the respective component corresponding to the at least one feature that satisfies the anomalous component criterion, and a natural language explanation describing a reason that the respective component corresponding to the at least one feature is causing the target wind turbine to behave anomalously.

In some embodiments, the computer instructions, when executed by the processing circuitry, perform operations further comprising: detecting that the observed amount of electrical power generated by the target wind turbine fails to satisfy the predetermined minimum power generation threshold for the predetermined time duration; in response to detecting the observed amount of electrical power generated by the target wind turbine fails to satisfy the predetermined minimum power generation threshold for the predetermined time duration: providing, to a power prediction explainability algorithm, (1) the predicted amount of electrical power to be generated by the target wind turbine and (2) a set of features the wind turbine power prediction model assessed to compute the predicted amount of electrical power to be generated by the target wind turbine, wherein each feature of the set of features includes a representation of a distinct piece of sensor data captured for a respective component of the target wind turbine; in response to providing the predicted amount of electrical power to be generated by the target wind turbine and the set of features to the power prediction explainability algorithm, computing, for each feature of the set of features, a respective contribution value indicating an extent to which that respective feature contributed to the predicted amount of electrical power to be generated by the target wind turbine; detecting, by the processing circuitry, that the respective contribution value of at least one feature of the set of features satisfies an anomalous component criterion, wherein the respective component corresponding to the at least one feature satisfying the anomalous component criterion is preventing the target wind turbine from satisfying the predetermined minimum power generation threshold; and in response to detecting the respective contribution value of the at least one feature satisfies the anomalous component criterion, generating the wind turbine maintenance alert based in part on the respective component of the target wind turbine corresponding to the at least one feature.

In some embodiments, the wind turbine maintenance alert generated for the target wind turbine includes: the respective wind turbine identifier corresponding to the target wind turbine, the respective component corresponding to the at least one feature that satisfies the anomalous component criterion, and a natural language explanation describing a reason that the respective component corresponding to the at least one feature is contributing to a degradation in power output of the target wind turbine.

In some embodiments, the computer instructions, when executed by the processing circuitry, perform operations further comprising: obtaining a corpus of training data that includes a plurality of distinct wind turbine training data samples, wherein each distinct wind turbine training data sample of the plurality of distinct wind turbine training data samples includes: sensor data captured by a set of sensors positioned on a subject wind turbine, and a turbine power value representing a real-world amount of electrical power generated by the subject wind turbine; and training a supervised machine learning model using the corpus of training data, wherein the trained supervised machine learning model corresponds to the wind turbine power prediction model.

In some embodiments, the computer instructions, when executed by the processing circuitry, perform operations further comprising: obtaining a corpus of training data that includes a plurality of unlabeled wind turbine training data samples, wherein each unlabeled wind turbine training data sample of the plurality of unlabeled wind turbine training data samples includes sensor data captured by a set of sensors positioned on a subject wind turbine; and training an unsupervised machine learning model using the corpus of training data, wherein the trained unsupervised machine learning model corresponds to the wind turbine anomaly detection model.

In some embodiments, the computer instructions, when executed by the processing circuitry, perform operations further comprising: computing, using the trained unsupervised machine learning model, a respective anomaly score for each unlabeled wind turbine training data sample included in the corpus of training data; generating a set of anomaly scores in response to computing the respective anomaly score for each unlabeled wind turbine training data sample included in the corpus of training data, wherein the set of anomaly scores includes the respective anomaly score computed for each unlabeled wind turbine training data sample included in the corpus of training data; identifying, within the set of anomaly scores, an anomaly score value that corresponds to a target quantile; and in response to identifying the anomaly score value that corresponds to the target quantile, setting the predefined maximum anomaly score threshold based on the anomaly score value, wherein: the wind turbine anomaly score computed for the target wind turbine exceeds the predefined maximum anomaly score threshold based on the wind turbine anomaly score computed for the target wind turbine being greater than or equal to the anomaly score value.

In some embodiments, the asset data corresponds to solar farm data, the energy farm corresponds to a solar farm, and the plurality of distinct energy assets correspond to a plurality of solar energy assets operating at the solar farm.

In some embodiments, a computer-implemented method comprises receiving, in real-time or near real-time, asset data associated with a plurality of distinct energy assets operating at an energy farm; computing, for each distinct energy asset of the plurality of distinct energy assets, an enriched set of attribute values derived from the asset data associated with the plurality of distinct energy assets; generating, by processing circuitry, an energy farm behavior data structure using the asset data associated with the plurality of distinct energy assets and the enriched set of attribute values computed for the plurality of distinct energy assets, wherein each row of the energy farm behavior data structure includes: a respective energy asset identifier corresponding to one of the plurality of distinct energy assets, the asset data corresponding to the one of the plurality of distinct energy assets, and the enriched set of attribute values corresponding to the one of the plurality of distinct energy assets; in response to generating the energy farm behavior data structure: computing, using an anomaly detection model, an energy asset anomaly score for each distinct energy asset included in the energy farm behavior data structure; and computing, by a power prediction model, a predicted amount of electrical power to be generated by each distinct energy asset included in the energy farm behavior data structure; and generating a maintenance alert for a target energy asset of the plurality of distinct energy assets operating at the energy farm in response to detecting at least one of: the energy asset anomaly score computed for the target energy asset exceeds a predefined maximum anomaly score threshold, and an observed amount of electrical power generated by the target energy asset fails to satisfy a predetermined minimum power generation threshold for a predetermined time duration.

In some embodiments, a computer-implemented system comprises processing circuitry; a memory; and a computer-readable medium operably coupled to the processing circuitry the computer-readable medium having computer-readable instructions stored thereon that, when executed by the processing circuitry, cause a computing device to perform operations comprising: receiving, in real-time or near real-time, asset data associated with a plurality of distinct energy assets operating at an energy farm; computing, for each distinct energy asset of the plurality of distinct energy assets, an enriched set of attribute values derived from the asset data associated with the plurality of distinct energy assets; generating, by the processing circuitry, an energy farm behavior data structure using the asset data associated with the plurality of distinct energy assets and the enriched set of attribute values computed for the plurality of distinct energy assets, wherein each row of the energy farm behavior data structure includes: a respective energy asset identifier corresponding to one of the plurality of distinct energy assets, the asset data corresponding to the one of the plurality of distinct energy assets, and the enriched set of attribute values corresponding to the one of the plurality of distinct energy assets; in response to generating the energy farm behavior data structure: computing, using an anomaly detection model, an energy asset anomaly score for each distinct energy asset included in the energy farm behavior data structure; and computing, by a power prediction model, a predicted amount of electrical power to be generated by each distinct energy asset included in the energy farm behavior data structure; and generating a maintenance alert for a target energy asset of the plurality of distinct energy assets operating at the energy farm in response to detecting at least one of: the energy asset anomaly score computed for the target energy asset exceeds a predefined maximum anomaly score threshold, and an observed amount of electrical power generated by the target energy asset fails to satisfy a predetermined minimum power generation threshold for a predetermined time duration.

In some embodiments, the wind farm behavior data structure includes the first set of rows and the wind farm behavior data structure does not include the second set of rows and the third set of rows.

In some embodiments, the computer instructions, when executed by the processing circuitry, perform operations further comprising: transmitting, using an electronic messaging service, the wind turbine maintenance alert generated for the target wind turbine to a target entity, or displaying the wind turbine maintenance alert generated for the target wind turbine on a graphical user interface.

In some examples, a computer-program product may comprise a non-transitory machine-readable storage medium storing computer instructions that, when executed by processing circuitry, perform operations comprising: receiving, in real-time or near real-time, wind turbine data associated with a plurality of distinct wind turbines operating at a wind farm; computing, for each distinct wind turbine of the plurality of distinct wind turbines, an enriched set of attribute values derived from the wind turbine data associated with the plurality of distinct wind turbines; generating, by the processing circuitry, a c using the wind turbine data associated with the plurality of distinct wind turbines and the enriched set of attribute values computed for the plurality of distinct wind turbines, wherein each row of the wind farm behavior data table includes: a respective wind turbine identifier corresponding to one of the plurality of distinct wind turbines, the wind turbine data corresponding to the one of the plurality of distinct wind turbines, and the enriched set of attribute values corresponding to the one of the plurality of distinct wind turbines; in response to generating the wind farm behavior data table: computing, using a wind turbine anomaly detection model, a wind turbine anomaly score for each distinct wind turbine included in the wind farm behavior data table; and computing, by a wind turbine power prediction model, a predicted amount of electrical power to be generated by each distinct wind turbine included in the wind farm behavior data table; and generating a wind turbine maintenance alert for a target wind turbine of the plurality of distinct wind turbines operating at the wind farm in response to detecting one of: the wind turbine anomaly score computed for the target wind turbine exceeds a predefined maximum anomaly threshold, and a power ratio between (i) an observed amount of electrical power generated by the target wind turbine and (ii) the predicted amount of electrical power to be generated by the target wind turbine fails to satisfy a predetermined power ratio threshold for a predetermined time duration.

In some examples, the wind turbine maintenance alert was generated in response to detecting that the wind turbine anomaly score computed for the target wind turbine exceeds the predefined maximum anomaly threshold, and the wind turbine maintenance alert generated for the target wind turbine includes: the respective wind turbine identifier corresponding to the target wind turbine, and one or more anomalous components of the target wind turbine.

In some examples, the wind turbine maintenance alert was generated in response to detecting that the power ratio of the target wind turbine fails to satisfy the predetermined power ratio threshold for the predetermined time duration, and the wind turbine maintenance alert generated for the target wind turbine includes: the respective wind turbine identifier corresponding to the target wind turbine, and one or more anomalous components of the target wind turbine preventing the power ratio of the target wind turbine from satisfying the predetermined power ratio threshold.

In some examples, the wind turbine data includes: sensor data captured by a set of sensors positioned on each distinct wind turbine of the plurality of distinct wind turbines, environmental data indicative of atmospheric conditions observed at each distinct wind turbine of the plurality of distinct wind turbines, and turbine power data indicative of an actual amount of electrical power generated by each distinct wind turbine of the plurality of distinct wind turbines.

In some examples, each distinct wind turbine of the plurality of distinct wind turbines includes: a respective tower, a respective nacelle coupled to the respective tower, wherein the respective nacelle includes a gearbox, a generator, a transformer, and a hydraulic unit, and a respective rotor coupled to the respective nacelle, wherein the respective rotor includes a plurality of distinct rotor blades, and the sensor data captured by the set of sensors includes: rotor-related sensor data indicative of an operating state of the respective rotor associated with each distinct wind turbine of the plurality of distinct wind turbines, tower-related sensor data indicative of a structural state of the respective tower associated with each distinct wind turbine of the plurality of distinct wind turbines, and nacelle-related sensor data indicative of an operating state of the respective nacelle associated with each distinct wind turbine of the plurality of distinct wind turbines.

In some examples, computing the enriched set of attribute values includes: automatically computing, using the rotor-related sensor data, an enriched set of rotor blade attribute values for each distinct wind turbine of the plurality of distinct wind turbines, wherein the enriched set of rotor blade attribute values computed for a respective wind turbine of the plurality of distinct wind turbines represents a mechanical load experienced by the plurality of distinct rotor blades associated with the respective wind turbine.

In some examples, computing the enriched set of attribute values includes: automatically computing, using the nacelle-related sensor data, an enriched set of temperature-related attribute values for each distinct wind turbine of the plurality of distinct wind turbines, wherein the enriched set of temperature-related attribute values computed for a respective wind turbine of the plurality of distinct wind turbines represents a thermal state of the generator located within the respective nacelle of the respective wind turbine; and automatically computing, using the nacelle-related sensor data, an enriched set of electrical attribute values for each distinct wind turbine of the plurality of distinct wind turbines, wherein the enriched set of electrical attribute values computed for the respective wind turbine of the plurality of distinct wind turbines represents an electrical state of the generator located within the respective nacelle of the respective wind turbine.

In some examples, computing the enriched set of attribute values includes: automatically computing, using the nacelle-related sensor data, an enriched set of temperature-related attribute values for each distinct wind turbine of the plurality of distinct wind turbines, wherein the enriched set of temperature-related attribute values computed for a respective wind turbine of the plurality of distinct wind turbines represents a thermal state of the transformer included within the respective nacelle of the respective wind turbine; automatically computing, using the environmental data, a normalized wind speed for each distinct wind turbine of the plurality of distinct wind turbines, wherein the normalized wind speed mitigates a wake effect observed at the wind farm; automatically computing, using the turbine power data, a respective binary power status value for each distinct wind turbine of the plurality of distinct wind turbines, wherein the respective binary power status value computed for the respective wind turbine of the plurality of distinct wind turbines indicates whether the respective wind turbine is operating in a power-generating state or a non-power-generating state; and automatically computing, using the wind turbine data, a respective operating class value for each distinct wind turbine of the plurality of distinct wind turbines, wherein the respective operating class value computed for the respective wind turbine of the plurality of distinct wind turbines corresponds to one of a plurality of predetermined wind turbine operating region classes.

In some examples, the computer instructions, when executed by the processing circuitry, perform operations further comprising: before generating the wind farm behavior data table: generating an original wind farm behavior data table using the wind turbine data associated with the plurality of distinct wind turbines and the enriched set of attribute values computed for the plurality of distinct wind turbines, wherein the original wind farm behavior data table includes: a first set of rows corresponding to a first subset of the plurality of distinct wind turbines that are operating in the power-generating state and have the respective operating class value that satisfies one of a first operating class criterion and a second operating class criterion, a second set of rows corresponding to a second subset of the plurality of distinct wind turbines that are operating in the non-power-generating state, and a third set of rows corresponding to a third subset of the plurality of distinct wind turbines having the respective operating region class value that does not satisfy the first operating class criterion and the second operating class criterion, wherein: the wind farm behavior data table is generated based on a filtering of the original wind farm behavior data table.

In some examples, the wind farm behavior data table includes the first set of rows, and the wind farm behavior data table does not include the second set of rows and the third set of rows.

In some examples, computing the wind turbine anomaly score for the target wind turbine includes: providing, as input to the wind turbine anomaly detection model, a respective row of the wind farm behavior data table that corresponds to the target wind turbine, wherein the respective row includes one or more of: the rotor-related sensor data indicative of the operating state of the respective rotor of the target wind turbine, the tower-related sensor data indicative of the structural state of the respective tower of the target wind turbine, the nacelle-related sensor data indicative of the operating state of the respective nacelle of the target wind turbine, the enriched set of attribute values computed for the target wind turbine, the environmental data indicative of the atmospheric conditions observed at the target wind turbine, and the turbine power data indicative of the actual amount of electrical power generated by the target wind turbine; and in response to providing the respective row associated with the target wind turbine to the wind turbine anomaly detection model, computing, by the wind turbine anomaly detection model, the wind turbine anomaly score for the target wind turbine, wherein: the wind turbine anomaly detection model computed the wind turbine anomaly score for the target wind turbine based on the one or more of the rotor-related sensor data, the tower-related sensor data, the nacelle-related sensor data, the enriched set of attribute values, the environmental data, and the turbine power data included in the respective row corresponding to the target wind turbine.

In some examples, computing the predicted amount of electrical power to be generated by the target wind turbine includes: providing, as input to the wind turbine power prediction model, the respective row of the wind farm behavior data table corresponding to the target wind turbine; and in response to providing the respective row associated with the target wind turbine to the wind turbine power prediction model, computing, by the wind turbine power prediction model, the predicted amount of electrical power to be generated by the target wind turbine, wherein: the wind turbine power prediction model computed the predicted amount of electrical power to be generated by the target wind turbine based on the one or more of the rotor-related sensor data, the tower-related sensor data, the nacelle-related sensor data, the enriched set of attribute values, and the environmental data included in the respective row corresponding to the target wind turbine.

In some examples, the environmental data included in the respective row corresponding to the target wind turbine includes: an ambient temperature value representing an air temperature measured at the target wind turbine, a wind direction value representing an angular direction from which wind approaches the target wind turbine, a wind speed value representing a speed of the wind observed at the target wind turbine, and a wind turbulence intensity value representing a degree of variability in the speed of the wind observed at the target wind turbine over a predetermined time span.

In some examples, the rotor-related sensor data included in the respective row corresponding to the target wind turbine includes: a first rotor blade load value representing a mechanical load experienced by a first rotor blade of the plurality of distinct rotor blades associated with the target wind turbine, a second rotor blade load value representing a mechanical load experienced by a second rotor blade of the plurality of distinct rotor blades associated with the target wind turbine, a third rotor blade load value representing a mechanical load experienced by a third rotor blade of the plurality of distinct rotor blades associated with the target wind turbine, a rotor blade pitch angle value representing an angular position of the plurality of distinct rotor blades associated with the target wind turbine, a rotor temperature value representing a temperature of the respective rotor of the target wind turbine, and a rotor speed value representing a rotational speed of the respective rotor of the target wind turbine.

In some examples, the tower-related sensor data included in the respective row corresponding to the target wind turbine includes: a first tower acceleration value representing an acceleration of the respective tower of the target wind turbine relative to a first axis of the target wind turbine, a second tower acceleration value representing an acceleration of the respective tower of the target wind turbine relative to a second axis orthogonal to the first axis, and a tower temperature value representing a temperature observed proximal to a bottom portion of the respective tower of the target wind turbine.

In some examples, the nacelle-related sensor data included in the respective row corresponding to the target wind turbine includes: a nacelle direction value representing an angular orientation of the respective nacelle of the target wind turbine, a nacelle temperature value representing a temperature of the respective nacelle of the target wind turbine, a first gearbox bearing temperature value representing a temperature observed at a first bearing located within the gearbox of the respective nacelle of the target wind turbine, a second gearbox bearing temperature value representing a temperature observed at a second bearing located within the gearbox of the respective nacelle of the target wind turbine, and a gearbox oil temperature value representing a temperature of oil circulating within the gearbox of the respective nacelle of the target wind turbine.

In some examples, the nacelle-related sensor data included in the respective row corresponding to the target wind turbine includes: a generator speed value representing a rotational speed of a generator shaft located within the generator of the respective nacelle of the target wind turbine, a first bearing temperature value representing a temperature observed at a first bearing located within the generator of the respective nacelle of the target wind turbine, a second bearing temperature value representing a temperature observed at a second bearing located within the generator of the respective nacelle of the target wind turbine, at least one stator winding temperature value representing a temperature observed at a stator winding located within the generator of the respective nacelle of the target wind turbine, a third bearing temperature value representing a temperature observed at a third bearing located within the generator of the respective nacelle of the target wind turbine, a fourth bearing temperature value representing a temperature observed at a fourth bearing located within the generator of the respective nacelle of the target wind turbine, at least one voltage value representing an amount of electrical voltage generated by the generator of the respective nacelle of the target wind turbine, at least one electrical current value representing an amount of alternating current produced by the generator of the respective nacelle of the target wind turbine, and an electrical frequency value representing a frequency of the alternating current produced by the generator of the respective nacelle of the target wind turbine.

In some examples, the nacelle-related sensor data included in the respective row corresponding to the target wind turbine includes: at least one transformer temperature value representing a temperature of the transformer located within the respective nacelle of the target wind turbine, a hydraulic pressure value representing a fluid pressure within the hydraulic unit of the respective nacelle of the target wind turbine, and a hydraulic oil temperature value representing a temperature of hydraulic oil used within the hydraulic unit of the respective nacelle of the target wind turbine.

In some examples, the computer instructions, when executed by the processing circuitry, perform operations further comprising: detecting the wind turbine anomaly score computed for the target wind turbine exceeds the predefined maximum anomaly threshold; in response to detecting the wind turbine anomaly score computed for the target wind turbine exceeds the predefined maximum anomaly threshold: providing, to an anomaly score explainability algorithm, (1) the wind turbine anomaly score computed for the target wind turbine and (2) a set of features the wind turbine anomaly detection model assessed to compute the wind turbine anomaly score for the target wind turbine, wherein each feature of the set of features includes a representation of a distinct piece of sensor data captured for a respective component of the target wind turbine; in response to providing the wind turbine anomaly score computed for the target wind turbine and the set of features to the anomaly score explainability algorithm, computing, for each feature of the set of features, a respective contribution value indicating an extent to which that respective feature contributed to the wind turbine anomaly score computed for the target wind turbine; detecting, by the processing circuitry, that the respective contribution value of at least one feature of the set of features satisfies an anomalous component criterion; and in response to detecting the respective contribution value of the at least one feature satisfies the anomalous component criterion, generating the wind turbine maintenance alert based in part on the respective component of the target wind turbine corresponding to the at least one feature.

In some examples, the wind turbine maintenance alert generated for the target wind turbine includes: the respective wind turbine identifier corresponding to the target wind turbine, the respective component corresponding to the at least one feature that satisfies the anomalous component criterion, and a natural language explanation describing a reason that the respective component corresponding to the at least one feature is causing the target wind turbine to behave anomalously.

In some examples, the computer instructions, when executed by the processing circuitry, perform operations further comprising: transmitting, using an electronic messaging service, the wind turbine maintenance alert generated for the target wind turbine to a target entity.

In some examples, the computer instructions, when executed by the processing circuitry, perform operations further comprising: detecting the power ratio of the target wind turbine fails to satisfy the predetermined power ratio threshold for the predetermined time duration; in response to detecting the power ratio of the target wind turbine fails to satisfy the predetermined power ratio threshold for the predetermined time duration: providing, to a power prediction explainability algorithm, (1) the predicted amount of electrical power to be generated by the target wind turbine and (2) a set of features the wind turbine power prediction model assessed to compute the predicted amount of electrical power to be generated by the target wind turbine, wherein each feature of the set of features includes a representation of a distinct piece of sensor data captured for a respective component of the target wind turbine; in response to providing the predicted amount of electrical power to be generated by the target wind turbine and the set of features to the power prediction explainability algorithm, computing, for each feature of the set of features, a respective contribution value indicating an extent to which that respective feature contributed to the predicted amount of electrical power to be generated by the target wind turbine; detecting, by the processing circuitry, that the respective contribution value of at least one feature of the set of features satisfies an anomalous component criterion, wherein the respective component corresponding to the at least one feature satisfying the anomalous component criterion is preventing the power ratio of the target wind turbine from satisfying the predetermined power ratio threshold; and in response to detecting the respective contribution value of the at least one feature satisfies the anomalous component criterion, generating the wind turbine maintenance alert based in part on the respective component of the target wind turbine corresponding to the at least one feature.

In some examples, the wind turbine maintenance alert generated for the target wind turbine includes: the respective wind turbine identifier corresponding to the target wind turbine, the respective component corresponding to the at least one feature that satisfies the anomalous component criterion, and a natural language explanation describing a reason that the respective component corresponding to the at least one feature is contributing to a degradation in power output of the target wind turbine.

In some examples, the computer instructions, when executed by the processing circuitry, perform operations further comprising: displaying the wind turbine maintenance alert generated for the target wind turbine on a graphical user interface.

In some examples, the computer instructions, when executed by the processing circuitry, perform operations further comprising: obtaining a corpus of training data that includes a plurality of distinct wind turbine training data samples, wherein each distinct wind turbine training data sample of the plurality of distinct wind turbine training data samples includes: sensor data captured by a set of sensors positioned on a subject wind turbine, and a turbine power value representing a real-world amount of electrical power generated by the subject wind turbine; and training a supervised machine learning model using the corpus of training data, wherein the trained supervised machine learning model corresponds to the wind turbine power prediction model.

In some examples, the computer instructions, when executed by the processing circuitry, perform operations further comprising: obtaining a corpus of training data that includes a plurality of unlabeled wind turbine training data samples, wherein each unlabeled wind turbine training data sample of the plurality of unlabeled wind turbine training data samples includes sensor data captured by a set of sensors positioned on a subject wind turbine; and training an unsupervised machine learning model using the corpus of training data, wherein the trained unsupervised machine learning model corresponds to the wind turbine anomaly detection model.

In some examples, the computer instructions, when executed by the processing circuitry, perform operations further comprising: computing, using the trained unsupervised machine learning model, a respective anomaly score for each unlabeled wind turbine training data sample included in the corpus of training data; generating a set of anomaly scores in response to computing the respective anomaly score for each unlabeled wind turbine training data sample included in the corpus of training data, wherein the set of anomaly scores includes the respective anomaly score computed for each unlabeled wind turbine training data sample included in the corpus of training data; identifying, within the set of anomaly scores, an anomaly score value that corresponds to a target quantile; and in response to identifying the anomaly score value that corresponds to the target quantile, setting the predefined maximum anomaly threshold based on the anomaly score value, wherein: the wind turbine anomaly score computed for the target wind turbine exceeds the predefined maximum anomaly threshold based on the wind turbine anomaly score computed for the target wind turbine being greater than or equal to the anomaly score value.

### BRIEF DESCRIPTION OF THE FIGURES

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to some embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to some embodiments of the present technology.

FIG. 11 illustrates a flow chart of an example of a process for generating and using a machine-learning model according to some aspects, according to some embodiments of the present technology.

FIG. 12 illustrates an example of a machine-learning model as a neural network, according to some embodiments of the present technology.

FIG. 13 illustrates various aspects of the use of containers as a mechanism to allocate processing, storage and/or other resources of a processing system to the performance of various analyses, according to some embodiments of the present technology.

FIGS. 14, 14A, and 14B illustrate an example process flow in accordance with some embodiments of the present technology.

FIGS. 15 through 17 illustrate example alert generation procedures in accordance with some embodiments of the present technology.

FIGS. 18 and 18A illustrate example maintenance alerts in accordance with some embodiments of the present technology.

FIG. 19 illustrates an example anomaly score explainability procedure in accordance with some embodiments of the present technology.

FIG. 20 illustrates an example power prediction explainability procedure in accordance with some embodiments of the present technology.

FIGS. 21A and 21B illustrate example wind farms in accordance with some embodiments of the present technology.

FIG. 22 illustrates an example wind turbine in accordance with some embodiments of the present technology.

FIG. 23 illustrates an example process flow in accordance with some embodiments of the present technology.

FIG. 24A illustrates an example alert generation architecture in accordance with some embodiments of the present technology.

FIG. 24B illustrates an example sensor data reception procedure in accordance with some embodiments of the present technology.

FIG. 24C illustrates an example asset hierarchy in accordance with some embodiments of the present technology.

FIG. 24D illustrates an example analytical data table generation procedure in accordance with some embodiments of the present technology.

FIG. 24E illustrates an example anomaly output data table generation procedure in accordance with some embodiments of the present technology.

FIG. 24F illustrates an example asset performance output data table generation procedure in accordance with some embodiments of the present technology.

FIG. 24G illustrates an example performance disparity value insertion procedure in accordance with some embodiments of the present technology.

FIG. 24H illustrates an example asset alert generation procedure in accordance with some embodiments of the present technology.

FIG. 24I illustrates an example power prediction explainability procedure in accordance with some embodiments of the present technology.

FIG. 24J illustrates an example anomaly score explainability procedure in accordance with some embodiments of the present technology.

FIG. 25A illustrates an example asset management agent process flow in accordance with some embodiments of the present technology.

FIGS. 25B through 25D illustrate example asset management asset user interface views in accordance with some embodiments of the present technology.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

### Example Systems

Systems depicted in some of the figures may be provided in various configurations. In some embodiments, the systems may be configured as a distributed system where one or more components of the system are distributed across one or more networks in a cloud computing system.

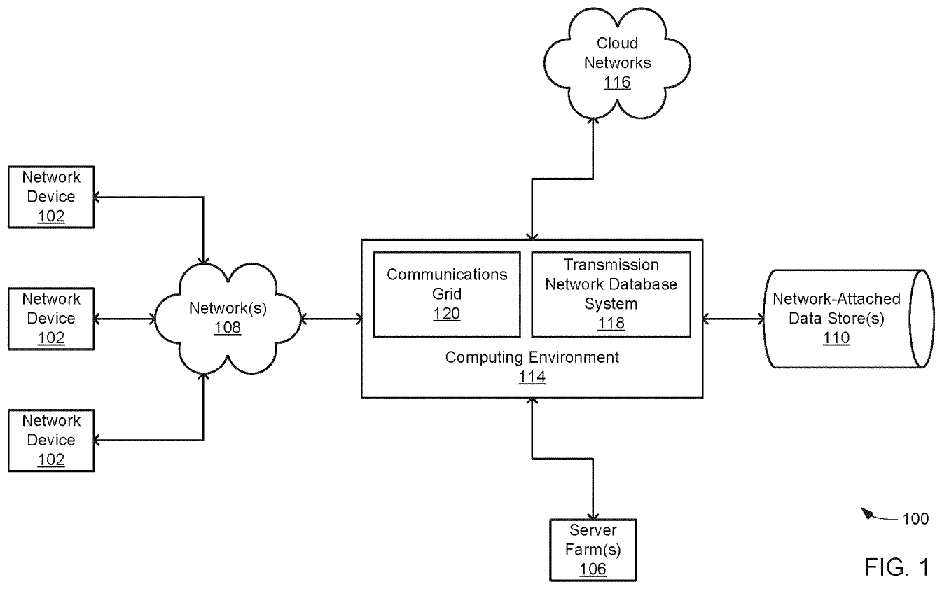

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

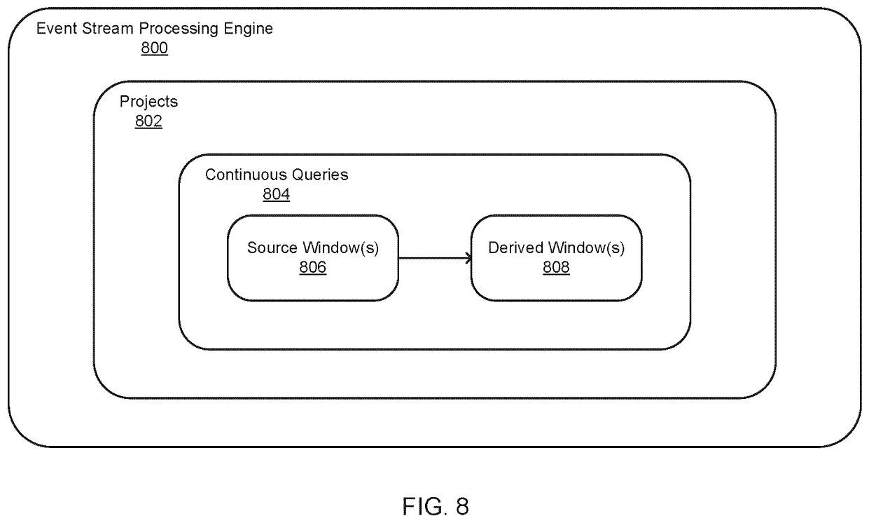

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more server farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

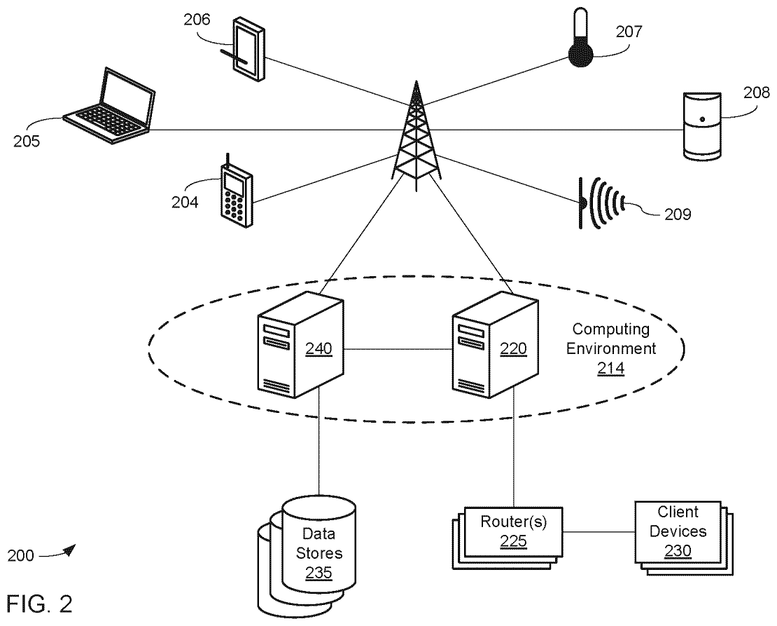

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® LOW Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

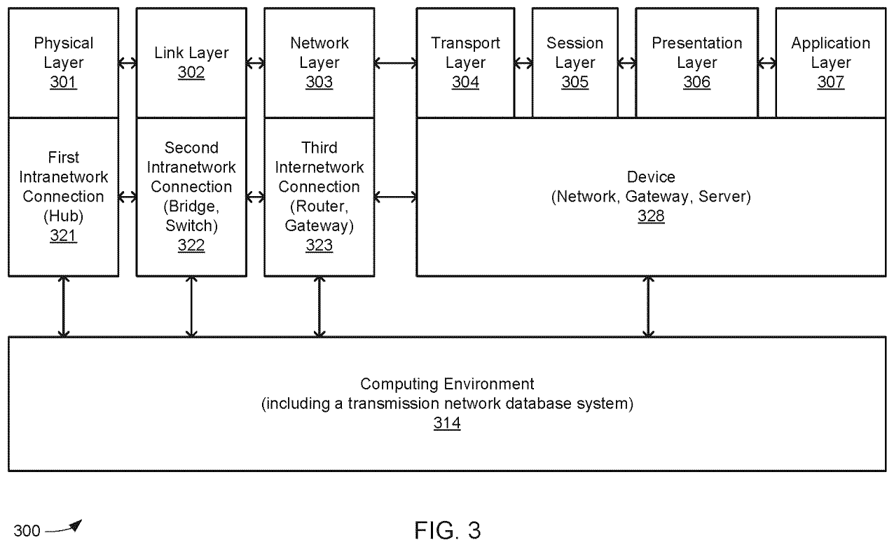

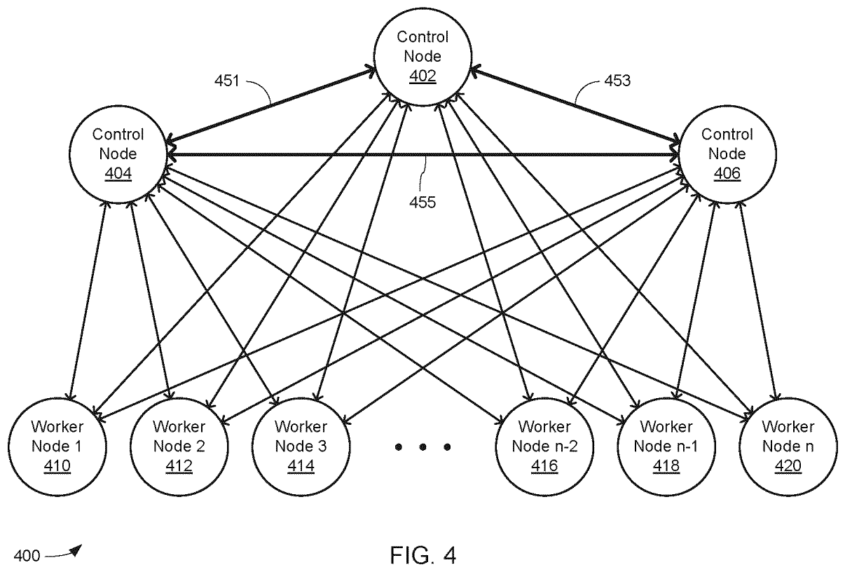

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data and is the farthest layer from the user in a communications system. On the other hand, the application layer is the highest layer because it interacts directly with a software application.

As noted, the model includes a physical layer 301. Physical layer 301 represents physical communication and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recently saved checkpoint of their status and re-start the project from that checkpoint to minimize lost progress on the project being executed.

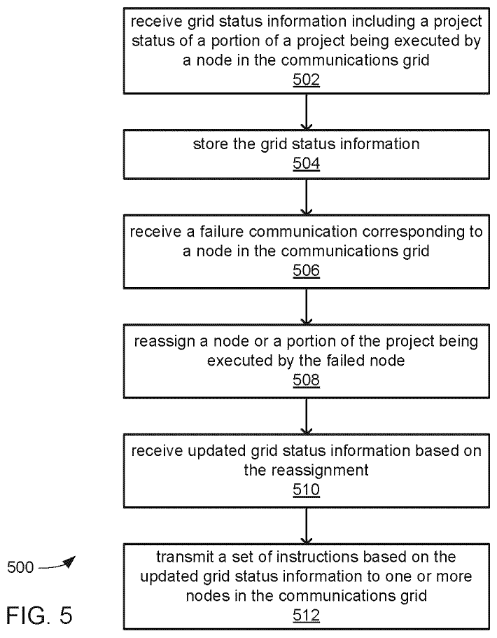

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

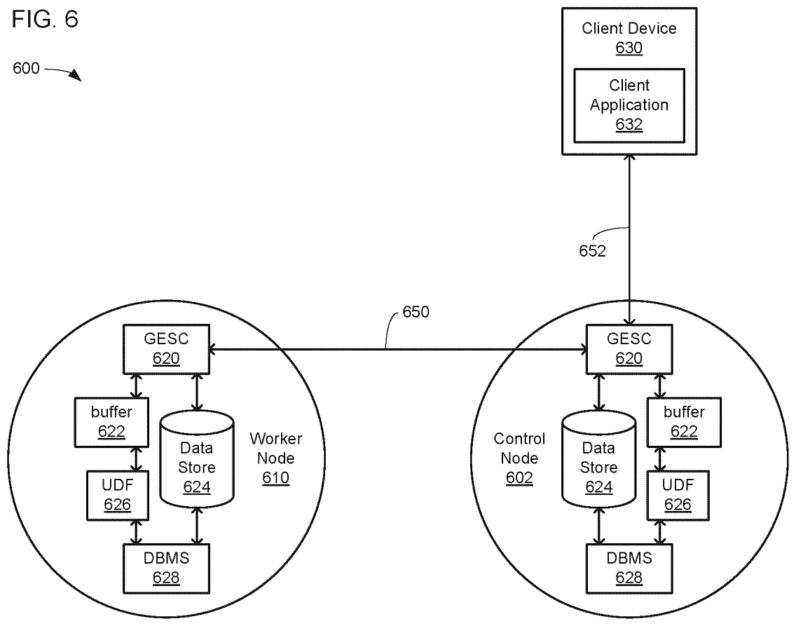

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However, in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

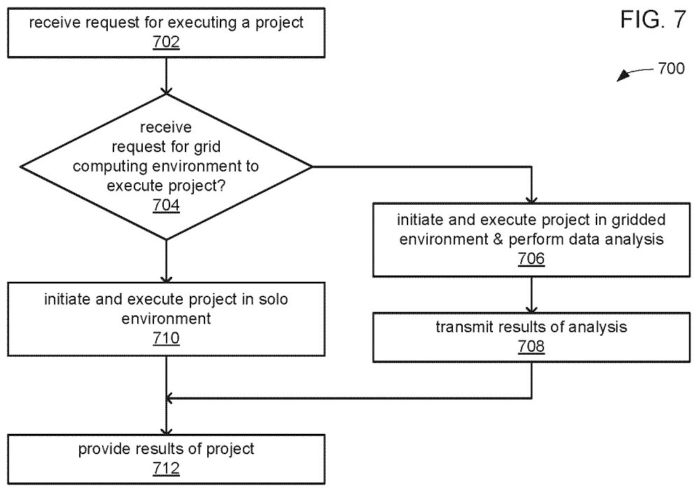

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

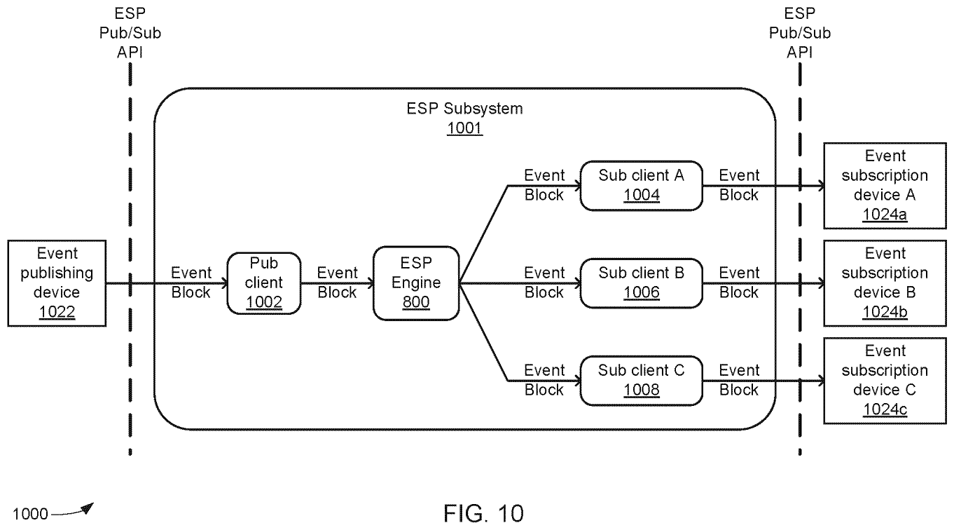

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Clients or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

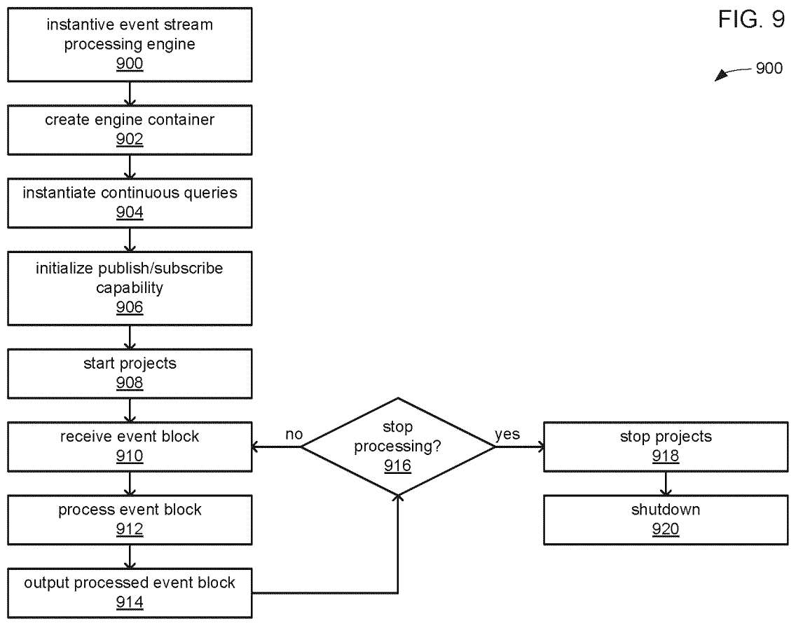

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing devices of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

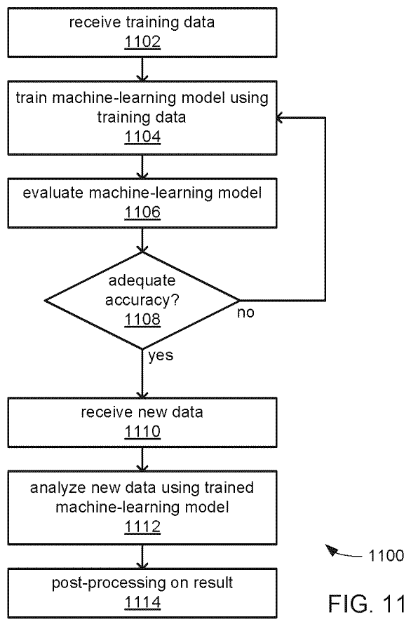

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108. the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

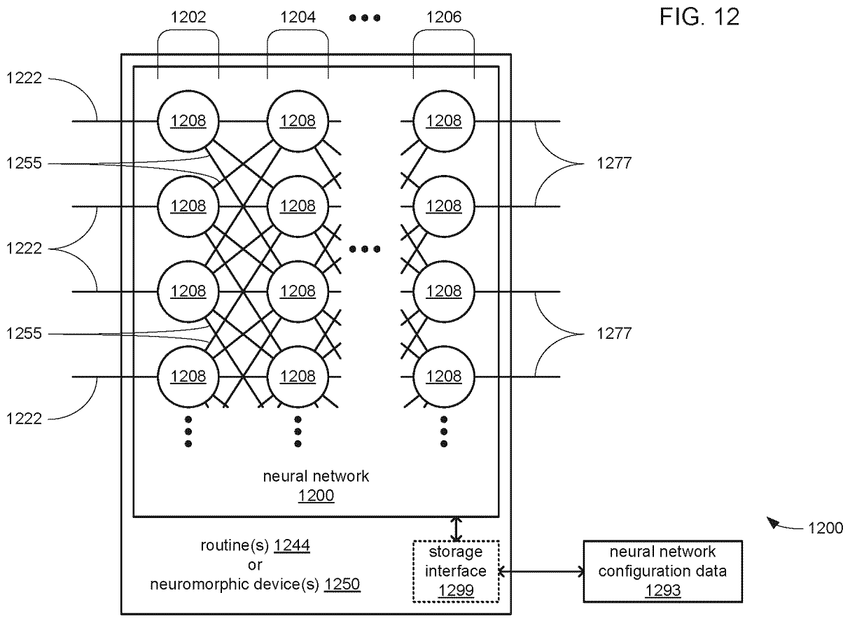

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max (x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively, or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

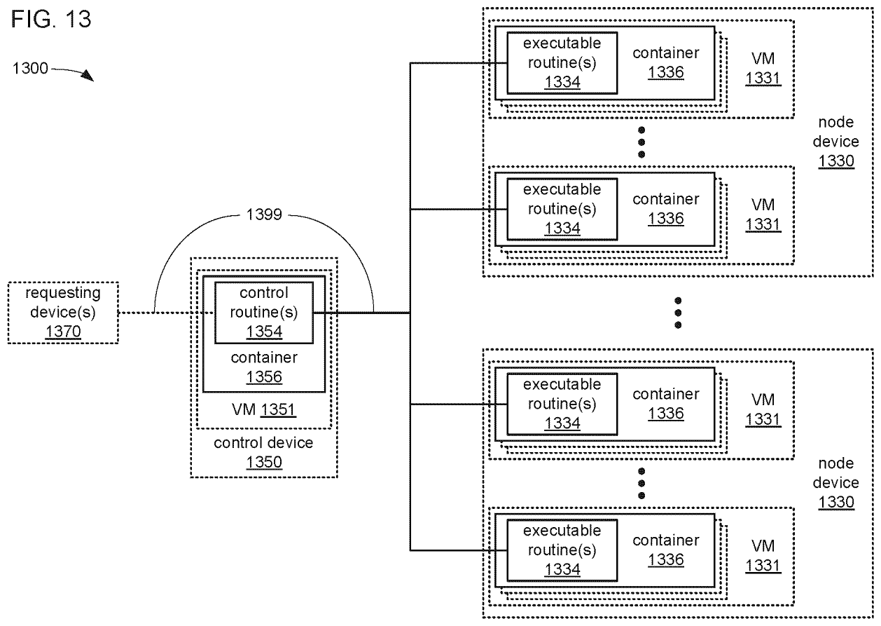

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively, or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively, or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively, or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Could Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively, or additionally, such supporting routines may serve to provide access to one or more storage repositories (not specifically shown) in which at least data objects may be stored for use in performing the requested analyses.

### Associated Processes

Energy asset monitoring may be performed in energy farm environments (e.g., wind farms, solar farms, geothermal, biomass, etc.) to minimize unplanned downtime and maximize operational efficiency. Conventional monitoring techniques, such as threshold-based monitoring or offline statistical analysis, may detect failures only after they occur and may not provide sufficient advance warning to prevent operational losses. The systems and methods described herein address these limitations by providing real-time monitoring, predictive analytics, and intelligent alerting that enable early detection of performance degradation and subsequent preventative interventions.

In order to detect performance degradation, the system described herein may use an anomaly detection model and a power prediction model that are trained offline using historical energy asset data and executed online using energy asset data collected in real-time or near real-time. For instance, the system may receive energy asset data from a set of sensors associated with a set of energy assets and may enrich the energy asset data with additional attributes. The system may then provide the energy asset data and corresponding enriched attributes to the anomaly detection model in order to calculate an anomaly score for each energy asset and a power prediction model in order to calculate a predicted amount of power produced by each energy asset. If the anomaly score for a particular energy asset exceeds a predefined maximum anomaly score threshold or an observed amount of electrical power produced for the energy asset falls below a minimum power threshold for a defined duration, the system may generate a maintenance alert indicating that the energy asset is experiencing an energy asset anomaly.

Additionally, or alternatively, the system may compare an observed amount of electrical power produced by an energy asset with the predicted amount of electrical power, such as evaluating a ratio between an observed amount of electrical power and a predicted amount of electrical power. In such examples, the system may monitor deviations between observed and predicted electrical power over a defined duration to determine whether the power prediction model is exhibiting degraded predictive performance and, in response, may generate an alert indicating that retraining of the power prediction model is to be performed.

Generating the maintenance alert based on a multi-model framework (e.g., both the anomaly detection model and the power prediction model) may provide increased robustness in detecting performance degradation prior to energy asset failure. Additionally, it should be noted that the maintenance alert may include contextual information specifying which components of the energy asset are contributing to anomalous energy asset behavior. In order to specify this component, the system described herein may provide the energy asset data and corresponding enriched attributes to an explainability model that identifies how much various sensor features contribute to an abnormal anomaly score or predicted amount of electrical power. The system described herein may then combine the contributions of the sensor features according to which system component they are associated with and may identify which component is associated with the highest total contribution.

Utilizing such a system, which may be capable of detecting energy asset anomalies in real-time prior to energy asset failure and providing alerts that indicate which specific energy assets are experiencing energy asset anomalies may enable timely intervention in addressing such anomalies, thus reducing overall downtime. For instance, the generated maintenance alert may be provided to automated systems capable of initiating corrective actions to prevent or mitigate additional performance degradation (e.g., adjusting a blade pitch of a wind turbine or performing generator torque control to reduce a temperature of a main shaft bearing). Alternatively, the generated maintenance alert may be provided to personnel with information facilitating repairs to be performed with reduced latency (e.g., information pinpointing the energy asset as well as its component linked to anomalous behavior).

In some examples, the system described herein may store the energy asset data and corresponding enriched attributes in an energy farm behavior data structure that is provided to the anomaly detection model and the power prediction model. The system may filter out data within the energy farm behavior data structure to enable accelerated anomaly detection and fewer computational resources to be consumed. For instance, the system may filter out energy asset data associated with energy assets in non-operational states and operating regions that are out-of-scope. Further, this improved efficiency may enable deployment of the anomaly detection model and/or power prediction model into environments with constrained processing capacity but improved response times (e.g., edge environments).

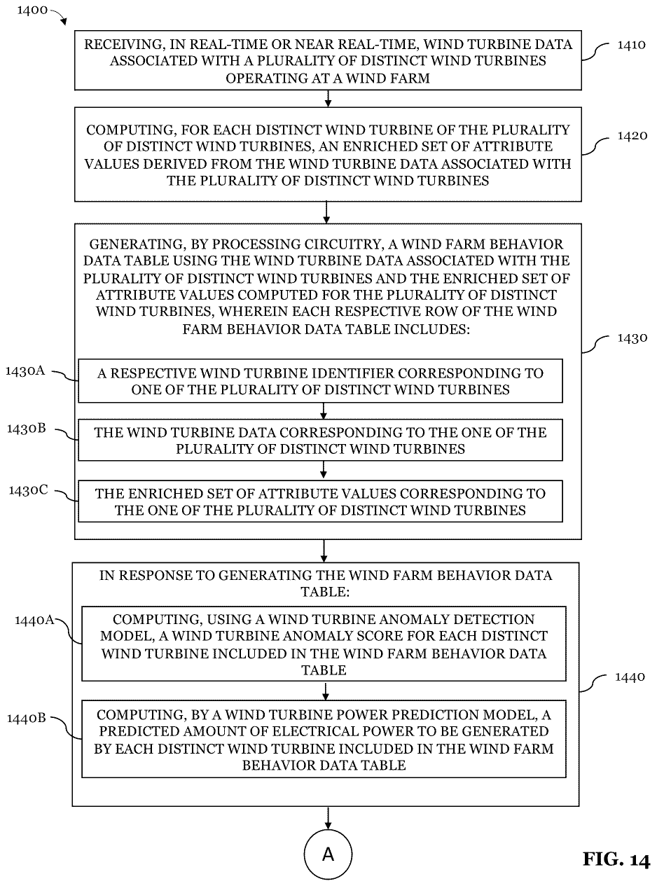

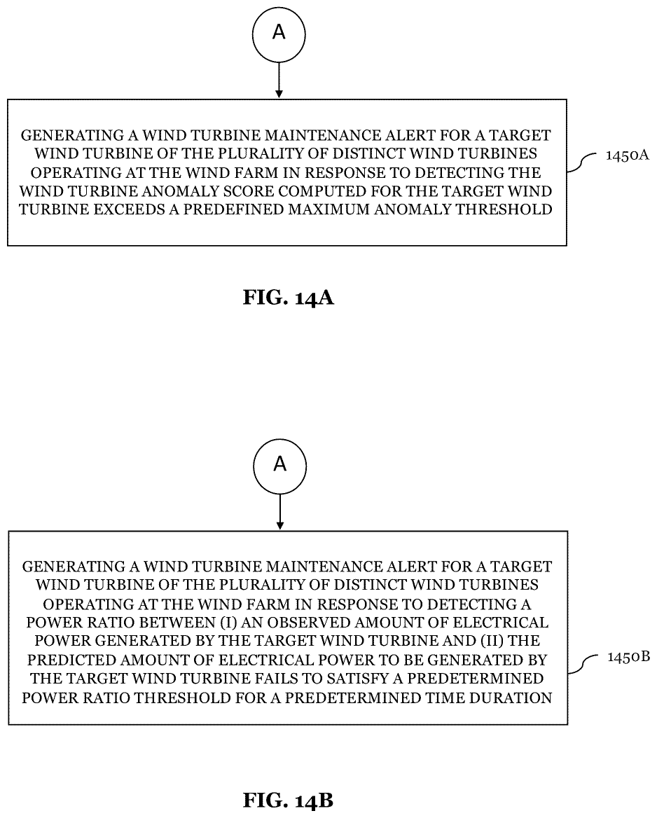

FIGS. 14 and 14A illustrate one embodiment of method 1400. It shall be appreciated that other embodiments contemplated within the scope of the present disclosure may involve more processes, fewer processes, different processes, or a different order of processes than illustrated in FIGS. 14 and 14A. It should be noted that a computer-program product may include a non-transitory machine-readable storage medium storing computer instructions that, when executed by one or more operations, may perform operations corresponding to the processes and sub-processes of method 1400. Additionally, or alternatively, a computer-implemented method may include operations corresponding to processes and sub-processes of 1400. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 1400.

As shown in FIG. 14, process 1410 of method 1400 may include receiving, in real-time or near real-time, asset data associated with a plurality of distinct energy assets operating at an energy farm. Receiving asset data in real-time or near real-time may refer to receiving asset data with minimal latency relative to when the asset data is generated such that the asset data accurately captures a current state of the plurality of distinct energy assets. In other words, in some embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

The term “energy farm” may refer to a collection of energy assets deployed at a common geographic site and configured to generate electrical power for distribution to a grid or directly to a power consumer. Non-limiting examples of energy farms may include wind farms, solar farms, hydroelectric farms, geothermal energy farms, and tidal energy farms.

The term “energy asset” as used herein may refer to a physical component of an energy farm that participates in the generation, conversion, or distribution of electrical power. Examples of energy assets may include, but not be limited to, wind energy assets (e.g., a wind turbine), solar energy assets (e.g., a solar panel), hydroelectric energy assets (e.g., a water turbine), geothermal energy assets (e.g., a steam turbine), tidal energy assets (e.g., a tidal turbine), or other machinery configured to produce or regulate energy. Energy assets may be monitored individually or in aggregate and may be organized into hierarchical structures in which the output of a lower-level energy asset serves as an input to a higher-level energy asset. A first example hierarchy may include a solar farm being associated with multiple inverters, each inverter being associated with multiple arrays, each array being associated with multiple combiner boxes, and each combiner boxes being associated with multiple string inverters. A second example hierarchy may include a wind farm being associated with or served by multiple wind turbines.

The term “asset data” may refer to information collected from an energy asset that characterizes an operational state, environmental conditions, or energy production outputs of that energy asset. Examples of asset data related to operational state may include sensor measurements such as temperature, vibration, current, voltage, wind speed, or irradiance. Examples of asset data related to environmental conditions may include atmospheric pressure, ambient temperature, and humidity. Examples of asset data related to energy production outputs may include instantaneous or cumulative electrical power output. Asset data may be received continuously or periodically in real-time or near real-time.

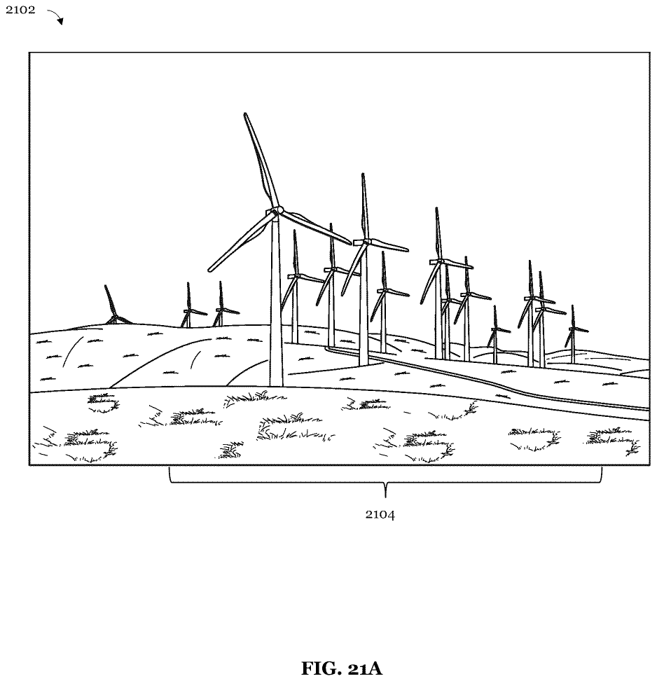

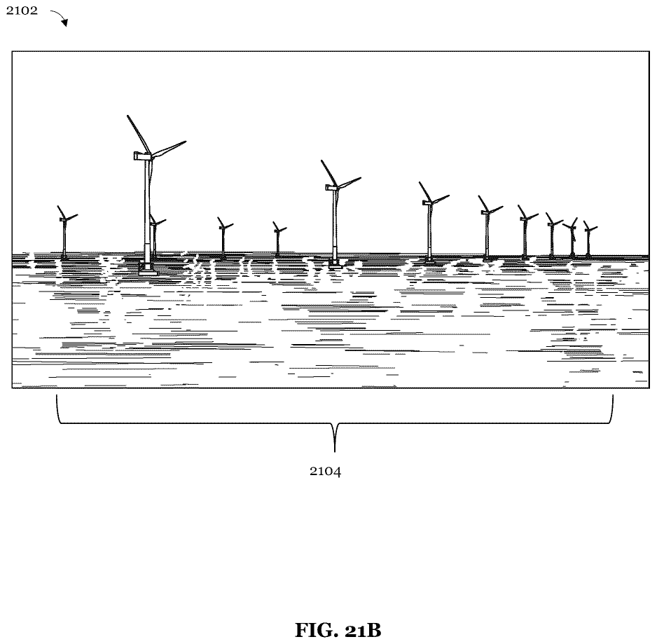

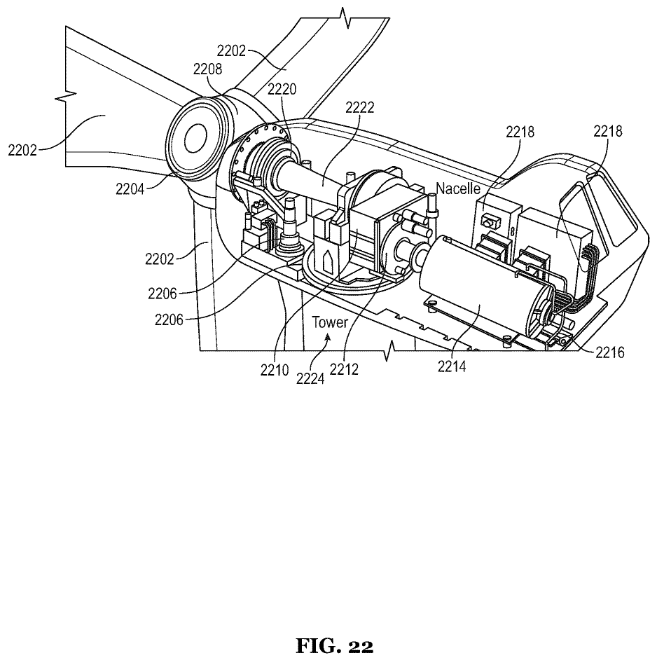

In a non-limiting example, as described with reference to FIGS. 21A and 21B, the energy farm may be a wind farm 2102 (e.g., an onshore wind farm as depicted with reference to FIG. 21A and an offshore farm as depicted with reference to FIG. 21B) and the plurality of distinct energy assets may be a plurality of distinct wind turbines 2104 operating at the wind farm. Additionally, as described with reference to FIG. 22, each distinct wind turbine may include a respective tower 2224, a respective nacelle coupled to the respective tower 2224, and a respective rotor 2208 coupled to the respective nacelle. The tower 2224 as described herein may be a vertical structural component configured to support the nacelle and rotor at an elevated height relative to a ground or body of water below. The nacelle as described herein may be a housing mounted on top of the tower that includes mechanical and electrical components of the wind turbine. The rotor as described herein may refer to an assembly of blades (e.g., plurality of distinct rotor blades 2202) and a hub coupled to the nacelle that captures wind energy and converts it into rotational mechanical energy for power generation. It should be noted that although various examples described herein assume three blades within the plurality of distinct rotor blades 2202, the techniques described herein may be applicable for other numbers of blades (e.g., 1 blade, 2 blades, 4 blades, 5 blades, and so on). Additionally, it should be noted that techniques described herein may be applicable to variable-speed wind turbines and fixed-speed wind turbines without deviating from the scope of the present disclosure.

The respective nacelle may include a gearbox 2210, a mechanical brake 2212, a generator 2214, a hydraulic unit 2216, control and power electronic systems 2218, main shaft bearings 2220, and a main shaft 2222. Main shaft 2222 may be a rotating shaft coupled to the rotor hub that transmits mechanical torque from the plurality of distinct rotor blades 2202 into a drivetrain of the wind turbine. Main shaft bearings 2220 may correspond to bearings that mechanically support the main shaft 2222 and enable low-friction rotation of the main shaft 2222. Gearbox 2210 may be a mechanical assembly configured to convert the rotation of the main shaft 2222 into higher-speed rotation suitable for driving generator 2214. Mechanical brake 2212 may be a braking subsystem configured to apply frictional force to the drivetrain of the wind turbine to slow or stop rotation of the rotor 2208. Generator 2214 may be an electrical machine configured to convert the higher-speed rotation provided by the gearbox 2210 into electrical energy. Hydraulic unit 2216 may be a system configured to provide pressurized hydraulic fluid for actuating pitch system 2204 and/or yaw system 2206. Pitch system 2204 may be a subsystem of the wind turbine configured to adjust an angular orientation of the plurality of distinct rotor blades 2202 relative to the wind. Yaw system 2206 may be a subsystem of the wind turbine configured to rotate the nacelle about an axis of the tower 2224. Control and power electronic systems 2218 may be electronic subsystems configured to monitor, regulate, and convert electrical signals and power flows associated with the generator 2214. In some examples, the nacelle of the wind turbine may include a transformer configured to convert the voltage generated by generator 2214 to a different voltage level suitable for transmission or grid integration. Alternatively, the transformer may be located outside of the wind turbine (e.g., at a base of the wind turbine).

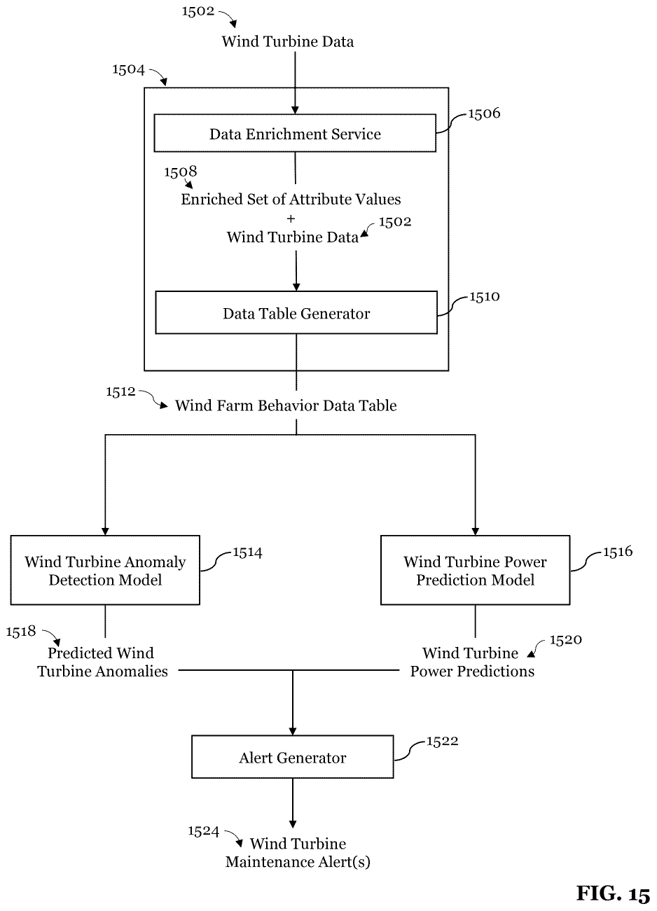

In a non-limiting example, as described with reference to FIG. 15, the asset data provided by wind farm 2102 and received at process 1410 may include wind turbine data 1502. The wind turbine data may include sensor data captured by a set of sensors positioned on each distinct wind turbine of the plurality of distinct wind turbines 2104 (e.g., operational state information), environmental data indicative of atmospheric conditions observed at each distinct wind turbine of the plurality of distinct wind turbines 2104 (e.g., environmental condition information), and turbine power data indicative of an actual amount of electrical power generated by each distinct wind turbine of the plurality of distinct wind turbines (e.g., energy production output information). The sensor data captured by the set of sensors may include rotor-related sensor data indicative of an operating state of the respective rotor associated with each distinct wind turbine of the plurality of distinct wind turbines 2104 (e.g., rotor 2208 of FIG. 22), tower-related sensor data indicative of a structural state of the respective tower associated with each distinct wind turbine of the plurality of distinct wind turbines 2104 (e.g., tower 2224 of FIG. 22), and nacelle-related sensor data indicative of an operating state of the respective nacelle associated with each distinct wind turbine of the plurality of distinct wind turbines 2104 (e.g., the nacelle described in FIG. 22).

As shown in FIG. 14, process 1420 of method 1400 may include computing, for each distinct energy asset of the plurality of distinct energy assets, an enriched set of attribute values derived from the asset data associated with the plurality of distinct energy assets. A set of enriched attribute values, as described herein, may refer to transformed, derived, or contextualized data values computed from the received asset data associated with an energy asset.

In some examples, the enriched set of attribute values may be computed by applying mathematical transformations, absolute value operations, or averaging functions to energy asset data. For instance, enriched attributes may include absolute value representations of blade load measurements to account for both positive and negative force values in a consistent manner. Enriched attributes may further include averages of related measurements, such as an average of the blade load values across multiple blades associated with a target rotor, an average of bearing temperatures across multiple distinct points of a high-speed shaft (e.g., a target shaft included within a target generator), an average of stator winding temperatures across multiple windings of a generator, an average of electrical current values produced by the generator across a plurality of distinct phases, and an average of voltage values produced by the generator across a plurality of distinct phases. Additional enriched attributes may include averages of transformer core temperatures. In some cases, derived values may be computed, such as a corrected wind speed obtained as the product of raw wind speed and an air density correction factor, a binary running status assigned a first value when turbine power is less than or equal to zero and a second value when turbine power is greater than zero, and a categorical operating region indicator determined by comparing observed wind speed against cut-in, rated, and cut-off thresholds of the turbine.

In a non-limiting example, as described with reference to FIG. 15, a real-time event processing service 1504 may receive wind turbine data 1502 and may provide the wind turbine data 1502 to a data enrichment service 1506. The data enrichment service 1506 may compute an enriched set of attribute values 1508 from the wind turbine data 1502 and may provide both the enriched set of attribute values 1508 and the wind turbine data 1502 to data table generator 1510. The enriched set of attribute values 1508 may differ from the wind turbine data 1502 in that the enriched set may include derived or transformed features created through data transformation operations such as averaging, normalization, or absolute value calculations, whereas the wind turbine data 1502 may include raw sensor measurements collected directly from wind turbines. By combining the raw sensor data with the enriched attribute values, the resulting dataset may enable the anomaly detection model and power prediction model as described herein to detect energy asset anomalies with increased accuracy.

In examples in which the wind turbine data 1502 includes rotor-related sensing data, process 1420 computing the enriched set of attribute values 1508 may include data enrichment service 1506 automatically computing, using the rotor-related sensor data, an enriched set of rotor blade attribute values for each distinct wind turbine of the plurality of distinct wind turbines 2104. In such examples, the enriched set of rotor blade attribute values computed for a respective wind turbine of the plurality of distinct wind turbines 2104 may represent a mechanical load experienced by the plurality of distinct rotor blades 2202 associated with the respective wind turbine.

In examples in which the wind turbine data 1502 includes nacelle-related sensor data, process 1420 computing the enriched set of attribute values 1508 may include data enrichment service 1506 automatically computing, using the nacelle-related sensor data, an enriched set of temperature-related attribute values for each distinct wind turbine of the plurality of distinct wind turbines 2104. In such examples, the enriched set of temperature-related attribute values computed for a respective wind turbine of the plurality of distinct wind turbines may represent a thermal state of the generator 2214 or a transformer located within the respective nacelle of the respective wind turbine.

Additionally, process 1420 computing the enriched set of attributes values 1508 may include data enrichment service 1506 automatically computing, using the nacelle-related sensor data, an enriched set of electrical attribute values for each distinct wind turbine of the plurality of distinct wind turbines. In such examples, the enriched set of electrical attribute values computed for the respective wind turbine of the plurality of distinct wind turbines 2104 may represent an electrical state of the generator 2214 located within the respective nacelle of the respective wind turbine.

In examples in which the wind turbine data 1502 includes environmental data, process 1420 computing the enriched set of attribute values 1508 may include data enrichment service 1506 automatically computing, using the environmental data, a normalized wind speed for each distinct wind turbine of the plurality of distinct wind turbines 2104. The term “wake effect” may refer to a reduction in wind speed and increased turbulence experienced by downwind wind turbines due to the airflow disruption created by upwind wind turbines. The term “normalized wind speed” may refer to an adjusted wind speed value that accounts for variations in air density or wake effect influences so that wind turbine performance can be compared under equivalent environmental conditions. In such examples, the normalized wind speed may mitigate a wake effect observed at the wind farm 2102. Additionally, airspeed indicators may read lower than true wind speed with an increase in altitude, where the true wind speed may represent the effective wind speed experienced by a wind turbine. Accordingly, data enrichment service 1506 may multiply wind speed by an air density correction factor in order to calculate a true wind speed.

In examples in which the wind turbine data 1502 includes turbine power data, process 1420 computing the enriched set of attribute values 1508 may include data enrichment service 1506 automatically computing, using the turbine power data, a respective binary power status value for each distinct wind turbine of the plurality of distinct wind turbines 2104. In such examples, the respective binary power status value computed for the respective wind turbine of the plurality of distinct wind turbines 2104 may indicate whether the respective wind turbine is operating in a power-generating state or a non-power-generating state. The term “power-generating state” may refer to an operational condition of a wind turbine in which the rotor is actively converting wind energy into mechanical energy that the generator uses to produce electrical power, whereas the term “non-power-generating state” may refer to an operational condition of a wind turbine in which the turbine is not producing electrical power.

In some examples, process 1420 computing the enriched set of attribute values 1508 may include data enrichment service 1506 automatically computing a respective operating class value for each distinct wind turbine of the plurality of distinct wind turbines 2104. In such examples, the respective operating class value computed for the respective wind turbine of the plurality of distinct wind turbines 2104 corresponds to one of a plurality of predetermined wind turbine operating region classes. The operating region class value may refer to a categorical indicator assigned to a wind turbine based on a relationship between observed wind speed and corresponding power output relative to the design specifications of the wind turbine. Examples of operating region class values may include a low-wind operating region class, a transitional operating region class, a rated-power operating class region, and a high-wind region operating region class. The low-wind operating region class may be assigned to a wind turbine if the wind turbine is experiencing an observed wind speed below a cut-in wind speed, which may be a minimum wind speed at which a wind turbine begins generating electrical power. The transitional operating region class may be assigned to a wind turbine if the wind turbine is experiencing an observed wind speed above the cut-in wind speed but is producing a power below a rated-power threshold. The rated-power transitional region may be assigned to a wind turbine if the wind turbine is experiencing an observed wind speed higher than the cut-in wind speed and is producing a power above or at the rated-power threshold. The high-wind operating region class may be assigned to a wind turbine if the wind turbine is experiencing an observed wind speed above a cut-out wind speed, which may refer to a maximum wind speed at which a wind turbine is configured to cease generating electrical power (e.g., due to potential mechanical damage or safety hazards). In the present disclosure, being assigned to the transitional operating region may satisfy a first operating class criterion and being assigned to the rated-power operating region may satisfy a second operating class criterion.

The term “rated-power threshold” may refer to a specified level of power output that corresponds to the maximum continuous electrical power a wind turbine is designed to produce under standard operating conditions. The rated-power threshold may vary across wind turbine models depending on design capacity and intended deployment environment. For example, a small-scale distributed generation wind turbine may have a rated-power threshold of approximately 100 kilowatts, while a utility-scale land-based wind turbine may have a rated-power threshold in the range of 2 to 5 megawatts. Offshore wind turbines may have even higher rated-power thresholds (e.g., exceeding 10 megawatts).

As shown in FIG. 14, process 1430 of method 1400 may include generating, by the processing circuitry, an energy farm behavior data structure using the asset data associated with the plurality of distinct energy assets and the enriched set of attribute values computed for the plurality of distinct energy assets. The term “energy farm behavior data structure” may refer to a structured representation (e.g., a tabular representation, a data table, etc) of asset data and corresponding enriched attribute values for the plurality of distinct energy assets.

In order to generate the energy farm behavior data structure, sub-process 1430A of process 1430 may set each row of the energy farm behavior data structure with a respective energy asset identifier corresponding to (e.g., assigned to) one of the plurality of distinct energy assets. Additionally, sub-process 1430B of process 1430 may set each row of the energy farm behavior data structure with the asset data corresponding to the respective energy asset whose energy asset identifier is associated with the row. Likewise, sub-process 1430C of process 1430 may set each row of the energy farm behavior data structure with the enriched set of attribute values corresponding to the respective energy asset whose energy asset identifier is associated with the row.

In a non-limiting example, as described with reference to FIG. 15, data table generator 1510 may receive the enriched set of attribute values 1508 and the wind turbine data 1502 from data enrichment service 1506. Data table generator 1510 may then generate a wind farm behavior data table 1512 using the wind turbine data 1502 and the enriched set of attribute values 1508 and may provide the wind farm behavior table 1512 to wind turbine anomaly detection model 1514 and wind turbine power prediction model 1516. The wind farm behavior data table 1512 may be provided simultaneously (e.g., in parallel) or sequentially (e.g., an alternating order) to the anomaly detection model 1514 and the power prediction model 1516. Both the anomaly detection model 1514 and the power prediction model 1516 may analyze the wind farm behavior data table 1512 with reference to multiple distinct components and subcomponents of each wind turbine, including but not limited to a rotor, tower, nacelle, main bearing, gearbox, generator, transformer, hydraulic unit, and rotor blades.

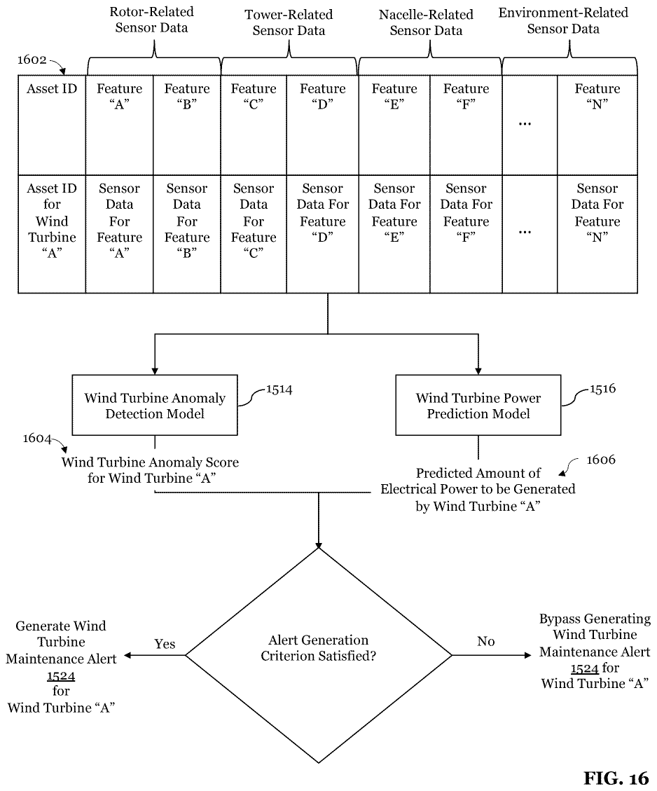

A non-limiting example of a row within the wind farm behavior data table 1512 is depicted with reference to FIG. 16. For instance, FIG. 16 may depict a row 1602 of the wind farm behavior data table 1512 corresponding to a target wind turbine within the plurality of distinct wind turbines 2104 (i.e., Wind Turbine A). The row 1602 may include an entry within a column whose values indicate the energy asset associated with a particular row. Accordingly, this entry for row 1602 may include an asset identifier unique to the target wind turbine relative to each other wind turbine within the plurality of distinct wind turbines 2104.

Additionally, the row 1602 may include entries within other columns for the asset data and the enriched set of attributes values, where each entry of the other columns may correspond to a respective feature associated with the wind turbine whose asset identifier is within row 1602. In some examples, the row 1602 may include sensor data associated with or corresponding to a plurality of distinct components of a wind turbine, such as rotor-related, tower-related, and nacelle-related values, together with the environment-related values. The inclusion of multiple categories of data within a single row may enable the anomaly detection model 1514 and power prediction model 1516 to identify correlations across components and environmental conditions, improving the accuracy of identifying operational deviations and forecasting turbine performance.

In some examples, the row 1602 may include entries for rotor-related sensor data (e.g., the rotor-related sensor data from wind turbine data 1502 and/or the enriched set of rotor-related attribute values from the enriched set of attribute values 1508). The rotor-related sensor data included in row 1602 for the target wind turbine may include one or more of a first rotor blade load value representing a mechanical load experienced by a first rotor blade of the plurality of distinct rotor blades 2202 associated with the target wind turbine, a second rotor blade load value representing a mechanical load experienced by a second rotor blade of the plurality of distinct rotor blades 2202 associated with the target wind turbine, a third rotor blade load value representing a mechanical load experienced by a third rotor blade of the plurality of distinct rotor blades 2202 associated with the target wind turbine, a rotor blade pitch angle value representing an angular position of the plurality of distinct rotor blades 2202 associated with the target wind turbine, a rotor temperature value representing a temperature of the respective rotor of the target wind turbine, and a rotor speed value representing a rotational speed of the respective rotor of the target wind turbine. The rotor blade pitch angle value may correspond to the degree of rotation of a rotor blade about its longitudinal axis to control the aerodynamic efficiency of the blade. Adjustments to the blade pitch may regulate the amount of wind energy captured and may mitigate excessive mechanical stress under varying wind conditions. Additionally, the rotor speed may be a factor in determining power output and may be proportional (e.g., directly proportional) to wind speed. Each of these may values may be within an entry within a distinct column and may thus represent a distinct feature of the target wind turbine.

Additionally, or alternatively, the row 1602 may include entries for tower-related sensor data (e.g., the tower-related sensor data from wind turbine data 1502 and/or the enriched set of tower-related attribute values from the enriched set of attribute values 1508). The tower-related sensor data in row 1602 for the target wind turbine may include one or more of a first tower acceleration value representing an acceleration of the respective tower 2224 of the target wind turbine relative to a first axis of the target wind turbine, a second tower acceleration value representing an acceleration of the respective tower 2224 of the target wind turbine relative to a second axis orthogonal to the first axis, and a tower temperature value representing a temperature observed proximal to a bottom portion of the respective tower 2224 of the target wind turbine. Accelerations measured along orthogonal axes (e.g., the first and second tower acceleration values) may reveal structural vibrations, imbalances, or oscillations in the tower, which may serve as early indicators of mechanical stress, component misalignment, or developing faults in the rotor-nacelle assembly. For instance, high tower acceleration may be observed before temperature-related issues occur at a wind turbine. Each of these may values may be within an entry within a distinct column and may thus represent a distinct feature of the target wind turbine.

Additionally, or alternatively, the row 1602 may include entries for nacelle-related sensor data (e.g., the nacelle-related sensor data from wind turbine data 1502 and/or the enriched set of nacelle-related attribute values from the enriched set of attribute values 1508). The nacelle-related sensor data may include one or more of a nacelle direction value representing an angular orientation of the respective nacelle of the target wind turbine, a nacelle temperature value representing a temperature of the respective nacelle of the target wind turbine, a first gearbox bearing temperature value representing a temperature observed at a first bearing located within the gearbox 2210 of the respective nacelle of the target wind turbine, a second gearbox bearing temperature value representing a temperature observed at a second bearing located within the gearbox 2210 of the respective nacelle of the target wind turbine, and a gearbox oil temperature value representing a temperature of oil circulating within the gearbox 2210 of the respective nacelle of the target wind turbine. The nacelle direction value may indicate the yaw orientation of the nacelle relative to the prevailing wind direction. Misalignment between nacelle direction and wind direction may reduce aerodynamic efficiency, cause uneven mechanical loading, and contribute to accelerated wear of drivetrain components. Each of these may values may be within an entry within a distinct column and may thus represent a distinct feature of the target wind turbine.

Additionally, or alternatively, the nacelle-related sensor data may include one or more of a generator speed value representing a rotational speed of a generator shaft located within the generator 2214 of the respective nacelle of the target wind turbine, a first bearing temperature value representing a temperature observed at a first bearing located within the generator 2214 of the respective nacelle of the target wind turbine, a second bearing temperature value representing a temperature observed at a second bearing located within the generator 2214 of the respective nacelle of the target wind turbine, at least one stator winding temperature value representing a temperature observed at a stator winding located within the generator 2214 of the respective nacelle of the target wind turbine, a third bearing temperature value representing a temperature observed at a third bearing located within the generator 2214 of the respective nacelle of the target wind turbine, a fourth bearing temperature value representing a temperature observed at a fourth bearing located within the generator 2214 of the respective nacelle of the target wind turbine, at least one voltage value representing an amount of electrical voltage generated by the generator 2214 of the respective nacelle of the target wind turbine, at least one electrical current value representing an amount of alternating current produced by the generator 2214 of the respective nacelle of the target wind turbine, and an electrical frequency value representing a frequency of the alternating current produced by the generator 2214 of the respective nacelle of the target wind turbine (e.g., in Hertz). Each of these may values may be within an entry within a distinct column and may thus represent a distinct feature of the target wind turbine.

Additionally, or alternatively, the nacelle-related sensor data included in the row 1602 may include at least one transformer temperature value representing a temperature of the transformer located within the respective nacelle of the target wind turbine, a hydraulic pressure value representing a fluid pressure within the hydraulic unit of the respective nacelle of the target wind turbine, or a hydraulic oil temperature value representing a temperature of hydraulic oil used within the hydraulic unit of the respective nacelle of the target wind turbine. Each of these may values may be within an entry within a distinct column and may thus represent a distinct feature of the target wind turbine.

In some examples, the row 1602 may include entries for environment-related sensor data (e.g., the environment-related sensor data from wind turbine data 1502 and/or the enriched set of environment-related attribute values from the enriched set of attribute values 1508). The environment-related sensor data in row 1602 for the target wind turbine may include one or more of an ambient temperature value representing an air temperature measured at the target wind turbine, a wind direction value representing an angular direction from which wind approaches the target wind turbine, a wind speed value representing a speed of the wind observed at the target wind turbine, and a wind turbulence intensity value representing a degree of variability in the speed of the wind observed at the target wind turbine over a predetermined time span (e.g., 10 minutes). Each of these may values may be within an entry within a distinct column and may thus represent a distinct feature of the target wind turbine.

In some examples, wind farm behavior data table 1512 may be derived from a larger originally generated data structure. For instance, after receiving the asset data and the enriched set of attributes values, data table generator 1510 may initially generate an original wind farm behavior data structure that includes asset data and enriched sets of attributes values for wind turbines operating in different power-generating states and with different operating region class values. Filtering the original wind farm behavior data structure in this manner may reduce a total quantity of inferences performed by anomaly detection model 1514 and/or power prediction model 1516. Reducing the total quantity of inferences may decrease GPU consumption, CPU consumption, and memory consumption during real-time execution. In some examples, tens, hundreds, or even thousands of rows that correspond to non-operational states or irrelevant operating regions may be removed, thereby streamlining the dataset to include only meaningful operational data that supports efficient and accurate anomaly detection and power prediction.

In a non-limiting example, the original wind farm behavior data structure may include a first set of rows corresponding to a first subset of the plurality of distinct wind turbines 2104 that are operating in the power-generating state and have the respective operating class value that satisfies one of the first operating class criterion (e.g., being within the transitional operating region class) and the second operating class criterion (e.g., being within the rated-power operating region class). Additionally, the original wind farm behavior data structure may include a second set of rows corresponding to a second subset of the plurality of distinct wind turbines 2104 that are operating in the non-power-generating state and a third set of rows corresponding to a third subset of the plurality of distinct wind turbines 2104 having the respective operating region class value that does not satisfy the first operating class criterion and the second operating class criterion (e.g., they are within the low-wind operation region class or the high-wind operating region class).

Because the second subset of the plurality of distinct wind turbines 2104 is operating in the non-power-generating state (e.g., are not actively generating power), data table generator 1510 may filter the second set of rows out of the original wind farm behavior data structure. Similarly, because the third subset of the plurality of distinct wind turbines 2104 has the operating region class value that does not satisfy the first and second operating class criteria, data table generator 1510 may filter the third set of rows out of the original wind farm behavior data structure. Accordingly, the data structure output by data table generator 1510 (e.g., wind farm behavior data table 1512) may include the first set of rows corresponding to the first subset of the plurality of distinct wind turbines 2104 and may not include the second set of rows and the third set of rows (e.g., wind farm behavior data table 1512 may be a filtered version of the original wind farm behavior data structure with reduced rows). This reduction in rows may enable faster anomaly detection and alert generation, as the anomaly detection model 1514 and power prediction model 1516 may process only the most relevant operational data rather than expend resources analyzing non-operational or out-of-scope conditions.

As shown in FIG. 14, process 1440 of method 1400 may include performing one or more operations in response to generating the energy farm behavior data structure. For instance, sub-process 1440A of process 1440 may include computing, using an anomaly detection model, an energy asset anomaly score for each distinct energy asset included in the energy farm behavior data structure. An anomaly detection model may refer to a machine learning or statistical model configured to evaluate asset data and enriched attributes values within an energy farm behavior data structure and to output an energy asset anomaly score that represents a degree to which operational behavior of an energy asset deviates from predefined or historically observed patterns. The energy asset anomaly score may serve as a quantitative indicator of the likelihood or severity of abnormal operation. For instance, a higher energy asset anomaly score may indicate a higher predicted degree that an energy asset is behaving anomalously. Stated another way, in some embodiments, the energy asset anomaly score computed for a respective energy asset (e.g., wind turbine) may indicate a degree or likelihood that the respective energy asset is behaving anomalously. For instance, in a non-limiting example, the energy asset anomaly score computed for the respective energy asset (e.g., wind turbine) may be a numerical value within a predetermined score range (e.g., zero (0) and one (1), zero (o) and one hundred (100), etc.) in which a higher energy asset anomaly score (e.g., ninety (90), ninety-five (95), etc.) indicates a higher likelihood that the respective energy asset is behaving anomalously and vice versa.

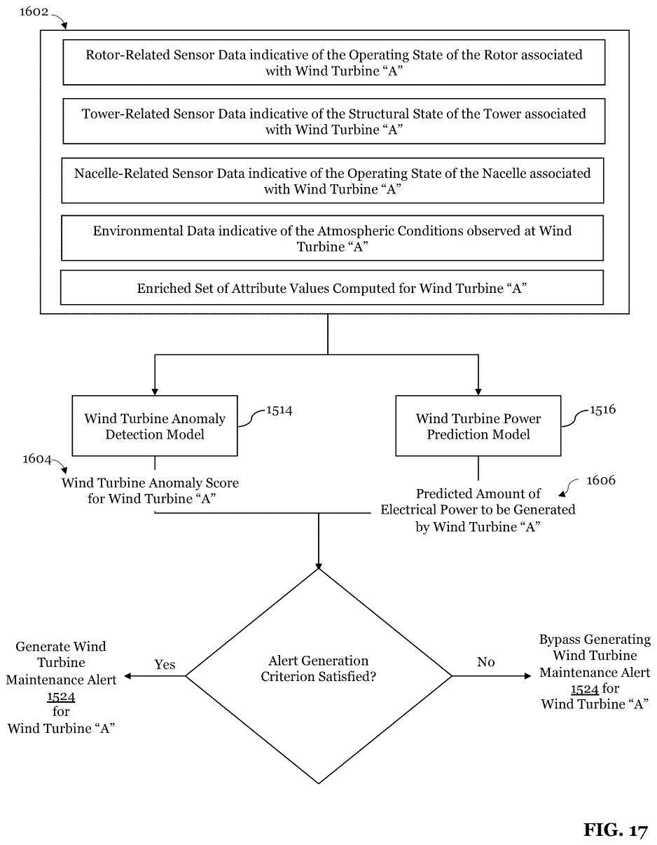

In a non-limiting example, as described with reference to FIGS. 15 through 17, a wind turbine anomaly detection model 1514 (e.g., an example of an anomaly detection model as described herein) may receive wind farm behavior data table 1512 as input from data table generator 1510 and may compute a wind turbine anomaly score 1604 for each distinct wind turbine of the plurality of distinct wind turbines 2104 included in the wind farm behavior data table 1512.

In some examples, wind turbine anomaly detection model 1514 computing the wind turbine anomaly score 1604 for the target wind turbine (i.e., Wind Turbine A) includes providing, as input to the wind turbine anomaly detection model 1514, row 1602 of the wind farm behavior data table 1512 that corresponds to the target wind turbine. In such examples, the row 1602 includes one or more of the rotor-related sensor data indicative of the operating state of the respective rotor of the target wind turbine, the tower-related sensor data indicative of the structural state of the respective tower of the target wind turbine, the nacelle-related sensor data indicative of the operating state of the respective nacelle of the target wind turbine, the enriched set of attribute values computed for the target wind turbine, the environmental data indicative of the atmospheric conditions observed at the target wind turbine, and the turbine power data indicative of the actual amount of electrical power generated by the target wind turbine. The actual amount of electrical power may refer to the real-world power output measured from the wind turbine under operating conditions, as distinguished from simulated or predicted power values. In response to providing the row 1602 associated with the target wind turbine to the wind turbine anomaly detection model 1514, the wind turbine anomaly detection model 1514 may compute the wind turbine anomaly score 1604 for the target wind turbine based on the one or more of the rotor-related sensor data, the tower-related sensor data, the nacelle-related sensor data, the enriched set of attribute values, the environmental data, and the turbine power data included in the respective row corresponding to the target wind turbine.

Sub-process 1440A may train the anomaly detection model in an offline phase using a corpus of training data that includes historical asset data captured from one or more energy assets. For instance, the corpus of training data may include a set of unlabeled training data samples associated with the one or more energy assets. Sub-process 1440A may then train the anomaly detection model as an unsupervised machine learning model. In order to train the unsupervised machine learning model, sub-process 1440A may detect a respective anomaly score for each unlabeled training data sample included in the corpus of training data and may generate a set of anomaly scores in response to computing the respective anomaly score for each unlabeled training data sample included in the corpus of training data. In such examples, the set of anomaly scores includes the respective anomaly score computed for each unlabeled training data sample included in the corpus of training data. Sub-process 1440A may then identify, within the set of anomaly scores, an anomaly score value that corresponds to a target quantile and, in response to identifying the anomaly score value that corresponds to the target quantile, set a predefined maximum anomaly score threshold based on the anomaly score value. Anomaly scores computed for particular energy assets may exceed the predefined maximum anomaly score based on the anomaly score being greater than or equal to the predefined maximum anomaly score.

For instance, in a non-limiting example, historical training data may be collected from a wind farm over a seven-day period at ten-minute intervals. In such examples, the training corpus may include thousands of unlabeled data samples representing operational measurements from multiple wind turbines. When the anomaly detection model is trained on this corpus or at least a subset of the training corpus, the anomaly detection model may compute an anomaly score for each data sample. If the distribution of anomaly scores computed by the anomaly detection indicates that the 99th percentile (e.g., target quantile or the like) corresponds to a score value of 72 on a scale of zero to one hundred, then the system may automatically establish or define a maximum anomaly score threshold of 72. In this manner, the predefined threshold may not be selected arbitrarily but may instead be determined based in part on using the trained anomaly detection model, ensuring that the anomaly detection model or the system or service implementing method process 1400 distinguishes between normal and anomalous operating behavior in a data-driven manner.

In a non-limiting example, as described with reference to FIG. 15, the anomaly detection model may be wind turbine anomaly detection model 1514 and the set of unlabeled training data samples may be a set of unlabeled wind turbine training data samples. In such examples, each unlabeled wind turbine training data sample of the set may include sensor data captured by a set of sensors positioned on a subject wind turbine.

Additionally, as shown in FIG. 14, sub-process 1440B of process 1440 may include computing, by a power prediction model, a predicted amount of electrical power to be generated by each distinct energy asset included in the energy farm behavior data structure. A power prediction model may refer to a machine learning or statistical model configured to estimate (e.g., predict) an amount of electrical power to be generated by an energy asset based on input asset data and enriched attribute values. The predicted power may differ from the actual or observed power in that the predicted power represents an expected output under given operating and environmental conditions, whereas the actual or observed power corresponds to the real-world electrical output measured directly from the energy asset during operation.

In a non-limiting example, as described with reference to FIGS. 15 through 17, a wind turbine power prediction model 1516 (e.g., an example of a power prediction model as described herein) may receive wind farm behavior data table 1512 as input from data table generator 1510 and may compute a predicted amount of electrical power 1606 for each distinct wind turbine of the plurality of distinct wind turbines 2104 included in the wind farm behavior data table 1512.

In some examples, wind turbine power prediction model 1516 computing the predicted amount of electrical power to be generated by the target wind turbine (i.e., Wind Turbine A) includes providing, as input to the wind turbine power prediction model 1516, row 1602 of the wind farm behavior data table 1512 corresponding to the target wind turbine. In response to providing the row 1602 associated with the target wind turbine to the wind turbine power prediction model 1516, wind turbine prediction model 1516 may compute the predicted amount of electrical power 1606 to be generated by the target wind turbine. The wind turbine power prediction model may compute the predicted amount of electrical power to be generated by the target wind turbine based on the one or more of the rotor-related sensor data, the tower-related sensor data, the nacelle-related sensor data, the enriched set of attribute values, and the environmental data included in row 1602 corresponding to the target wind turbine. It should be noted that the predicted amount of electrical power 1606 may be measured in watts, kilowatts, megawatts, or another quantity of measure.

Sub-process 1440B may train the power prediction model in an offline phase using a corpus of training data that includes a plurality of distinct training data samples. For instance, sub-process 1440B may train a supervised machine learning model using the corpus of training data, where the trained supervised machine learning model corresponds to (e.g., is) the power prediction model. In a non-limiting example, as described with reference to FIG. 15, the power prediction model being trained may be wind turbine power prediction model 1516 and the plurality of distinct training data samples may be a plurality of distinct wind turbine training data samples. In some such examples, each distinct wind turbine training data sample of the plurality of distinct wind turbine training data samples may include sensor data captured by a set of sensors positioned on a subject wind turbine and a turbine power value representing a real-world amount of electrical power generated by the subject wind turbine. The phrase “real-world amount of electrical power” may refer to the actual power output measured from an energy asset (e.g., via a sensor) under operating conditions, expressed in physical units such as kilowatts or megawatts. Such values may exclude simulated or predicted values such that the training dataset reflects observed operational performance.

It should be noted that training in the offline phase may be associated with one or more inputs and one or more outputs. For instance, historical energy farm data, alarm rules, and energy asset design specifications may be pre-processed and provided to the anomaly detection model and/or the power prediction model. Performing pre-processing may include computing enriched attribute values for historical sensor data and constructing an analytical data table from the enriched attribute values and the historical sensor data. The pre-processing may additionally include aligning time-stamped measures that are received from multiple sensors and filtering rows within the analytical data table to remove records corresponding to non-operational states or operating regions that are out-of-scope.

The outputs of the anomaly detection model and/or the power prediction model during the offline phase may undergo post-processing to generate anomaly detection model parameters, prediction model parameters, surrogate modeling parameters, and/or energy farm configuration parameters. Additionally, or alternatively, the post-processing may produce one more logs or output files including a power summary, a power curve uncertainty, a power curve region profile, turbine pairs and turbine loadings (e.g., in examples where the energy asset is a turbine), power coefficients, capacity factors, power predictions, an indication of variables that satisfy one or more criteria, an indication of a goodness of model fit, an anomaly score and summary, and/or Shapley value explanations (e.g., in examples where the anomaly detection model and/or power prediction model output Shapley values). Additionally, or alternatively, the post-processing may produce one or more visualization artifacts related to the outputs of these models.

As shown in FIGS. 14A and 14B, processes 1450A and 1450B of method 1400 may include generating a maintenance alert for a target energy asset of the plurality of distinct energy assets operating at the energy farm. A maintenance alert may refer to an electronically generated notification produced by a monitoring system in response to detecting anomalous behavior as described with reference to process 1450A and/or underperformance of an energy asset as described with reference to process 1450B. The maintenance alert may identify a target energy asset and a condition that triggered the maintenance alert. In some examples, the maintenance alert may indicate particular components of the energy asset associated with the condition. Additionally, the maintenance alert may include a natural language explanation describing a cause or a reason for the condition. Process 1450A and/or 1450B may provide the maintenance alert to a user device via a user interface.

As described herein, the maintenance alert may specify a component or subcomponent of the target energy asset associated with the anomalous behavior or underperformance. For instance, the maintenance alert may identify a hydraulic unit, rotor, bearing, gearbox, generator, transformer, or nacelle subsystem as the source of the detected condition. By directing attention to a specific component or subcomponent of the target energy asset (e.g., wind turbine), the maintenance alert may enable underlying issues to be diagnosed and addressed more efficiently, reducing the time spent locating faults and facilitating targeted repairs.

In a non-limiting example, as described with reference to FIG. 15, wind turbine anomaly detection model 1514 may provide an indication of one or more predicted wind turbine anomalies 1518 to alert generator 1522 and wind turbine power prediction model 1516 may provide one or more wind turbine power predictions 1520 to alert generator 1522. Alert generator 1522 may then generate a wind turbine maintenance alert 1524 corresponding to the one or more predicted wind turbine anomalies 1518 and/or the one or more wind turbine power predictions 1520.

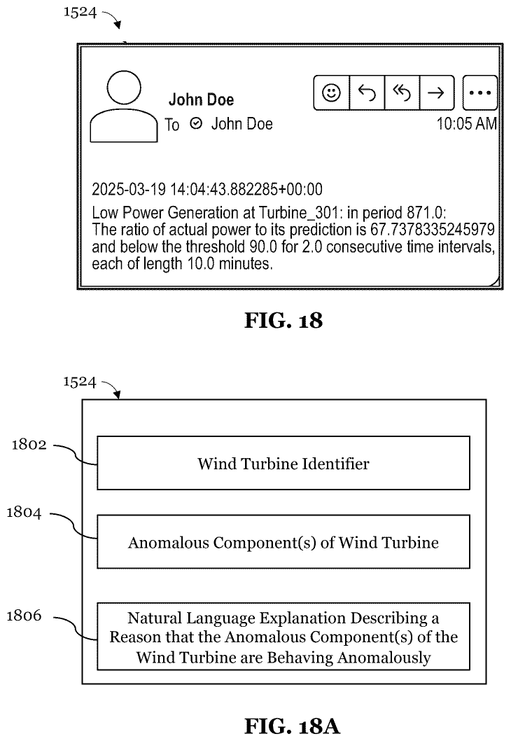

A non-limiting example of a wind turbine maintenance alert 1524 in response to power generation underperformance as predicted by power prediction model 1516 may be provided with reference to FIGS. 18 and 18A. The wind turbine maintenance alert 1524 may include a wind turbine identifier 1802 (e.g., “Turbine_301”) corresponding to a target wind turbine and a natural language explanation describing a reason that the wind turbine is behaving anomalously (e.g., “The ratio of actual power to its prediction is 67.7378335245979 and below the threshold 90.0 for 2.0 consecutive time intervals, each of length 10.0 minutes”). The wind turbine maintenance alert 1524 may, in some examples, include an indication of one or more anomalous components 1804 of the target wind turbine (e.g., a main shaft bearings 2220 as described with reference to FIG. 22) and a natural language explanation 1806 describing a reason that the anomalous component is behaving anomalously (e.g., the main shaft bearings 2220 needs to be relubricated). In some examples, the wind turbine maintenance alert 1524 may include temporal information indicating when power generation underperformance was detected and/or when the wind turbine maintenance alert 1524 was generated (e.g., “2025-03-19 at 14:04:43.882285+00:00”).

Another example of a wind turbine maintenance alert 1524 may include an indication of a hydraulic unit 2216 as one of the one or more anomalous components and a natural language explanation describing a condition associated with the hydraulic system (e.g., the hydraulic unit has exceeded its predefined maximum oil temperature threshold and requires oil replacement). For instance, the hydraulic unit 2216 may be identified as anomalous when a corresponding hydraulic oil temperature sensor feature exceeds a predefined maximum oil temperature threshold (e.g., 80 degrees Celsius), indicating that the hydraulic oil has degraded and should be replaced. To facilitate detecting that the hydraulic unit 2216 is anomalous, an anomaly score explainability algorithm described herein may take the hydraulic oil temperature feature as an input and may output a Shapley value that provides an indication of a contribution of the temperature of the hydraulic oil to an overall anomaly score. If the Shapley value is elevated relative to Shapley values generated for other sensor features, the temperature of the hydraulic oil may be a primary contributor to anomalous behavior and may thus be indicated in the wind turbine maintenance alert 1524.

As shown in FIG. 14A, process 1450A may include detecting the energy asset anomaly score computed for the target energy asset exceeds a predefined maximum anomaly score threshold. The predefined maximum anomaly score threshold may be an upper limit (e.g., a quantile-based cutoff) that is used to distinguish between normal operational behavior and anomalous operational behavior of an energy asset. In some examples, the predefined maximum anomaly score threshold may be determined during offline training of the anomaly detection model. For instance, the threshold may be derived directly from a distribution of anomaly scores generated during an associated training process (e.g., rather than being set randomly or arbitrarily).

In a non-limiting example, as described with reference to FIGS. 15 and 16, wind turbine anomaly detection model 1514 may generate a wind turbine anomaly score 1604 for a target wind turbine (i.e., Wind Turbine A) and may include the wind turbine anomaly score 1604 in the predicted wind turbine anomalies 1518 provided to alert generator 1522. Alert generator 1522 may then determine if the wind turbine anomaly score 1604 satisfies the predetermined maximum anomaly score threshold. If so, alert generator 1522 may generate a corresponding wind turbine maintenance alert 1524. Otherwise, alert generator 1522 may refrain from (e.g., bypass) performing the generation.

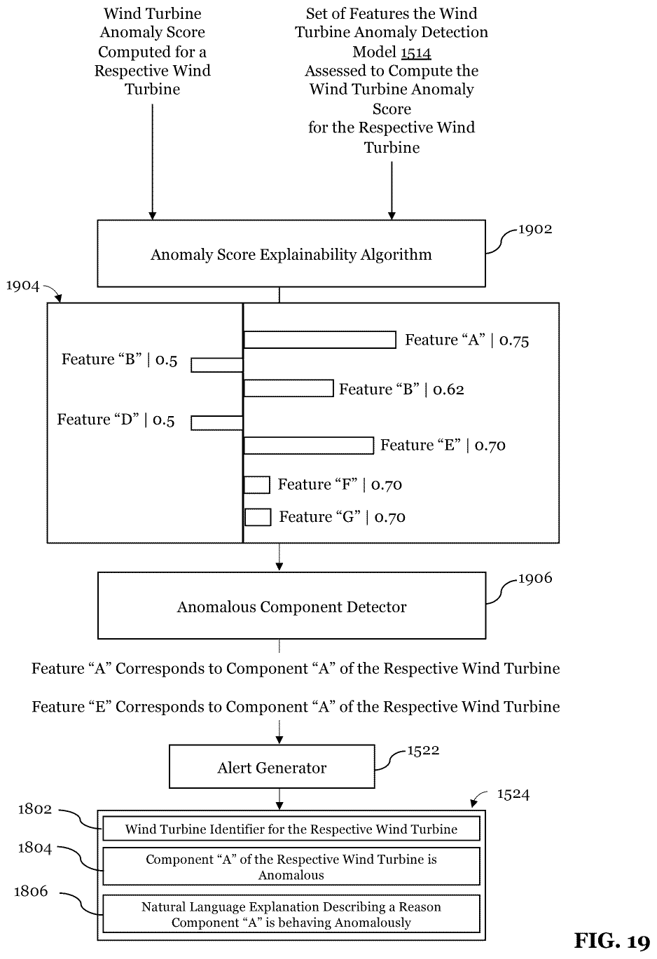

In examples in which the wind turbine anomaly score 1604 computed for the target wind turbine exceeds the predefined maximum anomaly score threshold, the wind turbine maintenance alert 1524 generated by alert generator 1522 may include an indication of which one or more components of the target wind turbine is contributing most significantly to the excessive wind turbine anomaly score 1604. In order to determine which one or more components are contributing most significantly, alert generator 1522 may utilize an anomaly score explainability algorithm 1902 and an anomalous component detector 1906 as described with reference to FIG. 19.

For instance, in a non-limiting example as described with reference to FIG. 19, alert generator 1522 may input (e.g., provide) the wind turbine anomaly score 1604 and the set of features that the wind turbine anomaly detection model 1514 assessed to compute the wind turbine anomaly score 1604 (e.g., the sensor data and/or the enriched attribute values within row 1602) into an anomaly score explainability algorithm 1902, where each feature of the set of features includes a representation of a distinct piece of sensor data captured for a respective component of the target wind turbine. Alert generator 1522 may then execute anomaly score explainability algorithm 1902 in order to compute feature contribution values 1904. Each feature of feature contribution values 1904 may include a respective contribution value indicating an extent to which that respective feature contributed to the wind turbine anomaly score 1604. A feature contribution value may refer to a numerical weight or score assigned to a given feature that quantifies the influence of that feature on the overall anomaly score, with higher values indicating stronger influence and lower values indicating weaker influence. Anomaly score explainability algorithm 1902 may output the feature contribution values 1904 to anomalous component detector 1906.

In examples in which the feature contribution values 1904 are Shapley values, anomalous component detector 1906 may update the values according to whether the corresponding Shapley intercept is lower than, equal to, or higher than the wind turbine anomaly score 1604. For instance, if the wind turbine anomaly score 1604 is represented by S_{TurbineAnomaly}, the Shapley intercept is represented by interceptₛₕₚ, and an ith feature contribution value of the feature contribution values 1904 is represented by shpᵢ, then shpᵢ may be given an updated value according to (MIN(shpᵢ, 0)/(S_{TurbineAnomaly}−interceptₛₕₚ))*100 if S_{TurbineAnomaly}<interceptₛₕₚ and be value may given an updated according to (MAX(shpᵢ, 0)/(S_{TurbineAnomaly}−interceptₛₕₚ))*100 if S_{TurbineAnomaly}≥interceptₛₕₚ, where MIN(*) is a function that selects the lowest value between shpᵢ and 0 and MAX (*) is a function that selects the highest value between shpᵢ and 0.

Additionally, anomalous component detector 1906 may normalize the feature contribution values 1904 so that their total contribution when summed is equal to a predetermined value (e.g., 100). The normalization may occur after updating contribution values according to a value of the Shapley intercept or may occur in its stead. Once the feature contribution values 1904 have been normalized, anomalous component detector 106 may aggregate (e.g., summarize) the normalized feature contribution values according to their associated component. For instance, in a non-limiting example, Features A and C in FIG. 19 may correspond to Component A (e.g., a generator 2214); Feature F may correspond to Component B (e.g., a hydraulic unit 2216); and Features B, D, and G may correspond to Component C (e.g., a gearbox 2210). Accordingly, the normalized feature contribution values associated with Features A and C may be aggregated to represent a first contribution value for Component A; the normalized feature contribution value associated with Feature F may represent a second contribution value for Component B; and the normalized feature contribution values for Features B, D, and G may be aggregated to represent a third contribution value for Component C. The anomalous component detector 1906 may then determine if the first, second, or third contribution value exceeds an anomalous component criterion and, if so, may indicate that anomalous component to alert generator 1522. For instance, as depicted in FIG. 19, only the first contribution value associated with Component A may exceed the anomalous component criterion and, accordingly, anomalous component detector 1906 may indicate Component A to alert generator 1522. As noted herein, the feature contribution values 1904 may be derived from Shapley value computations, where each Shapley value may represent a degree of contribution of a given feature to an overall anomaly score. By aggregating the Shapley values associated with related features, the system may attribute anomalous behavior to specific components or sub-components of a wind turbine and such components may be identified as anomalous components for inclusion in the maintenance alert. It should be noted that the identified component may correspond broadly to any major subsystem of the wind turbine, such as a rotor, tower, or nacelle, or to a subcomponent thereof, such as a main bearing, gearbox, generator, transformer, or hydraulic unit, or any combination of the foregoing.

Alternatively, the anomalous component criterion may be compared against each of the feature contribution values 1904. For instance, in FIG. 19, a first subset of the feature contribution values 1904 (e.g., Feature A and Feature E) may satisfy an anomalous component criterion, whereas the remaining subset of the feature contribution values (e.g., Features B, C, D, F, and G) may fail to satisfy the anomalous component criterion. Anomalous component detector 1906 may then identify one or more components corresponding to first subset of the feature contribution values that satisfy the anomalous component criterion (i.e., Component A) and may output an indication of the first subset of feature contribution values 1904 as well as the one or more components to alert generator 1522.

In examples in which each feature value included in a row of the wind farm behavior data table is associated with a Shapley value that quantifies the contribution of that feature to the anomaly score, the aggregated Shapley values for features associated with a given component may determine whether the component is anomalous. In such examples, a single deviant feature may have a sufficiently high Shapley value to cause the component to be flagged as anomalous. Alternatively, individual features may not appear anomalous when considered in isolation, but the combined contribution of multiple features may collectively exceed the anomalous component criterion, thereby identifying the associated component as anomalous.

The wind turbine maintenance alert 1524 generated for the target wind turbine by alert generator 1522 may include the respective wind turbine identifier 1802 corresponding to the target wind turbine, the respective one or more anomalous component 1804 corresponding to the at least one feature that satisfies the anomalous component criterion (e.g., Component A), and a natural language explanation 1806 describing a reason that the respective component corresponding to the at least one feature is causing the target wind turbine to behave anomalously. The natural language explanation 1806 may be generated by filling predefined templates with slots populated by the identified component and its triggering measurement or by using a large language model configured to produce explanatory text based on structured inputs. The natural language explanation 1806 may provide an interpretable statement linking underlying feature contribution values to an actionable maintenance alert.

Additionally, the alert generator 1522 may transmit, using an electronic messaging service, the wind turbine maintenance alert generated for the target wind turbine to a target entity and may display the wind turbine maintenance alert generated for the target wind turbine on a graphical user interface. It should be noted that there may be examples where the functionalities of anomaly score explainability algorithm 1902 and anomalous component detector 1906 may be performed at a module distinct from, but in communication with, alert generator 1522 (e.g., a module between wind turbine anomaly detection model 1514 and alert generator 1522).

As shown in FIG. 14B, process 1450B may include detecting an observed amount of electrical power generated by the target energy asset fails to satisfy a predetermined minimum power generation threshold for a predetermined time duration. The observed amount of electrical power may refer to the actual real-world power output measured from the energy asset during operation, expressed in physical units such as kilowatts or megawatts, and distinguished from simulated or predicted power values. The predefined maximum anomaly score threshold may refer to a lower limit on electrical power output established for a target energy asset to determine whether the asset is generating sufficient power under given operating conditions. In some examples, the predetermined minimum power generation threshold may be determined during offline training of the power prediction model.

In a non-limiting example, as described with reference to FIGS. 15 and 16, wind turbine power prediction model 1516 may generate a predicted amount of electrical power 1606 to be generated by a target wind turbine (i.e., Wind Turbine A) and may include the predicted amount of electrical power 1606 in the wind turbine power predictions 1520 provided to alert generator 1522. Alert generator 1522 may then determine if the predicted amount of electrical power 1606 satisfies the predetermined minimum power generation threshold. If so, alert generator 1522 may generate a corresponding wind turbine maintenance alert 1524. Otherwise, alert generator 1522 may refrain from (e.g., bypass) performing the generation.

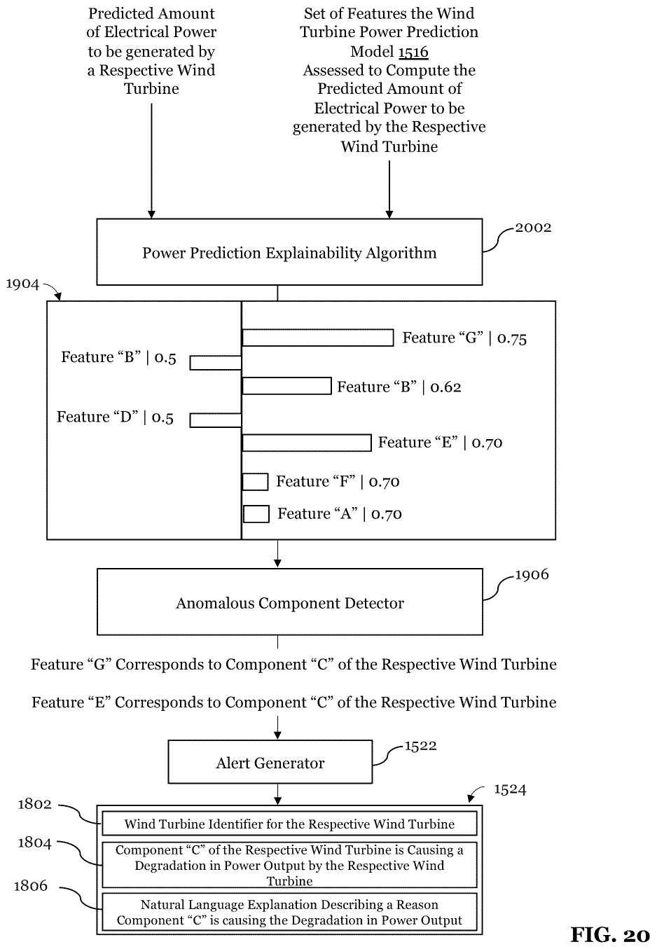

In examples in which the predicted amount of electrical power 1606 computed for the target wind turbine is below the predetermined minimum power generation threshold, the wind turbine maintenance alert 1524 generated by alert generator 1522 may include an indication of which one or more components of the target wind turbine is contributing most significantly to the reduced predicted amount of electrical power 1606. In order to determine which one or more components are contributing most significantly, alert generator 1522 may utilize a power prediction explainability algorithm 2002 and an anomalous component detector 1906 as described with reference to FIG. 20.

For instance, in a non-limiting example as described with reference to FIG. 20, alert generator 1522 may input (e.g., provide) the predicted amount of electrical power 1606 and the set of features that the wind turbine power prediction model 1516 assessed to compute the predicted amount of electrical power 1606 (e.g., the sensor data and/or the enriched attribute values within row 1602) into a power prediction explainability algorithm 2002, where each feature of the set of features includes a representation of a distinct piece of sensor data captured for a respective component of the target wind turbine. Alert generator 1522 may then execute power prediction explainability algorithm 2002 in order to compute feature contribution values 1904. Each feature of feature contribution values 1904 may include a respective contribution value indicating an extent to which that respective feature contributed to the predicted amount of electrical power 1606. Power prediction explainability algorithm 2002 may output the feature contribution values 1904 to anomalous component detector 1906.

In examples in which the feature contribution values 1904 are Shapley values, anomalous component detector 1906 may update their values according to whether the corresponding Shapley intercept is lower than, equal to, or higher than the predicted amount of electrical power 1606. For instance, if the predicted amount of electrical power 1606 is represented by P_{TurbinePower}, the Shapley intercept is represented by interceptₛₕₚ, and an ith feature contribution value of the feature contribution values 1904 is represented by shpᵢ, then shpᵢ may be given an updated value according to (MIN(shpᵢ, 0)/(P_{TurbinePower}−interceptₛₕₚ))*100 if P_{TurbinePower}<interceptₛₕₚ and may be given an updated value according to (MAX(shpᵢ, 0)/(P_{TurbinePower}−interceptₛₕₚ))*100 if P_{TurbinePower}≥interceptₛₕₚ, where MIN(*) is a function that selects the lowest value between shpᵢ and 0 and MAX (*) is a function that selects the highest value between shpᵢ and 0.

Additionally, anomalous component detector 1906 may normalize feature contribution values 1904 so that their total contribution when summed is equal to a predetermined value (e.g., 100). The normalization may occur after updating contribution values according to a value of the Shapley intercept. Once the feature contribution values 1904 have been normalized, anomalous component detector 1906 may aggregate them (e.g., summarize them) according to their associated component. For instance, in a non-limiting example, Features A, B, and D in FIG. 20 may correspond to Component A (e.g., a generator 2214); Feature F may correspond to Component B (e.g., a hydraulic unit 2216); and Features C and G may correspond to Component C (e.g., a gearbox 2210). Accordingly, the normalized feature contribution values associated with Features A, B, and D may be aggregated to represent a first contribution value for Component A; the normalized feature contribution value associated with Feature F may represent a second contribution value for Component B; and the normalized feature contribution values for Features C and G may be aggregated to represent a third contribution value for Component C. The anomalous component detector 1906 may then determine if the first, second, or third contribution value exceeds an anomalous component criterion and, if so, may indicate that anomalous component to alert generator 1522. For instance, as depicted in FIG. 20, only the third contribution value associated with Component C may exceed the anomalous component criterion and, accordingly, anomalous component detector 1906 may indicate Component C to alert generator 1522. As noted herein, the feature contribution values 1904 may be derived from Shapley value computations, where each Shapley value may represent a marginal contribution of a given feature to an overall predicted amount of electrical power. By aggregating the Shapley values associated with related features, the system may attribute anomalous behavior to specific components or sub-components of a wind turbine and such components may be identified as anomalous components for inclusion in the maintenance alert. It should be noted that the identified component may correspond broadly to any major subsystem of the wind turbine, such as a rotor, tower, or nacelle, or to a subcomponent thereof, such as a main bearing, gearbox, generator, transformer, or hydraulic unit, or any combination of the foregoing

Alternatively, the anomalous component criterion may be compared against each of the feature contribution values 1904. For instance, in FIG. 20, a first subset of the feature contribution values 1904 (e.g., Feature G and Feature E) may satisfy an anomalous component criterion (e.g., having a feature contribution value greater than or equal to 0.70), whereas the remaining subset of the feature contribution values (e.g., Features A, B, C, D, and F) may fail to satisfy the anomalous component criterion. Anomalous component detector 1906 may then identify one or more components corresponding to first subset of the feature contribution values that satisfy the anomalous component criterion (i.e., Component C) and may provide an indication of the first subset of feature contribution values 1904 as well as the one or more components to alert generator 1522.

In examples in which each feature value included in a row of the wind farm behavior data table is associated with a Shapley value that quantifies the contribution of that feature to the anomaly score, the aggregated Shapley values for features associated with a given component may determine whether the component is anomalous. In such examples, a single deviant feature may have a sufficiently high Shapley value to cause the component to be flagged as anomalous. Alternatively, individual features may not appear anomalous when considered in isolation, but the combined contribution of multiple features may collectively exceed the anomalous component criterion, thereby identifying the associated component as anomalous.

The wind turbine maintenance alert 1524 generated for the target wind turbine by alert generator 1522 may include the respective wind turbine identifier 1802 corresponding to the target wind turbine, the respective one or more anomalous components 1804 corresponding to the at least one feature that satisfies the anomalous component criterion (e.g., Component C), and a natural language explanation 1806 describing a reason that the respective component corresponding to the at least one feature is causing the target wind turbine to behave anomalously. The natural language explanation 1806 may be generated by filling predefined templates with slots populated by the identified component and its triggering measurement or by using a large language model configured to produce explanatory text based on structured inputs. The natural language explanation 1806 may provide an interpretable statement linking underlying feature contribution values to an actionable maintenance alert.

Additionally, the alert generator 1522 may transmit, using an electronic messaging service, the wind turbine maintenance alert generated for the target wind turbine to a target entity and may display the wind turbine maintenance alert generated for the target wind turbine on a graphical user interface. It should be noted that there may be examples where the functionalities of power prediction explainability algorithm 2002 and anomalous component detector 1906 may be performed at a module distinct from, but in communication with, alert generator 1522 (e.g., a module between wind turbine power prediction model 1516 and alert generator 1522).

Another non-limiting example may be provided with reference to Tables 1 through 5 depicted herein.

TABLE 1
Asset Maintenance Alerts

| | alert | alert_ | day_ | | | alert | alert | alert |
|---|---|---|---|---|---|---|---|---|
| Timestamp | Type | id | index | assetID | stats | Threshold | Starts | Ends |
| 08MAR25:03: | 2 | 64 | 8 | Turbine_ | 400 | 450 | 1011 | 1028 |
| 20:00 | | | | 2 | | | | |
| 12MAR25:23: | 2 | 222 | 12 | Turbine_ | 324.8102 | 450 | 1710 | 1727 |
| 50:00 | | | | 1 | | | | |
| 12MAR25:23: | 2 | 223 | 12 | Turbine_ | 325.0113 | 450 | 1710 | 1727 |
| 50:00 | | | | 2 | | | | |
| 12MAR25:23: | 2 | 224 | 12 | Turbine_ | 330.1463 | 450 | 1710 | 1727 |
| 50:00 | | | | 3 | | | | |
| 12MAR25:23: | 2 | 225 | 12 | Turbine_ | 327.4378 | 450 | 1710 | 1727 |
| 50:00 | | | | _4 | | | | |
| 12MAR25:23: | 2 | 226 | 12 | Turbine_ | 340.3456 | 450 | 1710 | 1727 |
| 50:00 | | | | | | | | |
| 12MAR25:23: | 2 | 227 | 12 | Turbine_ | 340.9164 | 450 | 1710 | 1727 |
| 50:00 | | | | 6 | | | | |
| 12MAR25:23: | 2 | 228 | 12 | Turbine_ | 349.7544 | 450 | 1710 | 1727 |
| 50:00 | | | | 7 | | | | |
| 12MAR25:23: | 2 | 229 | 12 | Turbine_ | 348.1444 | 450 | 1710 | 1727 |
| 50:00 | | | | 8 | | | | |
| 20MAR25:23: | 1 | 152 | 20 | Turbine_ | 0.674938 | 0.62 | 2862 | 2879 |
| 50:00 | | | | 1 | | | | |
| 20MAR25:23: | 1 | 153 | 20 | Turbine_ | 0.674938 | 0.62 | 2862 | 2879 |
| 50:00 | | | | 2 | | | | |
| 20MAR25:23: | 1 | 154 | 20 | Turbine_ | 0.674404 | 0.62 | 2862 | 2879 |
| 50:00 | | | | 3 | | | | |
| 20MAR25:23: | 1 | 155 | 20 | Turbine_ | 0.674938 | 0.62 | 2862 | 2879 |
| 50:00 | | | | 4 | | | | |
| 20MAR25:23: | 1 | 156 | 20 | Turbine_ | 0.671739 | 0.62 | 2862 | 2879 |
| 50:00 | | | | 5 | | | | |
| 20MAR25:23: | 1 | 157 | 20 | Turbine_ | 0.673337 | 0.62 | 2862 | 2879 |
| 50:00 | | | | 6 | | | | |
| 20MAR25:23: | 1 | 158 | 20 | Turbine_ | 0.669614 | 0.62 | 2862 | 2879 |
| 50:00 | | | | 7 | | | | |
| 20MAR25:23: | 1 | 159 | 20 | Turbine_ | 0.669614 | 0.62 | 2862 | 2879 |
| 50:00 | | | | 8 | | | | |
| 22MAR25:03: | 2 | 302 | 22 | Turbine_ | 400 | 450 | 3029 | 3046 |
| 40:00 | | | | 7 | | | | |

Table 1 may illustrate a non-limiting example of asset maintenance alerts sent at various timestamps. Asset maintenance alerts with ID 1 may be generated when a predicted amount of electrical power fails to satisfy a predetermined minimum power generation threshold and asset maintenance alerts with ID 2 may be generated when an energy asset anomaly score exceeds a predefined maximum anomaly score threshold.

TABLE 2
Shapley Values for alert_id 64 After Normalization

| alert_{—} | tag | | | | |
|---|---|---|---|---|---|
| id | Num | tag | percentImpact | assetID | Timestamp |
| 64 | 0 | TrueWindSpeed | 1.944567 | Turbine_2 | 08MAR25:03:20:00 |
| 64 | 1 | WindDirection | 0.020152 | Turbine_2 | 08MAR25:03:20:00 |
| 64 | 2 | Temperature_{—} | 0 | Turbine_2 | 08MAR25:03:20:00 |
| | | Ambient | | | |
| 64 | 3 | Turbulence | 0.967478 | Turbine_2 | 08MAR25:03:20:00 |
| 64 | 4 | Pitch Angle | 0.40633 | Turbine_2 | 08MAR25:03:20:00 |
| 64 | 5 | TempCHub | 0.989803 | Turbine_2 | 08MAR25:03:20:00 |
| 64 | 6 | TempSpin | 0.541338 | Turbine_2 | 08MAR25:03:20:00 |
| 64 | 7 | RotorSpd | 0.595694 | Turbine_2 | 08MAR25:03:20:00 |
| 64 | 8 | NacelleD | 1.53354 | Turbine_2 | 08MAR25:03:20:00 |
| 64 | 9 | TempNacl | 0 | Turbine_2 | 08MAR25:03:20:00 |
| 64 | 10 | TempMBrg | 55.467083 | Turbine_2 | 08MAR25:03:20:00 |
| 64 | 11 | TempGrbxBrgIMS | 0 | Turbine_2 | 08MAR25:03:20:00 |
| 64 | 12 | TempGrbxBrgHSS | 0 | Turbine_2 | 08MAR25:03:20:00 |
| 64 | 13 | TempGrbxOil | 0.195591 | Turbine_2 | 08MAR25:03:20:00 |
| 64 | 14 | GenSpeed | 9.006319 | Turbine_2 | 08MAR25:03:20:00 |
| 64 | 15 | TempGenBrgDE | 0 | Turbine_2 | 08MAR25:03:20:00 |
| 64 | 16 | TempGenBrgNDE | 0 | Turbine_2 | 08MAR25:03:20:00 |
| 64 | 17 | TempCTop | 0 | Turbine_2 | 08MAR25:03:20:00 |
| 64 | 18 | TempHVTrafoAT | 0.469641 | Turbine_2 | 08MAR25:03:20:00 |
| 64 | 19 | HydPressure | 0.790229 | Turbine_2 | 08MAR25:03:20:00 |
| 64 | 20 | TempHydOil | 0 | Turbine_2 | 08MAR25:03:20:00 |
| 64 | 21 | TempCGnd | 1.516735 | Turbine_2 | 08MAR25:03:20:00 |
| 64 | 22 | TowerAccX | 4.880868 | Turbine_2 | 08MAR25:03:20:00 |
| 64 | 23 | TowerAccY | 0.336155 | Turbine_2 | 08MAR25:03:20:00 |
| 64 | 24 | BladeALd | 0 | Turbine_2 | 08MAR25:03:20:00 |
| 64 | 25 | BladeBLd | 0 | Turbine_2 | 08MAR25:03:20:00 |
| 64 | 26 | BladeCLd | 0 | Turbine_2 | 08MAR25:03:20:00 |
| 64 | 27 | TempGenStWL1 | 0 | Turbine_2 | 08MAR25:03:20:00 |
| 64 | 28 | TempGenStWL2 | 0 | Turbine_2 | 08MAR25:03:20:00 |
| 64 | 29 | TempGenStWL3 | 0.032528 | Turbine_2 | 08MAR25:03:20:00 |
| 64 | 30 | TempHSSGenBrg1 | 0 | Turbine_2 | 08MAR25:03:20:00 |
| 64 | 31 | TempHSSGenBrg2 | 0 | Turbine_2 | 08MAR25:03:20:00 |
| 64 | 32 | TempHVTrafoP1 | 0.167368 | Turbine_2 | 08MAR25:03:20:00 |
| 64 | 33 | TempHVTrafoP2 | 0 | Turbine_2 | 08MAR25:03:20:00 |
| 64 | 34 | TempHVTrafoP3 | 0 | Turbine_2 | 08MAR25:03:20:00 |
| 64 | 35 | TempHVTraP1Cr | 18.571341 | Turbine_2 | 08MAR25:03:20:00 |
| 64 | 36 | TempHVTraP2Cr | 0 | Turbine_2 | 08MAR25:03:20:00 |
| 64 | 37 | TempHVTraP3Cr | 1.567241 | Turbine_2 | 08MAR25:03:20:00 |

Table 2 may illustrate Shapley values for one of the alerts illustrated in Table 1 (e.g., the alert with alert_id 64). Table 2 may include a respective row for each sensor feature (e.g., both for raw features collected from sensors and enriched attributes) and may represent the values output by an anomaly score explainability algorithm after undergoing normalization as described herein. For instance, for each row the column labeled “tag” may include a respective unique identifier for each sensor feature and the column labeled “percentImpact” may include the Shapley value.

It should be noted that TrueWindSpeed may represent a product of wind speed and air density correction; WindDirection may represent wind direction; Temperature_Ambient may represent ambient temperature; Turbulence may represent turbulence intensity defined as dividing standard deviation of true wind speed over a time window by the mean true wind speed over the same period; Pitch Angle may represent the angle of a wind turbine blade pitching from 0 degrees to 90 degrees; TempCHub may represent the temperature of a turbine's controller hub; TempSpin may represent a temperature of a turbine's spinner; RotorSpd may represent the rotaition speed of a wind turbine's rotor; NacelleD may represent the nacelle direction; TempNacl may represent the temperature of a nacelle; TempMBrg may represent the temperature of a main bearing; TempGrbxBrgIMS may represent the temperature of a gearbox's intermediate shaft bearing; TempGrbxBrgHSS may represent the temperature of a gearbox's high-speed shaft bearing; TempGrbxOil may represent the temperature of the gearbox oil; GenSpeed may represent the speed of a generator; TempGenBrgDE may represent the temperature of a generator drive-end bearing; TempGenBrgNDE may represent the temperature of a generator non-drive-end bearing; TempCTop may represent the temperature of a controller top; TempHVTrafoAT may represent the temperature of a high-voltage auxiliary transformer; HydPressure may represent hydraulic pressure; TempHydOil may represent the temperature of hydraulic oil; TempCGnd may represent the temperature of a controller ground; TowerAccX may represent tower acceleration associated with the horizontal axis; TowerAccY may represent tower acceleration associated with the vertical access; BladeALd may represent forces and stresses (e.g., load) experienced by a first turbine blade during operation; BladeBLd may represent forces and stresses (e.g., load) experienced by a second turbine blade during operation; BladeCLd may represent forces and stresses (e.g., load) experienced by a thid turbine blade during operation; TempGenStWL1 may represent temperature of a first generator stator winding; TempGenStWL2 may represent temperature of a second generator stator winding; TempGenStWL3 may represent temperature of a third generator stator winding; TempHSSGenBrg1 may represent temperature of a first high-speed shaft generator end bearing; TempHSSGenBrg2 may represent temperature of a first high-speed shaft generator end bearing; TempHVTrafoP1 may represent temperature of a first high voltage auxiliary transformer phase; TempHVTrafoP2 may represent temperature of a second high voltage auxiliary transformer phase; TempHVTrafoP3 may represent temperature of a third high voltage auxiliary transformer phase; TempHVTraP1Cr may represent temperature of a first high voltage auxiliary transformer phase core; TempHVTraP2Cr may represent temperature of a second high voltage auxiliary transformer phase core; TempHVTraP3Cr may represent temperature of a third high voltage auxiliary transformer phase core.

TABLE 3
Shapley Values for alert_id 64 After Aggregation

| alert_id | tag_group | totalPercentImpact | assetID | Timestamp |
|---|---|---|---|---|
| 64 | Environment | 2.932196 | Turbine_2 | 08MAR25:03:20:00 |
| 64 | Blade | 0.40633 | Turbine_2 | 08MAR25:03:20:00 |
| 64 | Hub | 0.989803 | Turbine_2 | 08MAR25:03:20:00 |
| 64 | Rotor | 1.137032 | Turbine_2 | 08MAR25:03:20:00 |
| 64 | Nacelle | 1.53354 | Turbine_2 | 08MAR25:03:20:00 |
| 64 | Main Bearing | 55.467083 | Turbine_2 | 08MAR25:03:20:00 |
| 64 | Gearbox | 0.195591 | Turbine_2 | 08MAR25:03:20:00 |
| 64 | Generator | 9.038847 | Turbine_2 | 08MAR25:03:20:00 |
| 64 | Transformer | 20.775591 | Turbine_2 | 08MAR25:03:20:00 |
| 64 | Hydraulic | 0.790229 | Turbine_2 | 08MAR25:03:20:00 |
| | Unit | | | |
| 64 | Tower | 6.733758 | Turbine_2 | 08MAR25:03:20:00 |

Table 3 may illustrate Shapley values for one of the alerts illustrated in Table 1 (e.g., the alert with alert_id 64). Table 3 may include a respective row for each component of a wind turbine and may further include a row for an environment condition (“Environment”), as illustrated by the “tag_group” column of table 3. Table 3 may represent the values of the “percentImpact” as shown in Table 2 after undergoing aggregation as described herein within the “totalPercentImpact” column. In the present example, for instance, the Shapley values for each of “TrueWindSpeed”, “WindDirection”, “TempAmbient” and “Turbulence” within the “tag” column of Table 2 may be combined together in order to get a respective “totalPercentImpact,” as each of these may be within the “Environment” group. Similarly, the Shapley values for each of “TempSpin” and “RotorSpd” within the “tag” column of Table 2 may be combined together in order to get a “totalPercentImpact,” as each of these may be within the “Rotor” group. In the present example, the main bearing of turbine_2 (e.g., a wind turbine) may be associated with the highest Shapley value. The Shapley value associated with the main bearing may exceed an anomalous component threshold. Accordingly, the system described herein may generate an alert that indicates the main bearing as the anomalous component and turbine_2 as an anomalous turbine.

TABLE 4
Shapley Values for alert_id 302 After Normalization

| alert_{—} | tag | | | | |
|---|---|---|---|---|---|
| id | Num | tag | percentImpact | assetID | Timestamp |
| 302 | 0 | TrueWindSpeed | 0 | Turbine_7 | 22MAR25:03:40:00 |
| 302 | 1 | WindDirection | 0.080091 | Turbine_7 | 22MAR25:03:40:00 |
| 302 | 2 | TempAmbient | 0.412611 | Turbine_7 | 22MAR25:03:40:00 |
| 302 | 3 | Turbulence | 0 | Turbine_7 | 22MAR25:03:40:00 |
| 302 | 4 | PitchAng | 0 | Turbine_7 | 22MAR25:03:40:00 |
| 302 | 5 | TempCHub | 0 | Turbine_7 | 22MAR25:03:40:00 |
| 302 | 6 | TempSpin | 0 | Turbine_7 | 22MAR25:03:40:00 |
| 302 | 7 | RotorSpd | 0 | Turbine_7 | 22MAR25:03:40:00 |
| 302 | 8 | NacelleD | 0.151429 | Turbine_7 | 22MAR25:03:40:00 |
| 302 | 9 | TempNacl | 0 | Turbine_7 | 22MAR25:03:40:00 |
| 302 | 10 | TempMBrg | 0.930802 | Turbine_7 | 22MAR25:03:40:00 |
| 302 | 11 | TempGrbxBrgIMS | 34.146035 | Turbine_7 | 22MAR25:03:40:00 |
| 302 | 12 | TempGrbxBrgHSS | 36.298474 | Turbine_7 | 22MAR25:03:40:00 |
| 302 | 13 | TempGrbxOil | 21.954816 | Turbine_7 | 22MAR25:03:40:00 |
| 302 | 14 | GenSpeed | 0 | Turbine_7 | 22MAR25:03:40:00 |
| 302 | 15 | TempGenBrgDE | 0 | Turbine_7 | 22MAR25:03:40:00 |
| 302 | 16 | TempGenBrgNDE | 0 | Turbine_7 | 22MAR25:03:40:00 |
| 302 | 17 | TempCTop | 0 | Turbine_7 | 22MAR25:03:40:00 |
| 302 | 18 | TempHVTrafoAT | 0 | Turbine_7 | 22MAR25:03:40:00 |
| 302 | 19 | HydPressure | 0 | Turbine_7 | 22MAR25:03:40:00 |
| 302 | 20 | TempHydOil | 0 | Turbine_7 | 22MAR25:03:40:00 |
| 302 | 21 | TempCGnd | 0 | Turbine_7 | 22MAR25:03:40:00 |
| 302 | 22 | TowerAccX | 0 | Turbine_7 | 22MAR25:03:40:00 |
| 302 | 23 | TowerAccY | 0 | Turbine_7 | 22MAR25:03:40:00 |
| 302 | 24 | BladeALd | 0 | Turbine_7 | 22MAR25:03:40:00 |
| 302 | 25 | BladeBLd | 0 | Turbine_7 | 22MAR25:03:40:00 |
| 302 | 26 | BladeCLd | 0.644856 | Turbine_7 | 22MAR25:03:40:00 |
| 302 | 27 | TempGenStWL1 | 0 | Turbine_7 | 22MAR25:03:40:00 |
| 302 | 28 | TempGenStWL2 | 0.511169 | Turbine_7 | 22MAR25:03:40:00 |
| 302 | 29 | TempGenStWL3 | 0 | Turbine_7 | 22MAR25:03:40:00 |
| 302 | 30 | TempHSSGenBrg1 | 0.472024 | Turbine_7 | 22MAR25:03:40:00 |
| 302 | 31 | TempHSSGenBrg2 | 0.089424 | Turbine_7 | 22MAR25:03:40:00 |
| 302 | 32 | TempHVTrafoP1 | 3.501671 | Turbine_7 | 22MAR25:03:40:00 |
| 302 | 33 | TempHVTrafoP2 | 0.593534 | Turbine_7 | 22MAR25:03:40:00 |
| 302 | 34 | TempHVTrafoP3 | 0.213062 | Turbine_7 | 22MAR25:03:40:00 |
| 302 | 35 | TempHVTraP1Cr | 0 | Turbine_7 | 22MAR25:03:40:00 |
| 302 | 36 | TempHVTraP2Cr | 0 | Turbine_7 | 22MAR25:03:40:00 |
| 302 | 37 | TempHVTraP3Cr | 0 | Turbine_7 | 22MAR25:03:40:00 |

Table 4 may illustrate Shapley values for one of the alerts illustrated in Table 1 (e.g., the alert with alert_id 302). Table 4 may include a respective row for each sensor feature (e.g., both for raw features collected from sensors and enriched attributes) and may represent the values output by an anomaly score explainability algorithm after undergoing normalization as described herein. For instance, for each row the column labeled “tag” may include a respective unique identifier for each sensor feature and the column labeled “percentImpact” may include the Shapley value.

TABLE 5
Shapley Values for alert_id 302 After Aggregation

| alert_id | tag_group | totalPercentImpact | assetID | Timestamp |
|---|---|---|---|---|
| 302 | Environment | 0.492702 | Turbine_7 | 22MAR25:03:40:00 |
| 302 | Blade | 0.644856 | Turbine_7 | 22MAR25:03:40:00 |
| 302 | Hub | 0 | Turbine_7 | 22MAR25:03:40:00 |
| 302 | Rotor | 0 | Turbine_7 | 22MAR25:03:40:00 |
| 302 | Nacelle | 0.151429 | Turbine_7 | 22MAR25:03:40:00 |
| 302 | Main Bearing | 0.930802 | Turbine_7 | 22MAR25:03:40:00 |
| 302 | Gearbox | 92.399326 | Turbine_7 | 22MAR25:03:40:00 |
| 302 | Generator | 1.072618 | Turbine_7 | 22MAR25:03:40:00 |
| 302 | Transformer | 4.308267 | Turbine_7 | 22MAR25:03:40:00 |
| 302 | Hydraulic | 0 | Turbine_7 | 22MAR25:03:40:00 |
| | Unit | | | |
| 302 | Tower | 0 | Turbine_7 | 22MAR25:03:40:00 |

Table 5 may illustrate Shapley values for one of the alerts illustrated in Table 1 (e.g., the alert with alert_id 302). Table 5 may include a respective row for each component of a wind turbine and may further include a row for an environment condition (“Environment”), as illustrated by the “tag_group” column of table 5. Table 5 may represent the values of the “percentImpact” as shown in Table 4 after undergoing aggregation as described herein within the “totalPercentImpact” column. In the present example, for instance, the Shapley values for each of “TrueWindSpeed”, “WindDirection”, “TempAmbient” and “Turbulence” within the “tag” column of Table 4 may be combined together in order to get a respective “totalPercentImpact,” as each of these may be within the “Environment” group. Similarly, the Shapley values for each of “TempSpin” and “RotorSpd” within the “tag” column of Table 4 may be combined together in order to get a “totalPercentImpact,” as each of these may be within the “Rotor” group. In the present example, the gearbox of turbine_7 (e.g., a wind turbine) may be associated with the highest Shapley value. The Shapley value associated with the gearbox may exceed an anomalous component threshold. Accordingly, the system described herein may generate an alert that indicates the gearbox as the anomalous component and turbine_7 as an anomalous turbine.

In some examples, process 1450A and/or 1450B may only generate a maintenance alert if sub-process 1550A detects that the energy asset anomaly score computed for a particular energy asset exceeds the predefined maximum anomaly score threshold or that sub-process 1550B detects that the predicted amount of electrical power generated by the particular energy asset fails to satisfy the predetermined minimum power generation threshold over a threshold quantity of consecutive periods during which the particular energy asset is functional. For instance, if the threshold quantity of consecutive periods is 3, then an energy asset whose energy asset anomaly score exceeds the predefined maximum anomaly score during two consecutive periods may not trigger generation of a maintenance alert. However, an energy asset whose energy asset anomaly score exceeds the predefined anomaly score during four consecutive periods may trigger generation of a maintenance alert, as it exceeds the threshold quantity of consecutive periods and may represent a detected pattern of anomalous behavior. It should be noted that, in some examples, the maintenance alert that is generated may include explainability information corresponding to the value of energy asset anomaly score and/or the observed amount of electrical power for the first instance (e.g., first observation) within the first period in which the predefined maximum anomaly score threshold is exceeded and/or the predetermined minimum power generation threshold is not exceeded.

In some examples, process 1450A and/or 1450B may function to limit how often maintenance alerts are sent out. For instance, if a maintenance alert is sent on an initial day and below a threshold quantity of days have passed since the initial maintenance alert was sent, process 1450A and/or 1450B may refrain from sending another maintenance alert even if the anomalous behavior that triggered the maintenance alert occurs again. However, if the anomalous behavior occurs again after the threshold quantity of days has passed, process 1450A and/or 1450B may generate another maintenance alert. This process may be referred to as latching.

In some examples, process 1450A and/or 1450B may further be configured to detect poor model performance (e.g., of the power prediction model). For instance, for each energy asset, process 1450A and/or 1450B may detect whether a percentage error in power estimation exceeds a predetermined threshold for a predetermined quantity of periods during which the energy asset is functioning. If so, process 1450A and/or 1450B may generate a corresponding alert message. It should be noted that alert generation for poor model performance may be subject to latching in at least some examples.

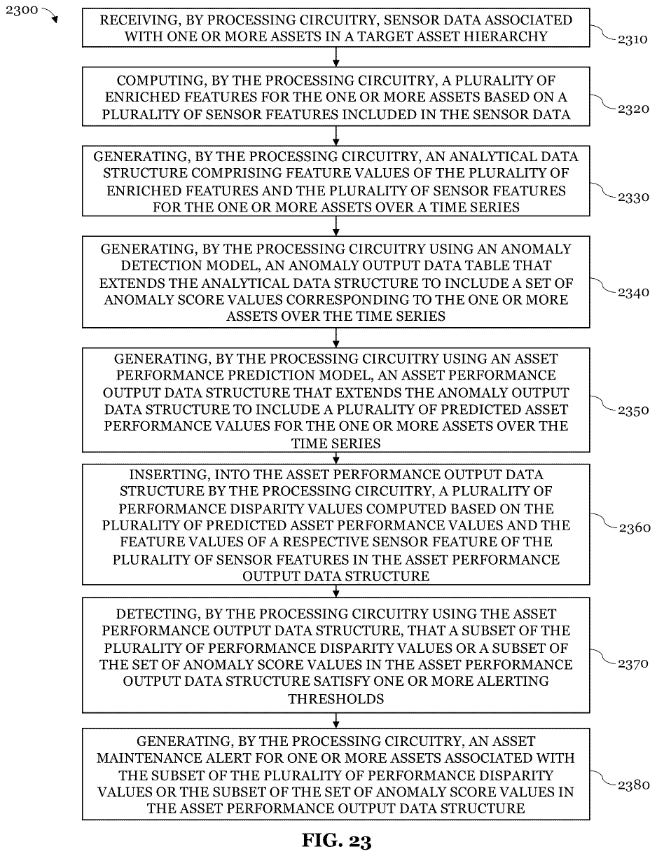

FIG. 23 illustrates one embodiment of method 2300. It shall be appreciated that other embodiments contemplated within the scope of the present disclosure may involve more processes, fewer processes, different processes, or a different order of processes than illustrated in FIG. 23. It should be noted that a computer-program product may include a non-transitory machine-readable storage medium storing computer instructions that, when executed by one or more operations, may perform operations corresponding to the processes and sub-processes of method 2300. Additionally, or alternatively, a computer-implemented method may include operations corresponding to processes and sub-processes of 2300. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 2300.

Method 2300 may provide a computer-implemented framework for enabling detection of anomalously behaving assets in real-time such that predictive maintenance may be performed on these assets. For instance, method 2300 may generally involve receiving sensor data for one or more assets, generating enriched features from the sensor data, and grouping the sensor data and enriched features into entries within an analytical data structure that keeps track of the sensor data for particular assets over time. Method 2300 may further include executing an anomaly detection model and an asset performance prediction model on each entry of the analytical data structure in order to generate extended entries which include an anomaly score and a predicted asset performance value, respectively. Additionally, method 2300 may involve computing a performance disparity value for each entry that represents a difference between the predicted asset performance value and an actual asset performance value and extending the entry to include the performance disparity value. Method 2300 may additionally include evaluating, for an entry associated with a particular asset, the anomaly score and performance disparity value against one or more alerting thresholds and generating an asset maintenance alert identifying the asset if the anomaly score and performance disparity value exceed satisfy the one or more alerting thresholds. By generating asset maintenance alerts in this manner, detection of performance degradation may be enabled in real-time such that predictive maintenance may be performed before assets fail, which may reduce unplanned downtown and improve the operational efficiency of fleets of assets.

It should be noted that there may be examples in which a system implementing method 2300 is configured to identify specific components of an asset that are contributing to anomalous behavior and to include an indication of the identified components in the asset maintenance alert. Each entry within the analytical data structure may include features related to a particular component of the asset. For instance, if the asset is a wind turbine, a first set of features within the entry may be related to a generator of the wind turbine and a second set of features within the entry may be related to a rotor of the wind turbine. The system may utilize an explainability algorithm in order to determine a contribution value that indicates how much a given feature is contributing to an anomaly score and/or performance disparity value which satisfies an alerting threshold. The system may then aggregate the contribution values related to particular components and may determine if the aggregated contribution values satisfy a predefined threshold. If the aggregated contribution values for a particular component satisfy the predefined threshold, that component may be identified as the component most likely to be contributing to anomalous behavior. By identifying the specific component, the system described herein may enable root-cause analysis and may shorten a time associated with performing maintenance on an asset experiencing anomalous behavior (e.g., as compared to more generally just identifying an asset).

Utilizing both an anomaly detection model and an asset performance prediction model may provide enhanced robustness to the system described herein. For instance, an anomaly score generated by the anomaly detection model may indicate anomalous behavior for an asset that has a normal performance disparity value. Similarly, a performance disparity value generated by the asset performance prediction model may indicate anomalous behavior for an asset that has a normal anomaly score. In this manner, the system described herein may enable improved anomalous behavior detection as compared to a system that utilizes only an anomaly detection model or only the asset performance prediction model.

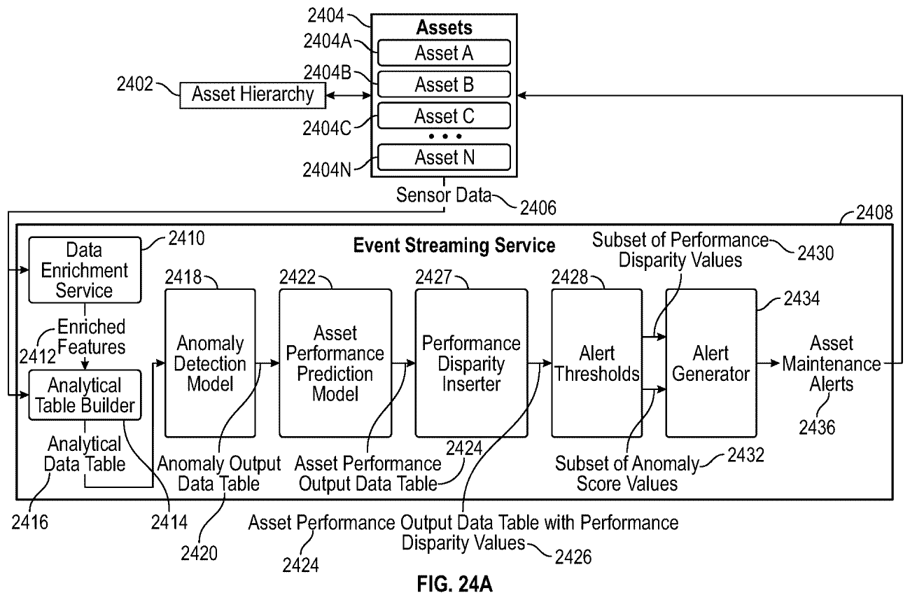

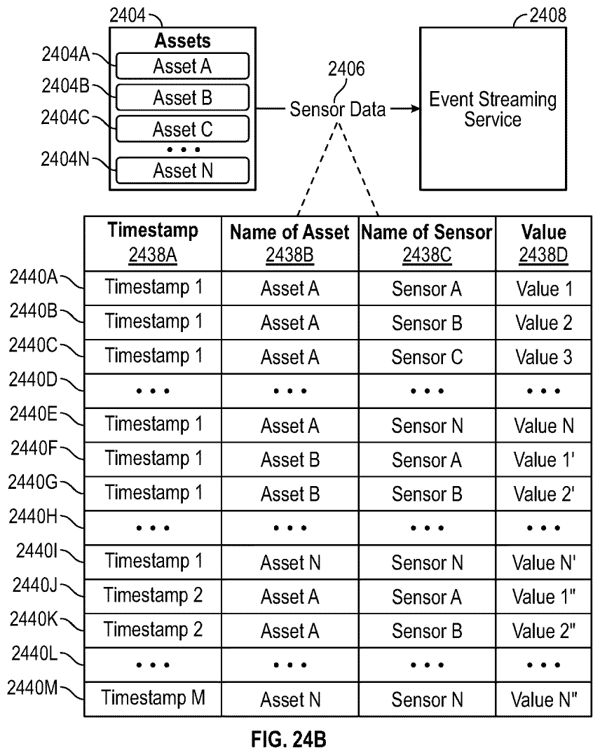

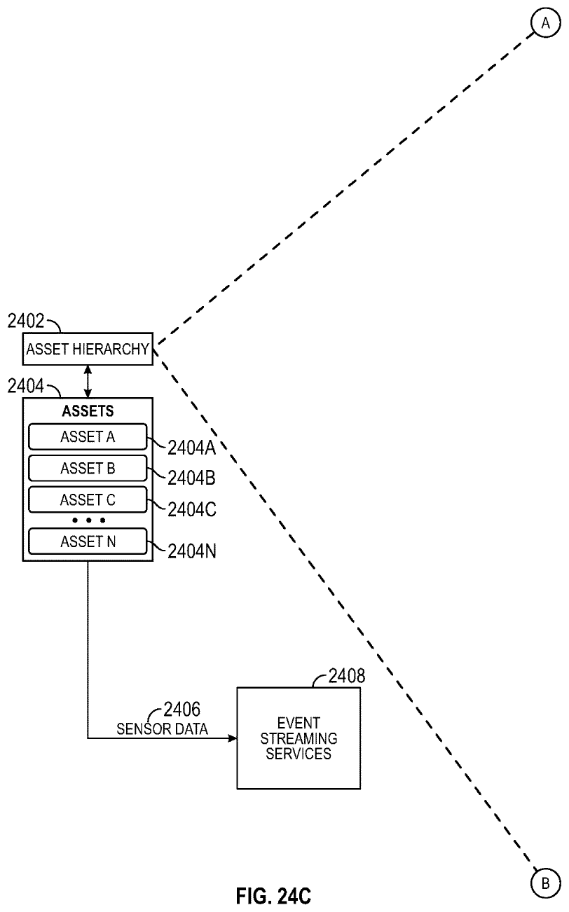

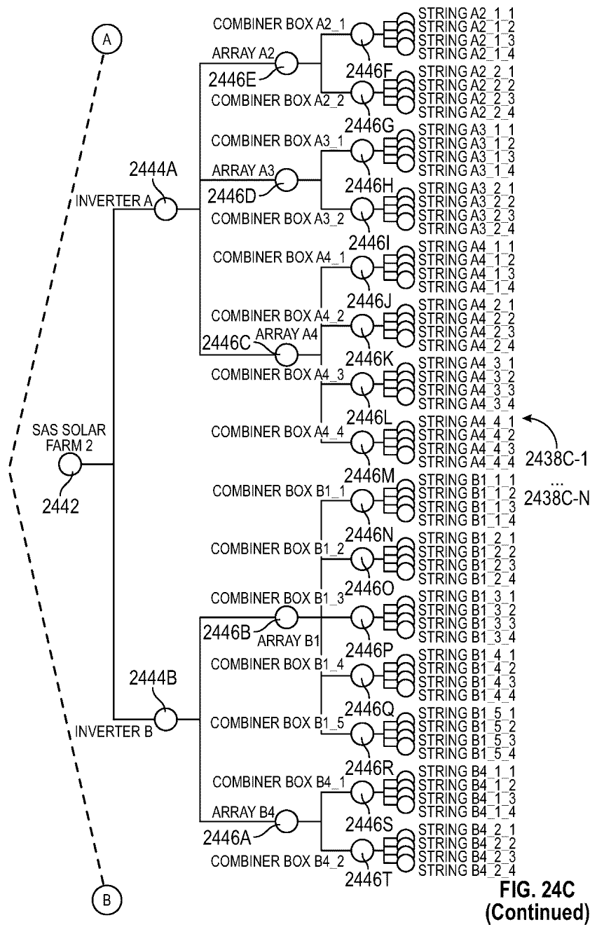

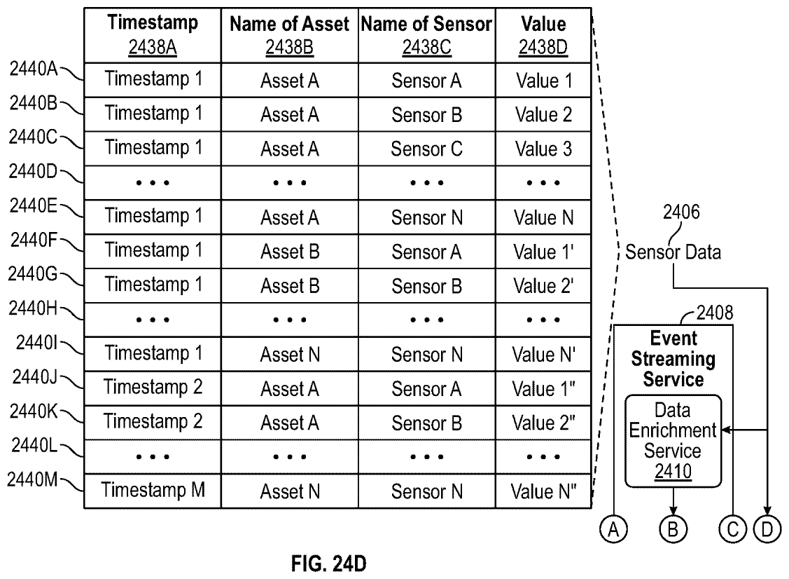

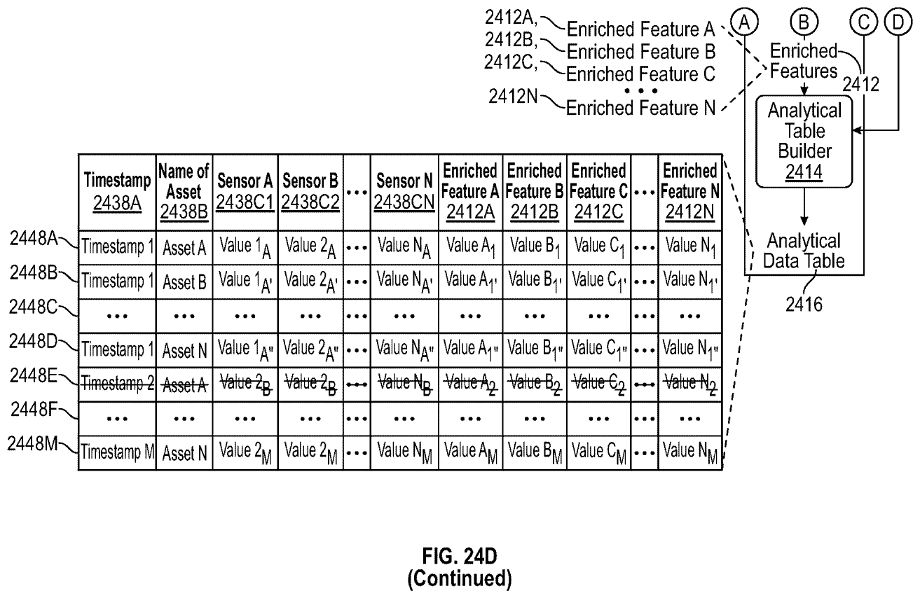

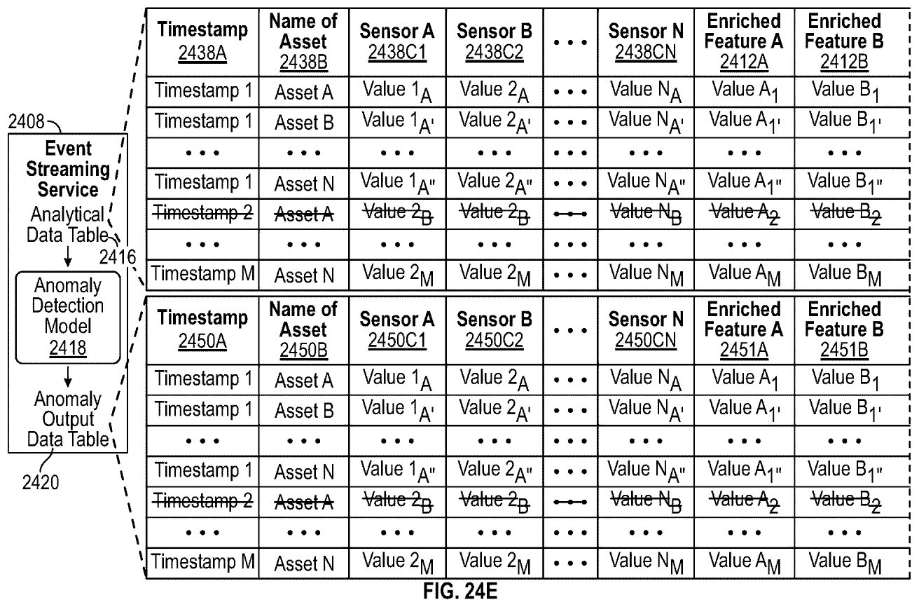

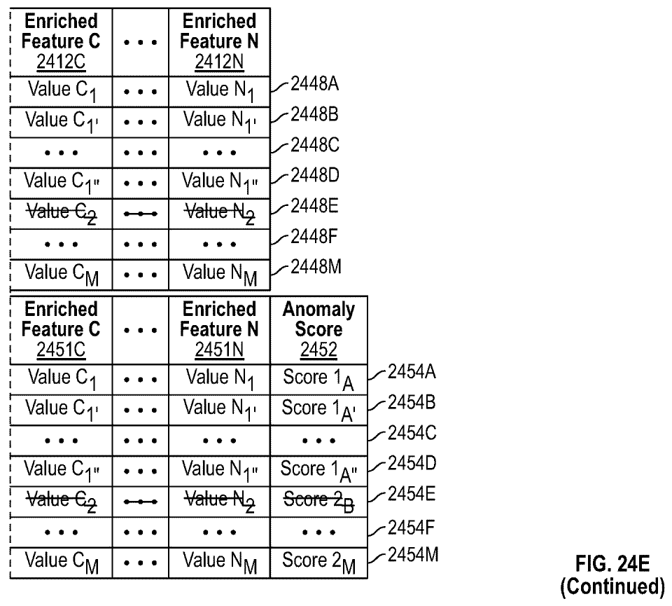

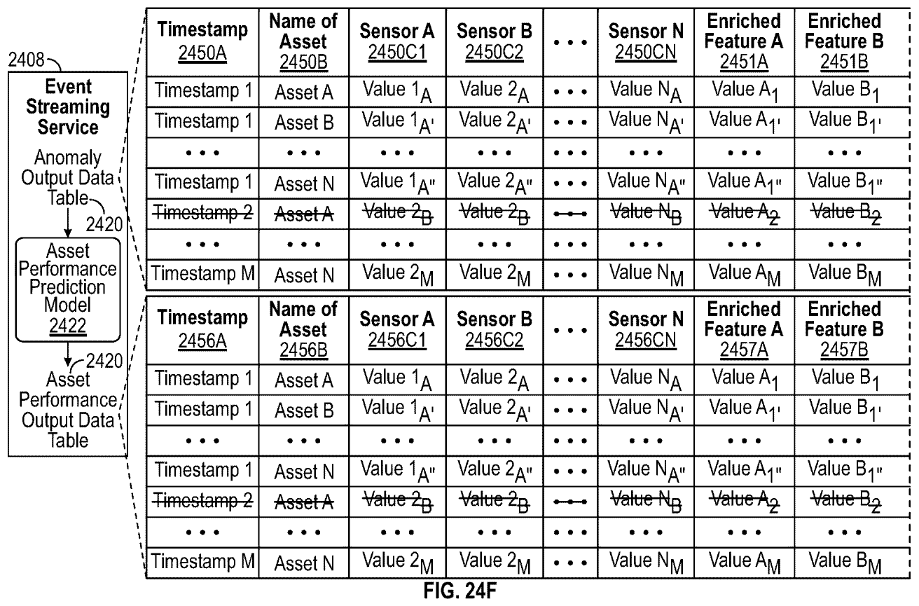

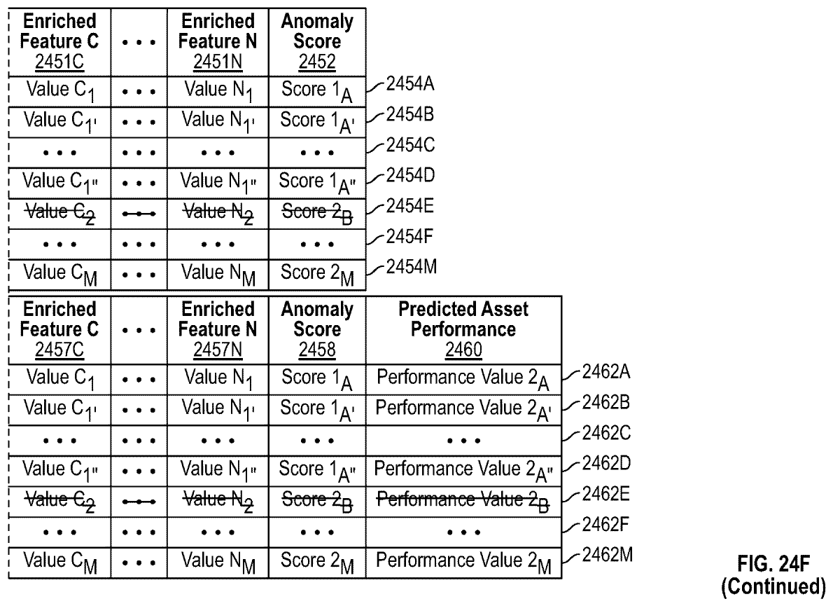

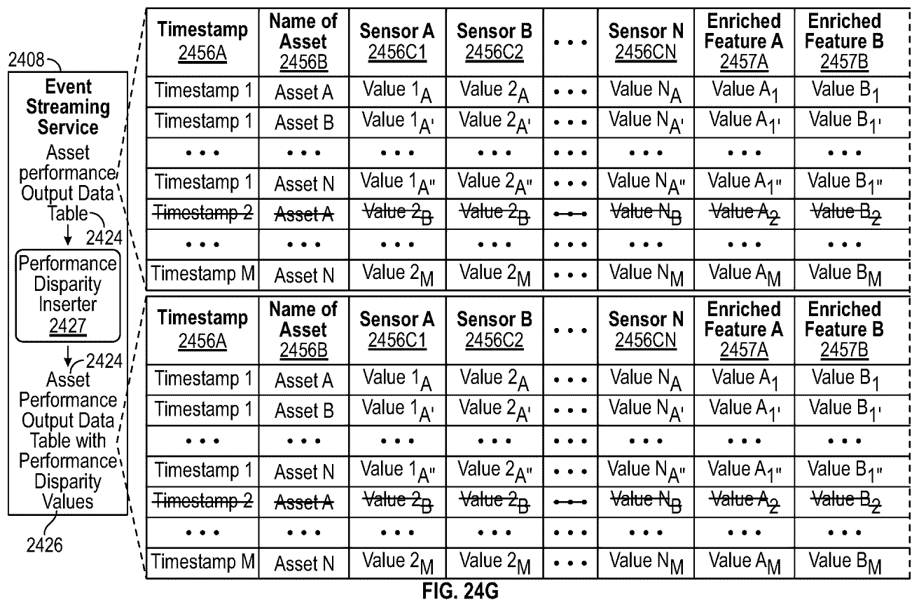

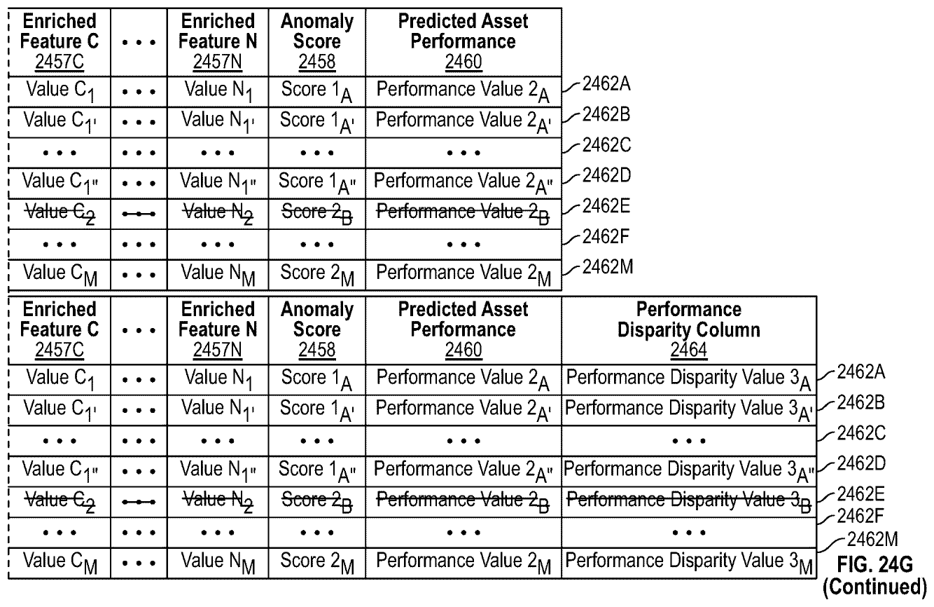

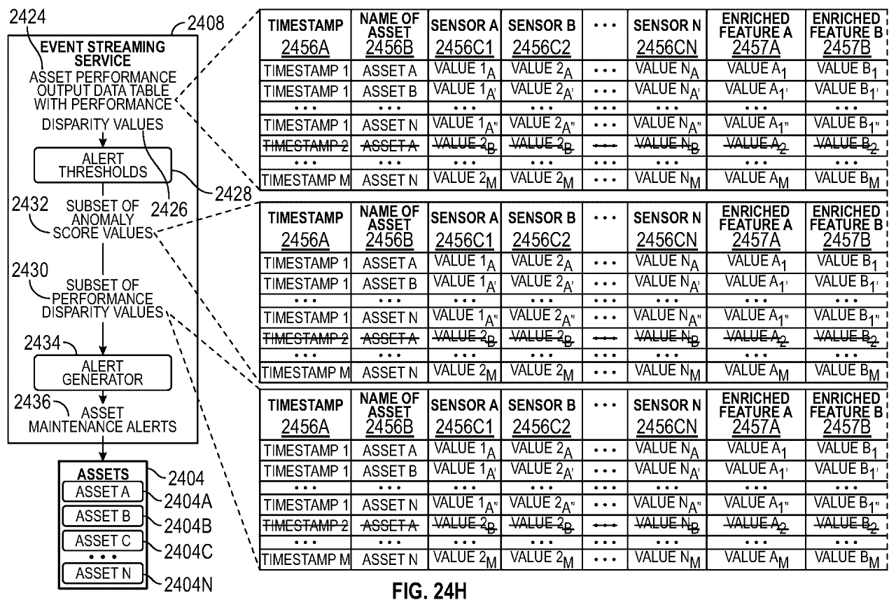

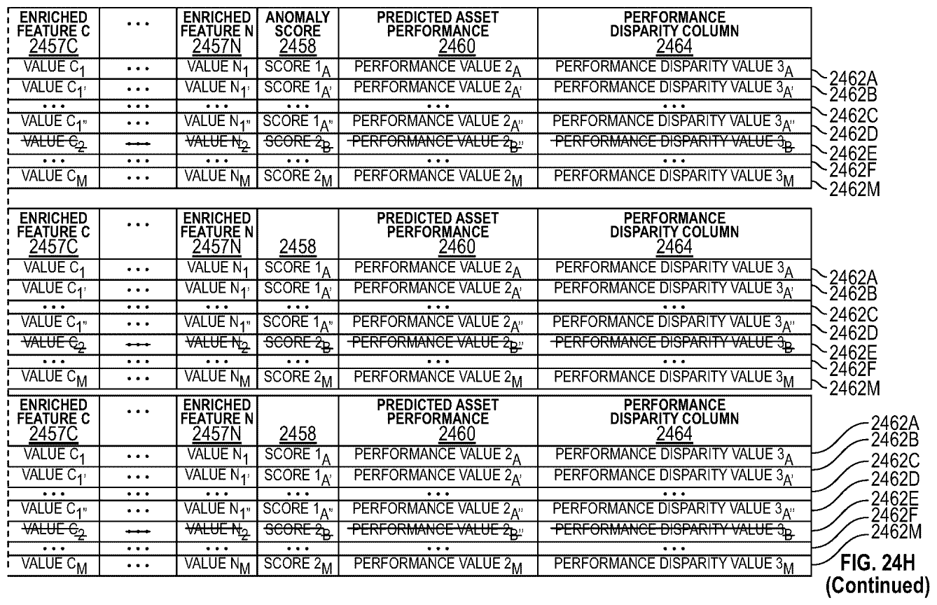

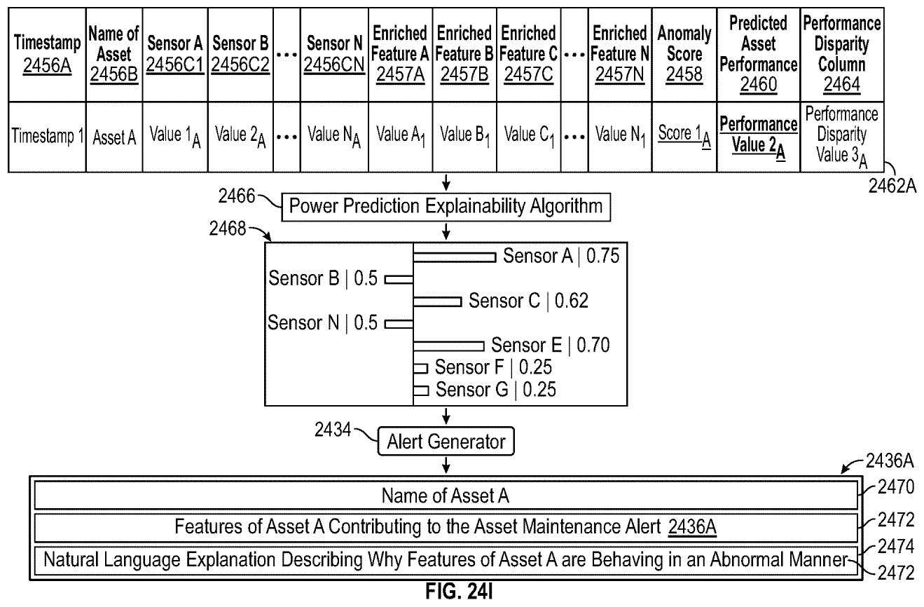

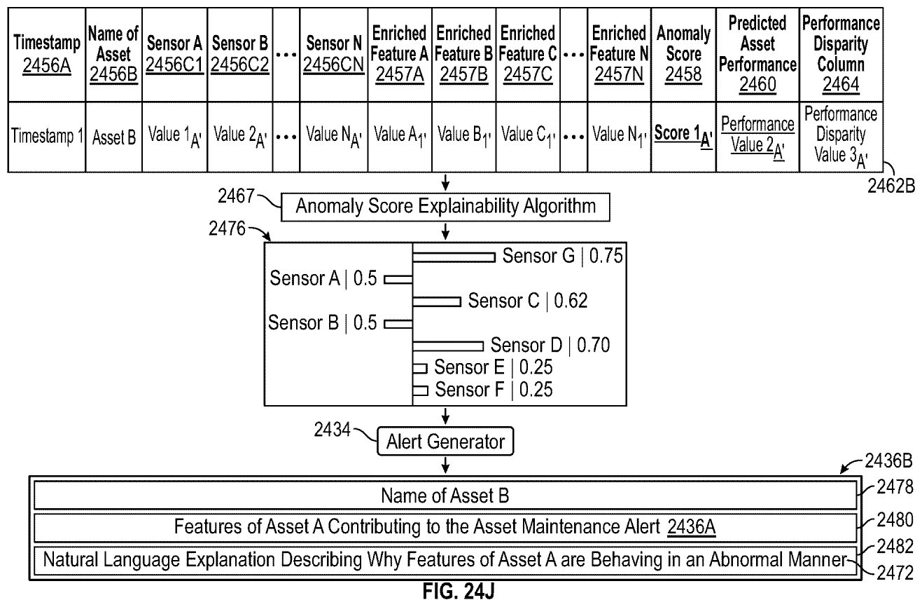

As shown in FIG. 23, process 2310 of method 2300 may include receiving, by processing circuitry, sensor data associated with one or more assets in a target asset hierarchy. In a non-limiting example, as described with reference to FIG. 24A, event streaming service 2408 may receive sensor data 2406 associated with one or more assets 2404 in a target asset hierarchy 2402.

The term “processing circuitry” may refer to one or more hardware or software-based computing components configured to execute instructions for carrying out the processes described with reference to method 2300. Processing circuitry may include one or more processors, microprocessors, microcontrollers, digital signal processors (DSPs), application-specific integrated circuits (ASICs), field-programmable gate arrays (FPGAs), or any combination thereof. In some examples, the processing circuitry may also include memory elements, communication interfaces, or other auxiliary components that enable execution of software modules implementing functions described with reference to processes 2310 through 2380. The processing circuitry may be embodied as a single computing device or distributed across multiple machines, virtual machines, or containerized services. The processing circuitry may operate in real time or near real time to process sensor data streams and perform the computations of method 2300.

The term “asset” may refer to an entity whose behavior is monitorable via one or more sensors in order to generate sensor data indicative of its operational or performance state. An asset may correspond to a discrete piece of equipment, a machine, or a subsystem thereof, and may include, for example, a turbine, inverter, generator, pump, compressor, or other industrial apparatus capable of producing measurable sensor outputs. In certain embodiments, an asset may also represent a logical aggregation of components that collectively perform a function within a larger system (e.g., a wind turbine within a wind farm or a string of solar panels within a solar farm). Non-limiting example assets may be depicted with reference to FIG. 24A. For instance, a set of assets 2404 may include N total assets, including asset 2404A (i.e., Asset A), asset 2404B (i.e., Asset B), asset 2404C (i.e., Asset C), and asset 2404N (i.e., Asset N).

The term “asset hierarchy” may refer to a structured representation of assets grouped into parent-child relationships that reflect functional, operational, or physical dependencies among the assets. Establishing a structured representation of assets enables the processing circuitry described herein to group, correlate, and compare sensor data across multiple operational levels (e.g., at the level of a turbine, at the level of a subsystem or component of the turbine) such that anomalies and performance deviations may be evaluated in relation to their position within the overall hierarchy. The target asset hierarchy described herein may include a root node identifying a deployment region associated with the one or more assets and one or more child nodes corresponding to the one or more assets and hierarchically arranged under the root node. The term “deployment region” may refer to a physical site, geographic area, or logical environment in which the one or more assets are installed and monitored. In a non-limiting example, the deployment region may be a wind farm site and the child nodes may be wind turbines located at the wind farm site.

It should be noted that there may be examples where the target asset hierarchy described may further include one or more second child nodes hierarchically arranged under the one or more child nodes, where the one or more second child nodes may correspond to one or more subsystems associated with the one or more assets. Additionally, there may be examples where the target asset hierarchy described herein includes one or more third child nodes hierarchically arranged under the one or more second child nodes, where the one or more third child nodes may correspond to one or more components associated with the one or more subsystems.

In a non-limiting example, as described with reference to FIG. 24C, the deployment region 2442 of asset hierarchy 2402 may be a solar farm site (e.g., Solar Farm 2) and the child nodes 2444A and 2444B may be respective inverters located at the solar farm site (e.g., Inverters A and B). The one or more second child nodes may be arrays (e.g., solar arrays) coupled to the inverters. For instance, second child nodes 2446E, 2446D, and 2446C may be dependent from child node 2444A, representing a first subset of arrays being coupled to a respective inverter (e.g., arrays A2, A3, and A4 being coupled to Inverter A). Likewise, second child nodes 2446B and 2446A may be dependent from child node 2444B representing a second subset of arrays being coupled to a respective inverter (e.g., arrays B1 and B4 being coupled to Inverter B).

The one or more third child nodes may be combiner boxes coupled to the arrays. For instance, third child nodes 2446F and 2446G may be dependent from second child node 2446E representing a first subset of combiner boxes being coupled to a respective array (combiner boxes A2_1 and A2_2 being coupled to Array A2). Third child nodes 2446H and 2446I may be dependent from second child node 2446D representing a second subset of combiner boxes being coupled to a respective array (combiner boxes A3_1 and A3_2 being coupled to Array A3). Third child nodes 2446J, 2446K, 2446L, and 2446M may be dependent from second child node 2446C representing a third subset of combiner boxes being coupled to a respective array (combiner boxes A4_1, A4_2, A4_3, and A4_4 being coupled to Array A4). Third child nodes 2446N, 24460, 2446P, 2446Q, and 2446R may be dependent from second child node 2446B representing a fourth subset of combiner boxes being coupled to a respective array (combiner boxes B1_1, B1_2, B1_3, B1_4, and B1_5 being coupled to Array B1). Third child nodes 2446S and 2446T may be dependent from second child node 2446A representing a fifth subset of combiner boxes being coupled to a respective array (combiner boxes B4_1 and B4_2 being coupled to Array B4).

Each of the one or more third child nodes may be coupled to respective fourth child nodes (e.g., fourth child nodes 2438C-1 through 2438C-N). For instance, with regards to FIG. 24C, four fourth child nodes 2438C-1 through 2438C-4 may be dependent from third child node 2446F representing a first subset of solar strings being coupled to a respective combiner box (e.g., Strings A2_1_1, A2_1_2, A2_1_3, and A2_1_4 being coupled to combiner box A2_1). Each other third child node may also have respective fourth child nodes dependent from them. The fourth child nodes, which may represent a lowest level in this example asset hierarchy, may correspond to the physical components that are instrumented with sensors and may serve as the origin of the sensor data ingested by the system. For example, a string of solar panels in a solar array, a wind turbine, or other terminal components within an asset hierarchy may generate the time-series measurements used to characterize operational behavior. Accordingly, higher level nodes (e.g., combiner boxes, arrays, inverters) may aggregate sensor data originating from these lowest-level sensor-equipped physical components and may pass it along until it arrives at the processing circuitry implementing process 2310. Alternatively, it should be noted that there may be examples where higher level nodes may collect sensor data of their own that is provided with or in lieu of the sensor data originating from the lowest level components of the hierarchy.

The term “sensor data” may refer to raw or processed measurements originating from one or more sensors associated with the one or more assets. In some examples, the sensor data may include time series records generated by the one or more sensors, where each time series record associates a timestamp with one or more sensor feature values corresponding to a respective asset. A “sensor feature” as described herein may refer to a measurable attribute of an asset that is monitored by the one or more sensors. Each time series record may include one or more of a timestamp associated with the respective time series sensor record, a name of a respective asset associated with the respective time series sensor record, a name of a respective sensor feature associated with the respective time series sensor record, and a value of the respective sensor feature for the respective asset at the timestamp associated with the respective time series sensor record.

In a non-limiting example, as described with reference to FIG. 24B, a set of sensors may provide sensor data 2406 from assets 2404 in the form of a set of time series sensor records 2440A through 2440I corresponding to a first timestamp (e.g., Timestamp 1). Each time series sensor record may include a timestamp 2438A, a name of a respective asset 2438B, a name of a respective sensor 2438C, and a sensor feature value 2438D measured by the respective sensor at the timestamp 2438A. Each of time series records 2440A, 2440B, 2440C, and 2440E as well as those in time series record set 2440D may correspond to a first asset (i.e., Asset A) and may include sensor feature values received from each of the sensors associated with the first asset (e.g., Sensors A through N) at the first timestamp. Each of time series records 2440F and 2440G may correspond to a second asset (i.e., Asset B) and may include sensor feature values received from each of the sensors (e.g., Sensors A and B) associated with the second asset (e.g., Asset B) at the first timestamp. Additional time series records corresponding to the second asset for each of the remaining sensors for the second asset as well as corresponding time series records for other assets may be included in time series record set 2440H, except for time series record 2440I, which may correspond to a last asset and a last sensor for that asset at the first timestamp.

The sensor data 2406 may further include time series records corresponding to other timestamps (e.g., time series records 2440J, 2440K, and 2440M as well as all of those in time series record set 2440L). For instance, time series records 2440J and 2440K may correspond to a same asset (e.g., asset 2404A, asset A) and sensor as time series records 2440A and 2440B, respectively, but may occur at a second timestamp after the first timestamp (e.g., Timestamp 2). Additional time series records corresponding to each asset and each sensor over each timestamp may be included in time series record set 2440L until time series record 2440M, which may include a final feature value from a last sensor of a last asset at a last timestamp. The sensor data 2406 may be stored in a long-format representation, where each observation may be represented by multiple time series records. For instance, a single observation at a first timestamp may include a first sensor value and a second sensor value. Accordingly, the sensor data may include a first record for the first sensor value and a second record for the second sensor value.

It should be noted, without deviating from the scope of the present disclosure, that sensors may be shared between assets or that independent sensors may exist for each asset (e.g., Sensor A for Asset A may be the same as that one for Asset B or there may be two separate instances of Sensor A, one for Asset A and one for Asset B). Additionally, the number of sensors may be the same or may vary from asset to asset without deviating from the scope of the present disclosure. It should also be noted that, in some examples, the time series records may be transmitted at different times from their respective sensors independently of other sensors.

In some examples, a first plurality of time series sensor records of the sensor data may be associated with a first timestamp of the time series and a first asset of the one or more assets. Additionally, a second plurality of time series sensor records of the sensor data may be associated with a second timestamp of the time series different from the first timestamp and associated with one of: the first asset or a second asset of the one or more assets. For instance, as depicted with reference to FIG. 24B, time series records 2440A through 2440E may be associated with first timestamp (e.g., Timestamp 1) and a first asset (e.g., Asset A). Additionally, time series records 2440J and 2440K may be associated with a second timestamp different from the first timestamp (e.g., Timestamp 2) and may be associated with the first asset. Likewise, time series record 2440M may be associated with a timestamp different from the first timestamp (e.g., Timestamp M) and may be associated with a second asset (e.g., Asset N).

In some examples, the sensor data may be received by a real-time or near real-time event streaming service. The term “event streaming service” as defined herein may refer to a computing system configured to continuously receive and process sensor data from one or more assets as the data is generated or with minimal latency (e.g., latency below a predefined threshold). The predefined threshold may correspond to a maximum allowable delay between data generation and processing and may vary depending on system constraints, including asset type or measurement type. In a non-limiting example, the predefined threshold may be less than one second for high-frequency telemetry associated with rotating machinery, less than five seconds for medium-frequency sensor streams associated with inverters, and less than one minute for low-frequency environmental measurements. In certain embodiments, the event streaming service may be implemented using an event stream processing system, such as the ESPE 800 described herein. In a non-limiting example, as described with reference to FIG. 24C, event streaming service 2408 may receive sensor data 2406 in real-time or near real-time. Receiving the sensor data 2406 in real time or near-real time may be enabled by the event streaming service 2408 instantiating an ESPE within a containerized execution environment, where the ESPE may continuously receive, filter, and enrich sensor data records and may integrate such data records into an analytical data structure as described herein.

As shown in FIG. 23, process 2320 of method 2300 may include computing, by the processing circuitry, a plurality of enriched features for the one or more assets based on a plurality of sensor features in the sensor data. In a non-limiting example as described with reference to FIG. 24A, event streaming service 2408 may collect sensor data 2406 from sensors associated with assets 2404 and may provide the sensor data 2406 to data enrichment service 2410. Data enrichment service 2410 may compute a plurality of enriched features 2412 for the assets 2404 based on a plurality of sensor features (e.g., each sensor feature value 2438D) in sensor data 2406. As used herein, “sensor” and “name of sensor 2438C” may be used interchangeably, where each name of sensor 2438C identifies a specific sensor that produces a corresponding sensor feature value 2438D for a given asset.

As described herein, the term “enriched feature” may refer to a derived data attribute that is computed from raw sensor feature values (e.g., those received directly from the assets). Enriching features may occur in order to improve a fidelity and predictive value of sensor data and may generally involve incorporating transformations, contextual adjustments, or combinations of multiple sensor feature values to capture higher-order characteristics of asset operation. In some embodiments, computation of enriched features may be performed in real time or near real time by a data enrichment service operating within the event streaming service described herein. Such enriched features may include, but not be limited to, true wind speed (e.g., derived by multiplying an air density correction with wind speed), average blade load calculated from multiple blade load sensors, average bearing temperature across multiple distinct points of a rotor shaft, average stator winding temperatures calculated across multiple windings of a generator, average electrical current values produced by a generator across distinct phases, average voltage values produced by a generator across distinct phases, or average transformer core temperatures measured at multiple distinct points of the transformer. Computation of enriched features may thus occur as part of a real-time preprocessing pipeline applied to incoming time-series sensor records. For instance, wind speed sensor values associated with a wind farm asset (e.g., a wind turbine) may be adjusted by applying correlation coefficients to remove wake effects in a wind farm or filtered to exclude values below a cut-in speed and/or above a cut-off speed.

As shown in FIG. 23, process 2330 of method 2300 may include generating, by the processing circuitry, an analytical data structure including feature values of the plurality of enriched features and the plurality of sensor features for the one or more assets over a time series. In a non-limiting example, as described with reference to FIG. 24A, analytical table builder 2414 may receive enriched features 2412 from data enrichment service 2410 and sensor data 2406 from the sensors associated with assets 2404 and may generate (e.g., in real-time or near real-time) an analytical data structure 2416 that includes feature values of the enriched features 2412 and the sensor features of the sensor data 2406 for the assets 2404 over a time series.

The term “analytical data structure” may refer to a structured, machine-readable representation of sensor data and enriched feature data. The analytical data structure may be implemented as a table, matrix, or equivalent record-based format in which columns correspond to specific features and rows correspond to asset-timestamp combinations. For instance, as depicted in FIG. 24D, analytical data table 2416 may be implemented in a tabular format. It should be noted that the analytical data structure may be in a suitable format for input into a series of machine learning models (e.g., the anomaly detection model and the asset performance prediction model as described herein).

The analytical data structure may include one or more columns that correspond to a respective feature of the plurality of sensor features and the plurality of enriched features. For instance, as depicted in FIG. 24D, columns 2438C₁ through 2438C_{N} of analytical data table 2416 may correspond to each sensor feature within sensor data 2406 and columns 2412A through 2412N (e.g., columns 2412A, 2412B, 2412C, and 2412N) may correspond to each sensor feature within enriched features 2412. Additionally, the analytical data structure may include one or more rows that correspond to a respective asset of one or more assets, where each row corresponds to a respective timestamp of the time series and includes a subset of feature values that correspond to the respective asset at the respective timestamp.

As depicted in FIG. 24D, analytical data table 2416 may include rows 2448A, 2448B, 2448D, 2448E, and 2448M and may further include sets of rows 2448C and 2448F, where set of rows 2448C may represent a set of rows between row 2448B and row 2448D and set of rows 2448F may represent a set of rows between row 2448E and 2448M. Each row may have an associated first column 2438A indicating a respective first timestamp and an associated second column 2438B indicating an identifier (e.g., name) of a respective asset. Additionally each row may include columns that indicate a subset of feature values that correspond to the respective asset at the respective timestamp (e.g., columns 2438C₁ through 2438C_{N} and columns 2412B through 2412N).

In some examples, generating the analytical data structure includes transforming a plurality of long-format time series sensor records into a transposed, row-based representation. In the long-format representation, each time series sensor record corresponds to a single measurement for a specific sensor, asset, and timestamp. The analytical table builder may aggregate and pivot those individual records so that each unique combination of asset and timestamp is represented by a single row in the analytical data structure. Each row therefore includes multiple columns corresponding to the feature values of the various sensors associated with that asset at that specific timestamp. The transformation from the long-format sensor records into the transposed analytical data structure may occur in real time or near real time, such that the analytical data structure may be updated continuously as new sensor data is received. For instance, in some examples, the transposition may be performed within tens to hundreds of milliseconds for each new received block of sensor data, enabling sub-second latency between sensor data arrival and analytical table availability for model execution.

In a non-limiting example of transposition, generating a first row of the analytical data structure that corresponds to a first asset at a first timestamp and includes first features values for a plurality of sensor features included in a first plurality of time series sensor records. Additionally, generating the analytical data structure may include generating a second row of the analytical data structure that corresponds to the first asset or a second asset at a second timestamp and includes second feature values for a plurality of sensor features included in a second plurality of time series sensor records. For instance, as depicted with reference to FIG. 24D, analytical table generator 2414 may generate row 2448D of analytical data table 2416 that corresponds to a first asset (e.g., Asset N) and at a first timestamp (e.g., Timestamp 1) and includes first feature values (e.g., within columns 2438C₁ through 2438C_{N}) for a plurality of sensor features included in a first plurality of time series sensor records (e.g., sensor feature values 2438D as indicated in time series sensor record 2440I and other time series sensor records corresponding to Timestamp 1 and Asset N in time series record set 2440H). Additionally, analytical table generator 2414 may generate row 2448M of analytical data table 2416 that corresponds to the first asset (Asset N) and a second timestamp (e.g., Timestamp M) and includes second feature values (e.g., within columns 2438C₁ through 2438C_{N}) for a plurality of sensor features included in a second plurality of time series records (e.g., sensor feature values 2438D as indicated in time series sensor record 2440M and other time series sensor records corresponding to Timestamp M and Asset N in time series record set 2440L). In this manner, the analytical table builder may perform a real-time transposition of the long-format sensor data (e.g., grouped as one record per sensor) to a wide-format analytical data table (e.g., grouped as one row per asset-timestamp pair). Other rows (e.g., 50 rows, 100 rows, 2000 rows, 10000 rows) may be generated in an analogous manner.

In some examples, when not all sensor data is received concurrently (e.g., due to network delays, sensor downtime, asynchronous reporting intervals), process 2330 may construct partial tables containing the available subset of feature values and may instantiate a secondary table or additional processing pipeline to integrate data that arrives later. Additionally, or alternatively, there may be certain examples in which only one row is permitted per analytical data table, where each table instance corresponds to a specific asset-timestamp pair.

In some examples, generating the analytical data structure may include detecting, by the processing circuitry, that a respective enriched feature of the plurality of enriched features has a first feature value in a first row of the analytical data structure and the respective enriched feature of the plurality of enriched features has a second feature value in a second row of the analytical data structure. Additionally, generating the analytical data structure may include determining that the first feature value of the respective enriched feature does not satisfy a filtering criterion and that the second feature value of the respective enriched feature satisfies the filtering criterion. In response the first row may be removed and the second row may be maintained in the analytical data structure. In a non-limiting example, as described with reference to FIG. 24D, analytical table generator 2414 may detect a value of enriched feature 2412A in row 2448E as well as value of enriched feature 2412 in row 2448A. Analytical table generator 2414 may determine that the value of enriched feature 2412A in row 2448E fails to satisfy a filtering criterion and that the value of enriched feature 2412A in row 2448A satisfies the filtering criterion. In response, analytical table generator 2414 may remove row 2448E and may maintain row 2448A. In some examples, the filtering may be in real-time or near real-time.

The term “filtering criterion” as used herein may refer to a logical condition applied to feature values within an analytical data structure to determine whether a set of time series sensor records corresponding to a particular asset at a particular timestamp is retained or excluded from subsequent processing. The filtering criterion may include a threshold-based comparison, a range restriction, or one or more categorical inclusion rules. In a non-limiting example, a filtering criterion may exclude time sensor records for a particular asset at a particular timestamp if a corresponding enriched feature satisfies an associated threshold (e.g., if true wind speed measurements for that particular asset at that particular asset fall below a cut-in threshold or exceed a cut-off threshold). In some examples, two or more filtering criteria may be concurrently executed to perform compound filtering operations across multiple sensor attributes.

As shown in FIG. 23, process 2340 of method 2300 may include generating, by the processing circuitry using an anomaly detection model, an anomaly output data structure that extends the analytical data structure to include a set of anomaly score values corresponding to the one or more assets over the time series. The term “extends” may refer to augmenting an existing data structure while preserving its original rows, columns, and corresponding feature values. In particular extending the analytical data structure may include adding one or more new columns containing additional computed values (e.g., anomaly score values that correspond to existing asset-timestamp rows of the analytical data table. In a non-limiting example, as described with reference to FIG. 24A, anomaly detection model 2418 may receive analytical data table 2416 from analytical table builder 2414 and may generate an anomaly output data structure 2420 that extends the analytical data table 2416.

An anomaly detection model as described herein may refer to a computational model trained to identify deviations in sensor feature values or enriched feature values that are inconsistent with historical or predefined operational patterns of one or more assets. The anomaly detection model may evaluate incoming sensor data and enriched features to compute anomaly score values that indicate the degree of deviation from the historical or predefined operational patterns.

In order to generate the anomaly output data structure, the anomaly detection model may assign an anomaly score to each entry of the analytical data structure. In the case where the analytical data structure is an analytical data table, the anomaly detection model may add a column to the analytical data structure that includes the assigned anomaly scores. Accordingly, the anomaly output data structure that extends the analytical data structure may include one or more columns that correspond to the one or more columns originating from the analytical data structure and an anomaly score column that stores the set of anomaly score values corresponding to the one or more assets over the time series. For instance, as depicted with reference to FIG. 24E, anomaly output data table 2420 may include one or more columns that correspond to the one or more columns originating from analytical data table 2416 (e.g., columns 2438C₁ through 2438C_{N} and 2412A through 2412N may correspond to columns 2450C₁ through 2450C_{N} and enriched features 2451A through 2451N, respectively). Additionally, the one or more columns may correspond to an anomaly score column 2452 that stores the set of anomaly score values corresponding to the one or more assets over the time series. Additionally, columns 2450A and 2450B of anomaly output data table 2420 may correspond to columns 2438A and 2438B of analytical data table 2416.

Additionally, the anomaly output data structure may include one or more rows that corresponds to the one or more rows originating from the analytical data structure and updated to include a respective anomaly score value corresponding to the respective asset at the respective timestamp. For instance, as depicted with reference to FIG. 24E, anomaly output data table 2420 may include rows 2454A, 2454B, 2454D, 2454E, and 2454M which may correspond to rows 2448A, 2448B, 2448D, 2448E, and 2448M, respectively of analytical data table 2416. Additionally, sets of rows 2454C and 2454F may correspond to sets of rows 2448C and 2448F of analytical data table 2416. Each of rows 2454A, 2454B, 2454D, 2454E, and 2454M and sets of rows 2454C and 2454F may include the respective anomaly score value determined for that row. In some examples, the anomaly score may range from 0 to 1, where 0 may represent a smallest amount of deviance from predefined or historically observed behavior and 1 may represent a most extreme deviance from the predefined or historically observed operational behavior.

In some examples, the anomaly detection model may be implemented as an isolation forest ensemble including a plurality of binary decision trees that recursively partition a feature space of sensor data until reaching terminal nodes that isolate individual or small subsets of sensor records. The number of node traversals required to isolate a given sensor record may serve as a measure of its similarity to other records, where shorter path lengths correspond to greater anomaly likelihood (e.g., and thus a greater anomaly score value). The resulting anomaly score for each record may be computed as the normalized average path length across all trees, thereby producing a continuous measure of deviation from normal behavior. It should be noted that the type of model used for anomaly detection may vary according to a frequency with which sensor data is received at 2310. For instance, the anomaly detection model may be implemented as an isolation forest ensemble in examples in which sensor data is received at a relatively low frequency (e.g., on the order of minutes between data samples). However, in examples in which sensor data is received at a relatively high frequency (e.g., on the order of milliseconds between data samples), other types of machine learning models may be utilized (e.g., one-class support vector machine).

In some examples, the processing circuitry associated with the system described herein may train the anomaly detection model. Training the anomaly detection model may involve constructing the plurality of binary decision trees from historical sensor data, where each binary decision tree is trained on a random subsample of the historical sensor data. For instance, the processing circuitry described herein may construct an analytical data table from the historical sensor data. Once the analytical data table is constructed, the processing circuitry may select a feature within an entry of the analytical data table at random and a random feature value for splitting the entries of the analytical data table into entries that have a higher associated feature value and entries that have a lower associated value. This process may continue iteratively until each node of the binary decision tree includes one entry or the tree reaches a maximum depth. The training may further involve defining a contamination level and using the defined contamination level to determine a corresponding anomaly threshold. The contamination level may indicate a proportion of entries within the analytical data table that should be treated as anomalous. For instance, if a contamination level of 1% is set, a node within a given binary decision tree may be indicated as anomalous if it has a path length that would put it above the 99th percentile (e.g., the 0.99 quantile) of shortest path length. Each tree may be trained on a random subset of the data and a random subset of features to enhance robustness.

In some examples, the anomaly detection model may be trained offline within a workspace, where a “workspace” may refer to a file structure or computational environment that includes one or more directories storing files that are input to or output from the training process. In a non-limiting example, the workspace may include an input folder storing input data files, a model store folder including model store files associated with anomaly detection, a code folder including executable files used to perform training, and an output folder including files that are output from the training process. It should be noted that these files may be modified via a user interface.

Performing training within the workspace may involve the process circuitry described herein reading in the historical sensor data from the input files (e.g., using an associated script that reads in the historical sensor data and processes it into an analytical data table). After the historical sensor data is read in, the processing circuitry may perform the training as described herein on the historical sensor data (e.g., using an associated script in the code folder that fits an isolation forest to the historical sensor data) and may serialize the resulting anomaly detection model into an model store file to store in the model store folder which includes internal parameters of the anomaly detection model. Further, the training may result in the generation of output files to store in the output folder that represent raw or processed outputs of the anomaly detection model. During deployment, the model store file may be loaded for computing anomaly scores in real time as new sensor data arrives.

In some examples, the system may employ a compiled macro catalog within the offline model-development environment to automate the generation of the machine-learning components and configuration artifacts used during online execution. The compiled macro catalog may include a set of orchestrated macros that perform operations associated with the ingestion and preprocessing of historical sensor data, the training and serialization of analytical models (e.g., the power prediction model and the anomaly detection model), and the creation of configuration files consumed by the online event-stream processing environment.

During a first phase of the offline workflow, execution of the macro catalog may initiate structured ingestion of historical sensor data and may perform preprocessing operations on the data. The pre-processing operations may include generating enriched attributes, filtering the sensor data, and aligning sensor data received from multiple sensors.

During a second phase of the offline workflow, the macro catalog may invoke model-training procedures to generate the analytical models (e.g., the anomaly detection model and/or the power prediction model) deployed in the online environment. These model-training procedures may include training an anomaly-detection model, a power-prediction model, and/or models associated with the explainability algorithms described herein. The macro catalog may encapsulate any parameters used to produce stable and deployable model outputs (e.g., hyperparameter settings). For each trained model, the macro catalog may generate a corresponding serialized representation (e.g., a model store file) suitable for ingestion by an event-stream processing engine operating in an online or edge-execution environment.

During a third phase of the offline workflow, the macro catalog may compute analytical summaries of historical asset behavior and may generate configuration artifacts for online execution. These configuration artifacts may include anomaly score thresholds, power prediction thresholds, or other metadata indicating characteristics of the monitored energy-asset fleet.

Additionally, in some examples, the trained anomaly detection model and the trained asset performance prediction model may be deployed within an online model package executed inside an ESP container. The ESP container may operate as a real-time inference engine configured to continuously receive sensor data, compute enriched attribute values, execute trained models stored in one or more model store files, and evaluate alerting logic defined in one or more configuration files.

The ESP container may be implemented as a container image (e.g., a Docker image) that encapsulates the executable software utilized for real-time processing while externalizing model artifacts and configuration files through one or more mounted volumes. The mounted volumes, which may also be referred to as volume mounts, may provide access to directories that contain model store files (e.g., associated with the anomaly detection model and the asset performance prediction model), alert rule configurations, pre-defined thresholds (e.g., the power prediction threshold and the anomaly score threshold), and/or log records generated during real-time execution. By separating runtime components from stored model artifacts, the system may enable model and configuration updates without reconstructing or re-deploying the container image.

As shown in FIG. 23, process 2350 of method 2300 may include generating, by the processing circuitry using an asset performance prediction model, an asset performance output data structure that extends the anomaly output data structure to include a plurality of predicted asset performance values for the one or more assets over the time series (e.g., augments or expands the anomaly output data structure by adding a new column while preserving all previously stored data elements). An asset performance prediction model may refer to a computational model configured to generate predicted asset performance metric values, such as power, voltage levels, or operational efficiency. In a non-limiting example, as described with reference to FIG. 24A, asset performance prediction model 2422 may receive anomaly output data table 2420 from anomaly detection model 2418 and may generate an asset performance output data table 2424 that extends the anomaly output data table 2420.

In order to generate the asset performance output data structure, the asset performance prediction model may assign a predicted asset performance value to each entry of the anomaly output data structure. In the case where the anomaly output data structure is an anomaly output data table, the asset performance output data structure may add a column to the anomaly output data table that includes the assigned predicted asset performance values. Accordingly, the asset performance output data structure that extends anomaly output data structure may include one or more columns that correspond to the one or more columns originating from the anomaly output data structure and a predicted asset performance column that stores the plurality of predicted asset performance values for the one or more assets over the time series. For instance, as depicted with reference to FIG. 24F, asset performance output data table 2424 may include one or more columns that correspond to the one or more columns originating from anomaly output data table 2420 (e.g., columns 2456C₁ through 2456C_{N}, 2457A through 2457N, and 2452 may correspond to columns 2450C₁ through 2450C_{N}, 2451A through 2451N, and 2458, respectively). Additionally, the one or more columns may correspond to a predicted asset performance column 2460 that stores the set or predicted asset performance values corresponding to the one or more assets over the time series. Additionally, columns 2456A and 2456B of asset performance output data table 2424 may correspond to (e.g., include) columns 2450A and 2450B of anomaly output data table 2420.

Additionally, the asset performance output data structure may include one or more rows that corresponds to the one or more rows originating from the anomaly output data structure and updated to include a respective predicted asset performance value corresponding to the respective asset at the respective timestamp. The term “predicted asset performance value,” as used herein, may refer to a numerical or categorical value generated by the asset performance prediction model that represents an estimated operational or performance-related parameter of an asset. Such values may include, but are not limited to, a predicted power output value (e.g., predicted electrical power generation of a turbine at a given timestamp), a predicted voltage level, a predicted current magnitude, or a predicted operational efficiency value (e.g., capacity factor or thermal efficiency). For instance, as depicted with reference to FIG. 24E, the asset performance output data table 2424 may include rows 2462A, 2462B, 2462D, 2462E, and 2462M which may correspond to rows 2454A, 2454B, 2454D, 2454E, and 2454M, respectively of anomaly output data table 2420. Additionally, sets of rows 2462C and 2462F may correspond to sets of row 2454C and 2454F of anomaly output data table 2420. Each of rows 2462A, 2462B, 2462D, 2462E, and 2462M and sets of rows 2462C and 2462F may include the respective predicted asset performance value determined for that row. An example of a predicted asset performance value may include a predicted amount of electrical power.

In some embodiments, the asset performance prediction model may be implemented as a gradient boosting ensemble comprising multiple shallow decision trees arranged in sequential layers, where each subsequent layer of trees is trained to correct the residual prediction errors of the preceding layer. For instance, a base predicted asset performance value may be output for a given entry within the analytical data table and each layer of decision trees may be applied iteratively to the predicted asset performance value in order to correct a residual between the predicted asset performance value and an actual asset performance value.

Performing training of the asset performance prediction model may involve generating an analytical data table from historical asset data and calculating a base predicted asset performance value for each of the entries within the analytical data table. The processing circuitry described herein may then record, for each entry, a difference between the base predicted asset performance value and an actual asset performance value, where this difference may be referred to as a “residual.” The processing circuitry may then train a decision tree to fit the residuals and may subsequently determine updated predicted asset performance values using an output of the decision tree as a correction factor. The processing circuitry may then calculate the corresponding residuals when using the decision tree and may determine a subsequent decision tree for correcting the predicted asset performance value as corrected by the original decision tree. This procedure may continue iteratively until a threshold quantity of decision trees is generated. It should be noted that the actual asset performance value may be provided separately as a performance label.

In some examples, the asset performance prediction model may be trained offline within a same workspace as the anomaly detection model. Performing training within the workspace may involve the process circuitry described herein reading in the historical sensor data from the input files (e.g., using an associated script that reads in the historical sensor data and processes it into an analytical data table). After the historical sensor data is read in, the processing circuitry may perform the training as described herein on the historical sensor data (e.g., using an associated script in the code folder that fits a gradient boosting tree for asset performance prediction) and may serialize the resulting asset performance prediction model into an model store file to store in the model store folder which includes internal parameters of the asset performance prediction model. Further, the training may result in the generation of output files to store in the output folder that represent raw or processed outputs of the asset performance prediction model. During deployment, the model store file may be loaded for computing anomaly scores in real time as new sensor data arrives. It should be noted that there may be alternate examples where the asset performance prediction model is trained using a random forest.

In some examples, a respective predicted asset performance value of the plurality of predicted asset performance values indicates an expected value for a feature of an asset at a respective time. For instance, in an example where a predicted asset value represents an electrical current value representing an amount of alternating current produced by a generator of an energy asset, the predicted asset performance value may indicate an expected value for the electrical current value. Alternatively, in an example where a predicted asset value represents a power generated by a generator of an energy asset, the predicted asset performance value may indicate an expected value for the generated power. A value being an expected value for a feature of an asset at a respective time may refer to it satisfying a respective threshold or being within a threshold range, wherein the threshold or threshold range are predefined or are derived empirically and/or from historical data. The identification of an expected value may facilitate later computation of performance disparity values that quantify deviations between predicted and measured performance by using the expected value and an actual value that is observed.

In some examples, a respective row of the asset performance output data structure at least includes the respective predicted asset performance value, and an actual value of the feature at the respective time. In such examples, the processing circuitry may compute a prediction error value between the respective predicted asset performance value and the actual value of the feature and may determine that the prediction error value exceeds a prediction error threshold for a predetermined number of periods. For instance, the processing circuitry described herein may execute a script (e.g., from the code folder of a corresponding workspace) that performs further processing on the asset performance output data structure output by the asset performance prediction model. The script may retrieve the predicted asset performance value and actual asset performance value from the asset performance output data structure and may calculate a performance disparity value as a ratio of the two values. It should be noted that there may be alternative examples where the performance disparity value may be calculated as the actual asset performance value.

For instance, in a non-limiting example as illustrated with reference to FIG. 24F, row 2462A of asset performance output table 2424 may include a column (e.g., column 2456C₁ or 2457A) that corresponds to an actual amount of alternating current produced by a generator and may include a predicted asset performance column 2460 that corresponds to an expected amount of electrical current. Alternatively, in another non-limiting example, row 2462A of asset performance output table 2424 may include a column (e.g., column 2456C₁ or 2457A) that corresponds to an actual amount of power produced by a generator and may include a predicted asset performance column 2460 that corresponds to an expected amount of power produced.

In response to determining that the prediction error value exceeds the prediction error threshold for a predetermined number of periods, event streaming service 2408 may designate the asset performance prediction model as requiring retraining and may retrain the asset performance prediction model based on the designating. In some examples, retraining may be triggered according to a configuration defined within the workspace file structure and may include a percentage error threshold and a prespecified number of periods during which the threshold must be exceeded, where the percentage error may represent a deviation between an actual performance of an asset and the predicted performance of the asset. In a non-limiting example, these parameters may be defined within an input file located within an input folder of the workspace structure. Retraining the asset performance prediction model may include updating one or more parameters of the model using a subset of feature values included in the respective row of the asset performance output data structurer as input variables. The updated parameters may be serialized into an model store file that is stored in the model store folder of the workspace and may replace or supplement the deployed model instance.

In some examples, the retraining processes may employ a latching mechanism to prevent redundant retraining or repeated alerts within short temporal windows. For instance, if the asset performance prediction model for a given asset has already triggered a retraining event and fewer than a threshold quantity of days have elapsed since that retraining event (e.g., three days), the event streaming service described herein may refrain from triggering another retraining event even if the associated conditions are satisfied again. Similarly, if the asset performance prediction model or the anomaly detection model for the given asset has already triggered alert generation and fewer than a threshold quantity of days have elapsed since that alert has been generated (e.g., three days), the event streaming service described herein may refrain from triggering an additional alert even if the associated performance disparity value exceeds an associated predefined threshold. Once the threshold time period has elapsed, subsequent violations of the retraining criteria may result in new retraining operations or alert generation. This latching process may ensure that transient fluctuations do not result in excessive retraining activity or unnecessary computational overhead.

As shown in FIG. 23, process 2360 of method 2300 may include inserting, into the asset performance output data structure by the processing circuitry, a plurality of performance disparity values computed based on the plurality of predicted asset performance value and the feature values of a respective sensor feature of the plurality of sensor features in the asset performance output data structure. In a non-limiting example, as described with reference to FIG. 24A, performance disparity inserter 2427 may receive asset performance output data table 2424 from asset performance prediction model 2422 and may insert, into the asset performance output data table 2424 a plurality of performance disparity values 2426.

The term “performance disparity value” as described herein may refer to a quantified measure representing a difference or ratio between a predicted performance value of an asset and a corresponding actual sensor feature value observed for the asset at a given timestamp. For instance, a respective performance disparity value of the plurality of performance disparity values may be computed based on a respective predicted asset performance value of a respective asset at a respective timestamp of the time series and a value of the respective sensor feature for the respective asset at the respective timestamp. In some such examples, the performance disparity value may be a ratio of the value of the respective sensor feature to the respective predicted asset performance value. In a non-limiting example, a respective sensor feature may measure an actual amount of electrical current or power produced by a generator of an asset and a predicted asset performance value may indicate a predicted amount of electrical current or power produced by the generator. In some such examples, the corresponding calculated performance disparity value may be a ratio of the actual amount of electrical current to the predicted amount of electrical current or may be a ratio of the actual amount of power to the predicted amount of power.

In some examples, the plurality of performance disparity values are inserted into the asset performance output data structure after the asset performance prediction model generates the asset performance output data structure. For instance, as illustrated with reference to FIG. 24G, asset performance prediction model 2422 may first generate asset performance output data table 2424 and performance disparity inserter 2427 may then insert the performance disparity values 2426.

In some examples, inserting the plurality of performance disparity values into the asset performance output data structure includes adding, by the processing circuitry, a performance disparity column to the asset performance output data structure and updating, by the processing circuitry, one or more rows of the asset performance output data structure to include a respective performance disparity value corresponding to a respective asset at a respective timestamp of the time series. For instance, in a non-limiting example, as described with reference to FIG. 24G, performance disparity inserter 2427 may add performance disparity column 2464 to asset performance data table 2424 and may update each of rows 2462A through 2462M with respective performance disparity values 2426. Inserting a new column may involve allocating additional memory to accommodate performance disparity column 2464 and storing a new computed value for each row into asset performance data table 2424. Further, associated metadata may be updated to enable reference to the associated column (e.g., a table size, a column index, a column label).

In examples in which the workspace described herein is utilized, the computation of performance disparity values may be located within the model store file associated with the asset performance prediction model (e.g., in the model store folder). During deployment, the model store file may be loaded by the event stream processing system described herein into a scoring window or a compute window configured for edge deployment. In edge use cases, the model store file may be transferred to localized compute nodes or embedded systems positioned proximate to the monitored assets (e.g., within a turbine controller or substation gateway). Once deployed, the ESP instance at the edge may execute the model store file in real time against incoming sensor and enriched feature data to continuously compute performance disparity values.

As shown in FIG. 23, process 2370 of method 2300 may include detecting, by the processing circuitry using the asset performance output data structure, that a subset of the plurality of performance disparity values or a subset of the set of anomaly score values in the asset performance output data structure satisfy one or more alerting thresholds. In a non-limiting example, as described with reference to FIG. 24A, event streaming service 2408 may receive the asset performance output data table 2424 with performance disparity values 2427 and may detect that a subset of performance disparity values 2430 (e.g., one or more of performance disparity values 2427 within performance disparity column 2464) or a subset of anomaly score values 2432 (e.g., one or more anomaly scores within anomaly score column 2458) satisfies one or more alert thresholds 2428.

The term “alerting threshold” may refer to a predefined numerical or logical condition applied to anomaly scores or performance disparity values that, when satisfied, trigger generation of an asset maintenance alert. In some examples, the one or more alerting thresholds may be satisfied when a performance disparity value satisfies one or more alerting thresholds over multiple (e.g., contiguous) timestamps whose total span satisfies a predefined threshold duration. For instance, if both a first performance disparity value in a first row associated with an asset at a first timestamp of a time series and a second performance disparity value in a second row associated with the asset at a second timestamp of the time series are below a performance threshold and the first and second timestamp satisfy a threshold duration (e.g., having performance disparity values below a performance threshold for two or more contiguous timestamps), the one or more alerting thresholds may be satisfied.

In some examples, the one or more alerting thresholds may be satisfied when a first criterion or a second criterion is satisfied. The first criterion may be satisfied when a first performance disparity value associated with a first timestamp and a second performance disparity value associated with a second (e.g., contiguous) timestamp fall below a performance threshold and the respective timestamps satisfy a threshold duration. The second criterion may be satisfied when a respective anomaly score value exceeds an anomaly threshold. The performance threshold and the threshold duration may be extracted from a first file uploaded to a real-time or near real-time event streaming service and the anomaly threshold may be extracted from a second file, different from the first file, uploaded to the real-time or near real-time event streaming service.

In a non-limiting example, as described with reference to FIG. 24H, event streaming service 2408 may determine that the subset of anomaly score values 2432 satisfying one of the alert thresholds 2428 (e.g., an anomaly threshold) includes the anomaly score values associated with rows 2462B and 2462D of asset performance output data table 2424 as each of these anomaly score values may exceed the one of the alert thresholds 2428. Additionally, event streaming service 2408 may determine that the subset of performance disparity values 2430 satisfying other of the alert thresholds 2428 (e.g., a performance threshold) may include row 2462A of asset performance output data table 2424.

In some examples, the alerting thresholds used to evaluate anomaly score values and performance disparity values may be defined during offline training. For instance, a first input file in the input folder of the workspace used to train the anomaly detection model and the asset performance prediction model may define the anomaly score threshold value corresponding to the quantile-based cutoff determined during isolation forest training (e.g., the 0.99 quantile at a 1% contamination level). Additionally, a second input file in the input folder of the workspace may define threshold parameters for the performance disparity value and corresponding duration values indicating how long the performance disparity value should remain below a threshold before an alert is triggered. During runtime, the event streaming service described herein may read the contents of these input files.

In some embodiments, the processing circuitry described herein may implement persistence and latching logic to stabilize the alerting process. When an alert condition is met, the event stream processing service described herein may latch the alert in an active state and maintain it for a defined interval or until a monitored variable (e.g., the anomaly score or performance disparity value) returns to a normal range for a sufficient recovery period. Once latched, the alert may be logged in the output folder of the workspace.

As shown in FIG. 23, process 2380 of method 2300 may include generating, by the processing circuitry, an asset maintenance alert for one or more assets associated with the subset of the plurality of performance disparity values or the subset of the set of anomaly score values in the asset performance output data structure. In a non-limiting example, as described with reference to FIG. 24A, alert generator 2434 may receive a subset of performance disparity values 2430 and a subset of anomaly score values 2432 that satisfied alert thresholds 2428 from event streaming service 2408 and may generate asset maintenance alerts 2436 for the corresponding assets 2404.

In some examples, an asset maintenance alert is generated for a respective asset in response to determining that a row in the asset performance output data structure includes a performance disparity value or an anomaly score value that satisfies the one or more alerting thresholds. For instance, as described with reference to FIG. 24H, alert generator 2434 may generate a first asset maintenance alert for asset 2404B (i.e., Asset B) and a second asset maintenance alert for asset 2404N (i.e., Asset N) based on the anomaly score values within row 2462B and 2462D, respectively, of the asset performance output data table 2424 satisfying an anomaly threshold.

Additionally, or alternatively, an asset maintenance alert may be generated for a respective asset in response to determining that multiple rows in the asset performance output data structure corresponding to the asset include multiple anomaly score values or multiple performance disparity values that satisfy the one or more alerting thresholds over multiple (e.g., contiguous) timestamps. For instance, as described with reference to FIG. 24H, alert generator 2434 may generate a maintenance alert for asset 2404A (i.e., Asset A) based on the performance disparity value in row 2462A and the performance disparity value in a preceding row associated with asset 2404A at a preceding timestamp (e.g., immediately preceding) satisfying a performance disparity threshold.

In some examples, the processing circuitry associated with the system described herein may generate an asset maintenance alert for the respective asset if the respective amount of time during which the one or more alerting thresholds are satisfied exceeds a predefined alert persistence threshold (e.g., a respective quantity of contiguous timestamps during which a performance or anomaly threshold is satisfied exceeds a threshold quantity of timestamps, such as two, three, or ten contiguous timestamps). For instance, as described with reference to FIG. 24H, alert generator 2434 may generate a maintenance alert for asset 2404B (i.e., Asset B) based on the anomaly score value in row 2462B and an anomaly score value in a preceding row associated with asset 2404B at a preceding timestamp (e.g., immediately preceding) satisfying an anomaly threshold such that the quantity of timestamps exceeds a predefined alert persistence threshold (e.g., a threshold of 1). It should be noted that the asset maintenance alert may only be generated if a number of asset maintenance alerts generated for the respective asset over a specified time interval does not exceed a maximum alert count threshold. For instance, if the asset maintenance alert generated for asset 2404B for row 2462B would be a fourth asset maintenance alert generated within a specified time interval and the maximum alert count threshold is 3, then alert generator 2434 may refrain from generating the asset maintenance alert for row 2462B.

It should be noted that the asset maintenance alert may only be generated if the number of asset maintenance alerts generated for the respective asset over a specified time interval does not exceed a maximum alert count threshold, which prevents excessive alert generation under intermittent conditions. For example, if the asset maintenance alert generated for asset 2404B for row 2462B would be a fourth alert generated within a defined time window (e.g., one hour) and the maximum alert count threshold is three, then alert generator 2434 may refrain from generating the alert for row 2462B. In some implementations, alert generator 2434 may also apply latching and persistence behaviors, ensuring that once an alert is triggered, it remains active until all associated monitored variables return to normal operating ranges for a sufficient period.

In examples in which a respective performance disparity value in a respective row of an asset performance output data structure satisfies one or more alerting thresholds, generating the asset maintenance alert for a respective asset corresponding to the respective row may include extracting, by the processing circuitry, the respective performance disparity value and one or more respective feature values of the plurality of enriched features and the plurality of sensor features from the respective row. Additionally, generating the asset maintenance alert may include providing, by the processing circuitry, the respective performance disparity value and the one or more respective feature values to a power prediction explainability algorithm and computing, by the processing circuitry using the power prediction explainability algorithm, a contribution value for the plurality of enriched features and the plurality of sensor features with respect to the respective performance disparity value. Further, generating the asset maintenance alert may include detecting, by the processing circuitry, that the contribution value of a subset of features in the plurality of enriched features and the plurality of sensor features satisfies a contribution threshold and adding, to the asset maintenance alert by the processing circuitry, the subset of features identified as contributing to the respective performance disparity value.

In a non-limiting example, as described with reference to FIG. 24I, the performance disparity value associated with row 2462A of asset performance output data table 2424 (e.g., the performance disparity value within performance disparity column 2464) may satisfy a performance disparity threshold of the alert thresholds 2428. Accordingly, event streaming service 2408 may provide the respective performance disparity value of row 2462A and one or more respective feature values (e.g., one or more of the values within columns 2456C₁ through 2456C_{N} or columns 2457A through 2457N) to power prediction explainability algorithm 2466. Event streaming service 2408 may compute, via the power prediction explainability algorithm 2466, respective contribution values 2468 for each of the sensor features and/or enriched features. Each feature contribution value may indicate a magnitude and direction of a given feature's influence on a deviation between predicted and actual performance values.

In some examples, the feature contribution values 2468 may be derived as Shapley values, representing a marginal contribution of each feature to a predicted asset performance value. The computation of the feature contribution values may include three primary stages: post-processing, normalization, and summarization. During the post-processing stage, the power prediction explainability algorithm 2466 may update each Shapley contribution value based on the relationship between the predicted asset performance value and a baseline Shapley intercept. For instance, if the predicted asset performance value is represented by P_{TurbinePower}, the Shapley intercept is represented by interceptₛₕₚ, and an ith feature contribution value of the feature contribution values 1904 is represented by shpᵢ, then shpᵢ may be given an updated value according to (MIN(shpᵢ, 0)/(P_{TurbinePower}−interceptₛₕₚ))*100 if P_{TurbinePower}<interceptₛₕₚ and may be given an updated value according to (MAX(shpᵢ, 0)/(P_{TurbinePower}−interceptₛₕₚ))*100 if P_{TurbinePower}≥interceptₛₕₚ. The normalization stage may then scale the feature contribution values so that their sum equals a constant value (e.g., 100). This normalization may ensure that contributions are expressed as proportional percentages of total model influence.

In the summarization stage, the normalized feature-level contributions may be aggregated according to the physical or logical components to which each feature belongs. For example, features corresponding to blade speed and blade pitch may be summarized as a single contribution for a rotor component, while features corresponding to generator current and temperature may be summarized as a single contribution for a generator component. In a non-limiting example, as depicted in FIG. 24I, Sensors A, B, and E in FIG. 20 may correspond to a Component A; Sensor F may correspond to a Component B; and Sensors N and G may correspond to a Component C. Accordingly, the normalized feature contribution values associated with Sensors A, B, and E may be aggregated to represent a first contribution value for Component A; the normalized feature contribution value associated with Sensor F may represent a second contribution value for Component B; and the normalized feature contribution values for Sensors N and G may be aggregated to represent a third contribution value for Component C. Event streaming service 2408 may then provide the contribution values to alert generator 2434, which may detect which contribution values within contribution values 2468 satisfies a contribution threshold. For instance, alert generator 2434 may determine if the first, second, or third contribution value exceeds an anomalous component criterion. In a non-limiting example, alert generator 2434 may determine that the first contribution value for Component A exceeds the anomalous component criterion. Accordingly, alert generator 2434 may add the features 2472 contributing to the asset maintenance alert (e.g., the features associated with sensors A, B, and E) to asset maintenance alert 2436A. Additionally, alert generator 2434 may include a name of the corresponding asset 2470 (e.g., Asset A) as well as a natural language explanation 2474 describing why the features 2472 are behaving in an abnormal manner.

In examples in which a respective anomaly score in a respective row of an asset performance output data structure satisfies one or more alerting thresholds, generating the asset maintenance alert for a respective asset corresponding to the respective row may include extracting, by the processing circuitry, the respective anomaly score value and one or more respective feature values of the plurality of enriched features and the plurality of sensor features from the respective row. Additionally, generating the asset maintenance alert may include providing, by the processing circuitry, the respective anomaly score value and the one or more respective feature values to an anomaly score explainability algorithm and computing, by the processing circuitry using the anomaly score explainability algorithm, a contribution value for the plurality of enriched features and the plurality of sensor features with respect to the respective anomaly score value. Further, generating the asset maintenance alert may include detecting, by the processing circuitry, that the contribution value of a subset of features in the plurality of enriched features and the plurality of sensor features satisfies a contribution threshold and adding, to the asset maintenance alert by the processing circuitry, the subset of features identified as contributing to the respective anomaly score value.

In a non-limiting example, as described with reference to FIG. 24J, the anomaly score associated with row 2462B of asset performance output data table 2424 (e.g., the anomaly score value within anomaly score column 2458) may satisfy an anomaly score threshold of the alert thresholds 2428. Accordingly, event streaming service 2408 may provide the respective anomaly score value of row 2462B and one or more respective feature values (e.g., one or more of the values within columns 2456C₁ through 2456C_{N} or columns 2457A through 2457N) to anomaly score explainability algorithm 2467. Event streaming service 2408 may compute, via the anomaly score explainability algorithm 2467, contribution values 2476 for sensor features and/or enriched features and may perform post-processing, normalization, and summarization as described herein to compute normalized and aggregated feature contribution values (e.g., with reference to the anomaly score rather than the asset predicted performance value). For instance, if the predicted asset performance value is represented by S_{TurbineAnomaly}, the Shapley intercept is represented by interceptₛₕₚ, and an ith feature contribution value of the feature contribution values 1904 is represented by shpᵢ, then shpᵢ may be given an updated value according to (MIN(shpᵢ, 0)/(S_{TurbineAnomaly}))*100 if S_{TurbineAnomaly}<interceptₛₕₚ and may be given an updated value according to (MAX(shpᵢ, 0)/(S_{TurbineAnomaly}−interceptₛₕₚ))*100 if S_{TurbineAnomaly}≥interceptₛₕₚ. The normalization stage may then scale the feature contribution values so that their sum equals a constant value (e.g., 100).

In the summarization stage, the normalized feature-level contributions may be aggregated according to the physical or logical components to which each feature belongs. In a non-limiting example, as depicted in FIG. 24I, Sensors G, B, and D in FIG. 20 may correspond to a Component A; Sensor F may correspond to a Component B; and Sensors A and E may correspond to a Component C. Accordingly, the normalized feature contribution values associated with Sensors G, B, and D may be aggregated to represent a first contribution value for Component A; the normalized feature contribution value associated with Sensor F may represent a second contribution value for Component B; and the normalized feature contribution values for Sensors A and E may be aggregated to represent a third contribution value for Component C. Event streaming service 2408 may then provide the contribution values 2476 to alert generator 2434, which may detect which contribution values within contribution values 2476 satisfies a contribution threshold. For instance, alert generator 2434 may determine if the first, second, or third contribution value exceeds an anomalous component criterion. In a non-limiting example, alert generator 2434 may determine that the first contribution value for Component A exceeds the anomalous component criterion. Accordingly, alert generator 2434 may add the features 2480 contributing to the asset maintenance alert (e.g., the features associated with sensors G, B, and E) to asset maintenance alert 2436B. Additionally, alert generator 2434 may include, in the asset maintenance alert 2436B, a name of the corresponding asset 2478 (e.g., Asset A) as well as a natural language explanation 2482 describing why the features 2476 are behaving in an abnormal manner.

In some examples, the asset maintenance alert generated for a respective asset is transmitted using an electronic messaging service and may include a name of the respective asset, one or more features of the plurality of enriched features and the plurality of sensor features contributing to the asset maintenance alert, and a natural language explanation describing why the one or more features are behaving in an abnormal manner. For instance, as described with reference to FIG. 24I, asset maintenance alert 2436A may include a name of a respective asset 2470, one or more features contributing to the asset maintenance alert 2472, and a natural language explanation 2474 why the one or more features are behaving in an abnormal manner. Additionally, or alternatively, as described with reference to FIG. 24J, asset maintenance alert 2436B may include a name of a respective asset 2478, one or more features contributing to the asset maintenance alert 2480, and a natural language explanation 2482 why the one or more features are behaving in an abnormal manner.

In some examples, an asset maintenance alert may be generated in response to detecting degradation in model performance. For instance, as described with reference to process 1450A and/or 1450B, the event streaming service may monitor the ongoing accuracy of asset performance prediction model and may determine whether a percentage error in predicted asset performance exceeds a predetermined threshold for a predetermined number of contiguous time periods. If the percentage error satisfies such conditions, the event streaming service may generate an asset maintenance alert indicating that the asset performance prediction model is performing poorly and may benefit from retraining or recalibration.

In some examples, the output of the asset maintenance alert (or of model training as described herein) may include various graph plots or data visualizations. For instance, the output may include a performance summary, where the performance summary may, for instance, include a plot of a predicted performance asset value versus a corresponding feature value for various observations (e.g., predicted generated power versus true wind speed) a plot of the predicted performance asset value for each asset (e.g., a first predicted generated power distribution from a first asset, a second predicted generated power distribution from a second asset, and so on), or a plot of a feature contribution value relative for each asset (e.g., a first true wind speed distribution for a first asset, a second true wind speed distribution for a second asset, and so on).

In some examples the performance summary may include a real-time power curve anomaly monitoring visualization, which continuously updates as new data streams are processed. The real-time power curve visualization may plot actual power output values of a given asset (e.g., a wind turbine) on the y-axis against true wind speed values on the x-axis, forming a live power curve that reflects instantaneous operational efficiency. The visualization may overlay a reference power curve generated by the asset performance prediction model and may be updated in near real time (e.g., every few seconds or minutes) based on data received from the event streaming service.

In some examples, the system may construct the real-time power curve visualization by applying an anomaly detection algorithm to pairs of true wind-speed values and corresponding turbine-power output values. For instance, the system may apply a statistical boundary to incoming value pairs to assign an anomaly designation when an observed pair exceeds the statistical boundary. The distance of the observed pair from the statistical boundary may be used to compute a severity level. For instance, pairs of values that lie slightly outside the statistical boundary may be assigned a lower severity level, whereas pairs that lie a greater, substantial distance beyond the boundary may be assigned a higher severity level. Alternatively, all pairs beyond the boundary may be assigned a same severity level. In order to determine the statistical boundary, the system described herein may apply an unsupervised anomaly-detection algorithm to historical pairs of wind speed and actual power output.

It should be noted that power-curve anomaly detection may scale efficiently to wind farms of various sizes. The power-curve may rely on a small number of parameters (e.g., just wind speed and actual power output) relative to all derivable features for a particular wind turbine. Accordingly, anomaly detection may be performed with minimal computational overhead, even as a quantity of wind turbines within the wind farm increases.

Additionally, or alternatively, the output of the asset maintenance alert may include visualizations related to a clustering of assets (e.g., a plot or table of clusters of assets and the average distance between them). Additionally, or alternatively, the output of the asset maintenance alert may include visualizations (e.g., a plot or table) related to power coefficients and capacity factors. Additionally, or alternatively, the output of the asset maintenance alert may include visualizations of how each feature corresponds to an asset performance value (e.g., a pie chart showing the relative contribution value of each feature or a bar graph showing the relative contribution value). Additionally, or alternatively, the output of the asset maintenance alert may include visualizations comparing actual and predicted asset performance values (e.g., a scatter plot comparing actual and predicted power). Additionally, or alternatively, the output of the asset maintenance alert may include visualizations illustrating anomaly detection (e.g., a scatter plot of anomaly scores over time, a scatter plot of predicted asset performance values relative to a feature such as true wind speed, a pie chart demonstrating how various features contribute to a high anomaly score relative to each other, a bar chart demonstrating which feature has the highest contribution value).

In some embodiments, the system described herein may include a computational entity configured to act as an intermediary between a user and the various artifacts generated during energy asset anomaly detection. For instance, the system may include an agent capable of obtaining natural language input from a user (e.g., via an associated user interface), structuring that natural language input into a query that the agent may use to obtain relevant artifacts, and generating a response to the natural language input based on the retrieved artifacts (e.g., datasets containing sensor readings, specific alert information, tag component mapping, and/or results of online local sensitivity analyses). Such artifacts may include previously obtained asset information (e.g., asset data, enriched attributes, energy farm behavior data structures), model-generated scores (e.g., energy asset anomaly scores, predicted amounts of electrical power, feature contribution values), and maintenance alerts. The agent may be capable of providing responses to users (e.g., technicians) that enhance the usability of alerts described herein. For instance, the responses may provide a user with information concerning which asset should be checked, when did an issue with an associated asset begin, why did a maintenance issue occur, and how the associated maintenance issue can be resolved.

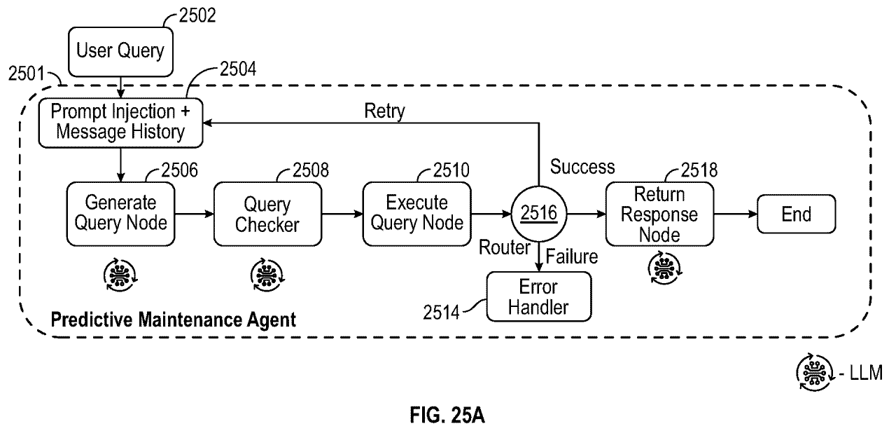

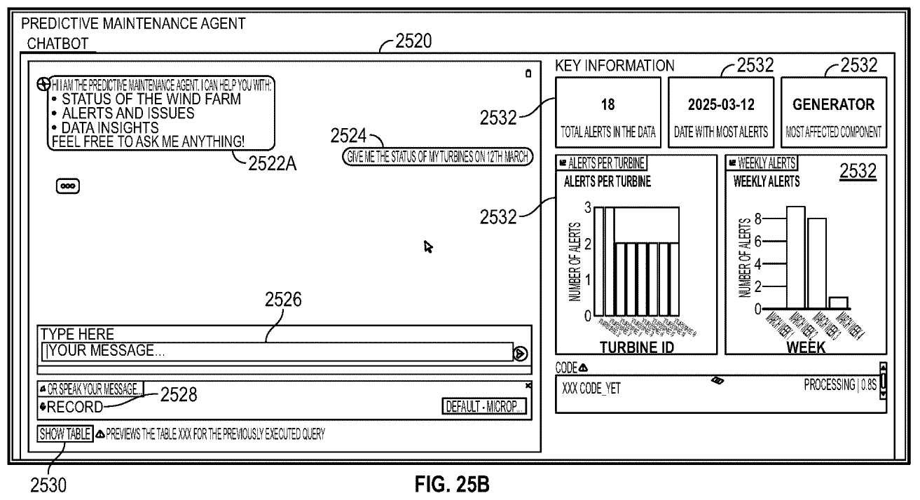

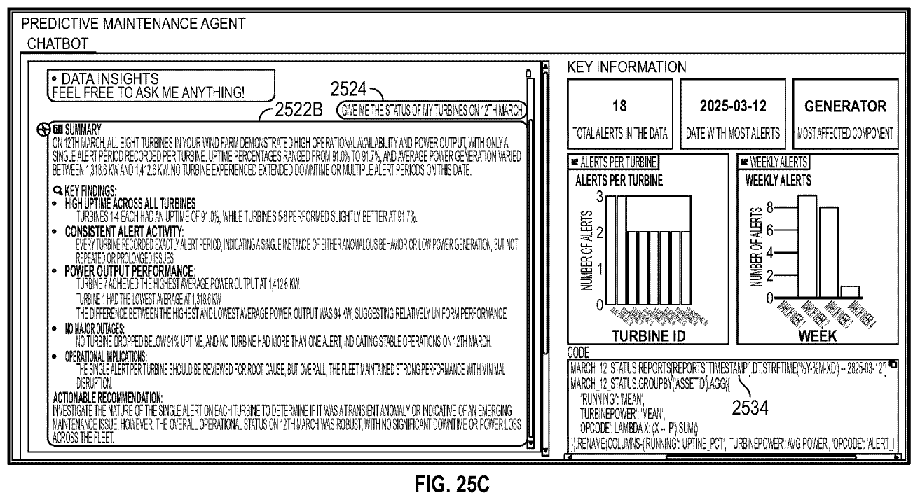

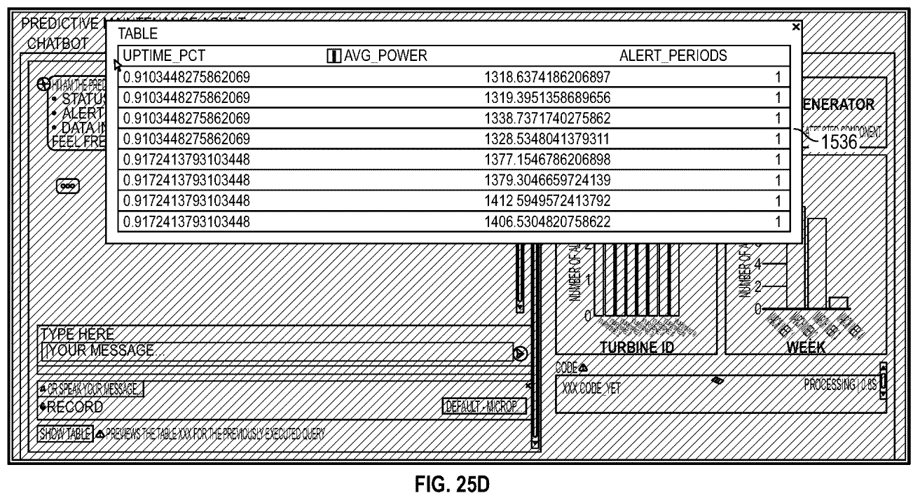

In one embodiment, as depicted with reference to FIG. 25A, an agent 2501 may receive a natural language query from a user via a user interface at 2502. The natural language query may associated with at least one asset (e.g., at least one energy asset) and may relate to investigation of a maintenance alert, historical operating behavior, comparative asset performance, or contributing factors associated with anomalous behavior or underperformance.

Following receipt of the natural language query, at 2504 the agent 2501 may construct an internal prompt by combining the natural language query with contextual information, including message history associated with prior user interactions and system-defined prompt injection content. The prompt injection content may include constraints, schema definitions, or domain-specific instructions that guide subsequent processing.

The agent 2501, at 2506, may then generate a structured query node using a language model. The structured query node may represent a machine-executable query and may reference databases or other storage modules storing asset information, model-generated scores, or maintenance alerts. The agent 2501, at 2508, may perform a query validation operation prior to execution of the structured query node. The query validation operation may be performed using a language model (e.g., a same or different language model used at 2506) or rule-based logic to determine whether the structured query node satisfies predefined correctness, safety, or execution criteria. In response to determining that the structured query node fails to satisfy at least one criterion, the agent 2501 may initiate a retry operation in which a new internal prompt is constructed at 2504.

Once the query validation operation succeeds, the agent 2501 at 2510 may execute the structured query node to obtain a query result data structure. The query result data structure may include data derived from asset information, model-output scores, or maintenance alerts. In response to detecting an error handling operation, the agent 2501 may route execution to an error handling operation at 2514 that generates an error response or may initiate a retry operation (e.g., may proceed to 2504).

Following successful execution, the agent 2501 at 2518 may generate a response node using a language model (e.g., a same or different language model as that used at 2506 or 2508). The response node may include a structured textual response summarizing findings associated with the natural language query and may be generated based on the query result data structure. It should be noted that the agent may be capable of using Shapley values generated during anomaly detection to rank alert predictors based on impact percentage.

In some examples, the user interface through which the agent 2501 may be accessed may be graphical user interface. As depicted in FIG. 25B, the graphical user interface may include a conversational interaction region 2520 configured to receive natural language input. The conversation interaction region may accept textual input (e.g., via user interface control element 2526) or voice-derived input (e.g., via user input to user interface control element 2528) converted into text and may display responses generated by the agent 2501 in a conversation format corresponding to successive user queries. For instance, as depicted in FIG. 25B, the conversational interaction region 2520 may include an initial script provided to the user within user interface display element 2522A of the conversational interaction region 2520. A user may input a natural language input into user interface control element 2526 or may provide voice-derived input via user interface control element 2528 and a corresponding user interface display element 2524 may display within the conversation interaction region 2520 that acts as a receipt of the natural language input. In response to the received natural language input, the conversational interaction region 2520 may display a response 2522B generated by the agent 2501, as depicted in FIG. 25C.

The graphical user interface may further include an analytical context region that is distinct from the conversational interaction region 2520. The analytical context region may display one or more visualizations 2532 derived from previously obtained asset information, model-output scores, or maintenance alerts. The visualizations may include, for instance, temporal trends, asset-level summaries, or comparative performance indicators. In the present example, such visualizations may include a total number of maintenance alerts, a date in which the most alerts were generated, a most affected component (e.g., a component responsible for the greatest number of generated alerts), a quantity of alerts per asset, or a quantity of alerts over the course of a time duration.

In some examples, the graphical user interface may include a query transparency region 2534 (e.g, as depicted in FIG. 25C) configured to display the structured query (e.g., executed code) or the query result data structure obtained from execution of the structured query. The query transparency region may enable inspection of machine-executable logic and underlying data used to generate a corresponding response. The query transparency region may be updated for each new natural language input provided to the conversational interaction region. It should be noted that the query result data structure, in some examples, may be accessed via user input to a user interface control element (e.g., user interface control element 2530 as depicted with reference to FIG. 25B). The resulting query result data structure may then be displayed in a popover 2536 that is triggered via user input to user interface control element 2530 (e.g., as depicted in FIG. 25D).

It shall also be noted that the system and methods of the embodiments and variations described herein can be embodied and/or implemented at least in part as a machine comprising a computer-readable medium storing computer-readable instructions. The instructions may be executed by computer-executable components integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, memory sticks (e.g., SD cards, USB flash drives), cloud-based services (e.g., cloud storage), magnetic storage devices, Solid-State Drives (SSDs), or any suitable device. The computer-executable component is preferably a general or application-specific processor, but any suitable dedicated hardware or hardware/firmware combination device can alternatively or additionally execute the instructions.

It shall be noted that, in the method(s) described herein where one or more steps (e.g., processes) are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The systems and methods of the preferred embodiments may additionally, or alternatively, be implemented on an integrated data analytics software application and/or software architecture such as those offered by SAS Institute Inc. of Cary, N.C., USA. Merely for illustration, the systems and methods of the preferred embodiments may be implemented using or integrated with one or more SAS software tools such as SAS® Viya™ which is developed and provided by SAS Institute Inc. of Cary, N.C., USA.

Although omitted for conciseness, the preferred embodiments include every combination and permutation of the implementations of the systems and methods described herein in real-time or near real-time, asynchronously (e.g., sequentially), concurrently (e.g., in parallel), or in any other suitable order by and/or using one or more instances of the systems, elements, and/or entities described herein. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the application without departing from the scope of the various described embodiments.

What is claimed is:

1. A computer-program product comprising a non-transitory machine-readable storage medium storing computer instructions that, when executed by processing circuitry, perform operations comprising:
receiving, by the processing circuitry, sensor data associated with one or more assets in a target asset hierarchy;
computing, by the processing circuitry, a plurality of enriched features for the one or more assets based on a plurality of sensor features included in the sensor data;
generating, by the processing circuitry, an analytical data structure comprising feature values of the plurality of enriched features and the plurality of sensor features for the one or more assets over a time series;
generating, by the processing circuitry using an anomaly detection model, an anomaly output data structure that extends the analytical data structure to include a set of anomaly score values corresponding to the one or more assets over the time series;
generating, by the processing circuitry using an asset performance prediction model, an asset performance output data structure that extends the anomaly output data structure to include a plurality of predicted asset performance values for the one or more assets over the time series;
inserting, into the asset performance output data structure by the processing circuitry, a plurality of performance disparity values computed based on the plurality of predicted asset performance values and the feature values of a respective sensor feature of the plurality of sensor features in the asset performance output data structure;
detecting, by the processing circuitry using the asset performance output data structure, that a subset of the plurality of performance disparity values or a subset of the set of anomaly score values in the asset performance output data structure satisfy one or more alerting thresholds; and
generating, by the processing circuitry, an asset maintenance alert for one or more assets associated with the subset of the plurality of performance disparity values or the subset of the set of anomaly score values in the asset performance output data structure.

2. The computer-program product according to claim 1, wherein the computer instructions, when executed by the processing circuitry, perform the operations comprising:
training, by the processing circuitry, the anomaly detection model by:
generating, by the processing circuitry, a plurality of binary decision trees based on a corpus of historical sensor data associated with the one or more assets,
determining, by the processing circuitry, an average path length associated with one or more respective historical sensor records of the corpus across the plurality of binary decision trees, and
assigning, by the processing circuitry, an anomaly score value to the one or more respective historical sensor records based on the average path length of the one or more respective historical sensor records.

3. The computer-program product according to claim 2, wherein:
the anomaly score value assigned to a first respective historical sensor record of the one or more respective historical sensor records is higher than the anomaly score value assigned to a second respective historical sensor record of the one or more respective historical sensor records when the average path length of the first respective historical sensor record is shorter than the average path length of the second respective historical sensor record, and
the anomaly score value assigned to the first respective historical sensor record is lower than the anomaly score value assigned to the second respective historical sensor record when the average path length of the first respective historical sensor record is longer than the average path length of the second respective historical sensor record.

4. The computer-program product according to claim 2, wherein the average path length of a respective historical sensor record of the one or more respective historical sensor records is determined based on a number of tree node traversals required to assign the respective historical sensor record to a terminal node in each of the plurality of binary decision trees.

5. The computer-program product according to claim 1, wherein the computer instructions, when executed by the processing circuitry, perform the operations comprising:
training, by the processing circuitry, the asset performance prediction model by:
inputting, to the asset performance prediction model by the processing circuitry, one or more labeled sensor records comprising:
a set of historical feature values associated with the plurality of sensor features and the plurality of enriched features for a respective asset at a respective historical time series value, and
a performance label indicating an observed performance of the respective asset at the respective historical time series value; and
iteratively fitting, by the processing circuitry, a plurality of decision trees to the one or more labeled sensor records, wherein each subsequent decision tree of the plurality of decision trees is fitted to residual errors associated with performance predictions made by one or more previously fitted decision trees of the plurality of decision trees.

6. The computer-program product according to claim 1, wherein the analytical data structure comprises:
one or more columns that correspond to a respective feature of the plurality of sensor features and the plurality of enriched features, and
one or more rows that:
corresponds to a respective asset of the one or more assets,
corresponds to a respective timestamp of the time series, and
includes a subset of the feature values that correspond to the respective asset at the respective timestamp.

7. The computer-program product according to claim 6, wherein the anomaly output data structure that extends the analytical data structure includes:
one or more second columns that corresponds to the one or more columns originating from the analytical data structure and an anomaly score column that stores the set of anomaly score values corresponding to the one or more assets over the time series, and
one or more second rows that corresponds to the one or more rows originating from the analytical data structure and updated to include a respective anomaly score value corresponding to the respective asset at the respective timestamp.

8. The computer-program product according to claim 7, wherein the asset performance output data structure that extends the anomaly output data structure includes:
one or more third columns that correspond to:
the one or more second columns originating from the anomaly output data structure; and
a predicted asset performance column that stores the plurality of predicted asset performance values for the one or more assets over the time series, and
one or more third rows corresponding to the one or more second rows originating from the anomaly output data structure and updated to include a respective predicted asset performance value corresponding to the respective asset at the respective timestamp.

9. The computer-program product according to claim 1, wherein the target asset hierarchy includes:
a root node identifying a deployment region associated with the one or more assets, and
one or more child nodes corresponding to the one or more assets and hierarchically arranged under the root node.

10. The computer-program product according to claim 9, wherein the target asset hierarchy further includes:
one or more second child nodes hierarchically arranged under the one or more child nodes and correspond to one or more subsystems associated with the one or more assets, and
one or more third child nodes hierarchically arranged under the one or more second child nodes and correspond to one or more components associated with the one or more subsystems.

11. The computer-program product according to claim 1, wherein:
the sensor data comprises a plurality of time series sensor records received by a real-time or near real-time event streaming service, and
a respective time series sensor record of the plurality of time series sensor records includes one or more of:
a timestamp associated with the respective time series sensor record,
a name of a respective asset associated with the respective time series sensor record,
a name of a respective sensor feature associated with the respective time series sensor record, and
a value of the respective sensor feature for the respective asset at the timestamp associated with the respective time series sensor record.

12. The computer-program product according to claim 1, wherein:
a first plurality of time series sensor records of the sensor data is associated with a first timestamp of the time series and a first asset of the one or more assets, and
a second plurality of time series sensor records of the sensor data is:
associated with a second timestamp of the time series, different from the first timestamp, and
associated with one of: the first asset or a second asset of the one or more assets.

13. The computer-program product according to claim 12, wherein generating the analytical data structure at least includes:
generating a first row of the analytical data structure that corresponds to the first asset at the first timestamp and comprises first features values for the plurality of sensor features included in the first plurality of time series sensor records, and
generating a second row of the analytical data structure that corresponds to the first asset or the second asset at the second timestamp and comprises second feature values for the plurality of sensor features included in the second plurality of time series sensor records.

14. The computer-program product according to claim 1, wherein generating the analytical data structure includes:
detecting, by the processing circuitry, that a respective enriched feature of the plurality of enriched features has a first feature value in a first row of the analytical data structure,
detecting, by the processing circuitry, that the respective enriched feature of the plurality of enriched features has a second feature value in a second row of the analytical data structure,
determining that the first feature value of the respective enriched feature does not satisfy a filtering criterion and that the second feature value of the respective enriched feature satisfies the filtering criterion,
in response to determining that the first feature value of the respective enriched feature does not satisfy the filtering criterion, removing the first row from the analytical data structure, and
in response to determining that the second feature value of the respective enriched feature satisfies the filtering criterion, maintaining the second row in the analytical data structure.

15. The computer-program product according to claim 1, wherein a respective performance disparity value of the plurality of performance disparity values:
is computed based on a respective predicted asset performance value of a respective asset at a respective timestamp of the time series and a value of the respective sensor feature for the respective asset at the respective timestamp, and
represents a ratio of the value of the respective sensor feature to the respective predicted asset performance value.

16. The computer-program product according to claim 1, wherein:
the plurality of performance disparity values are inserted into the asset performance output data structure after the asset performance prediction model generates the asset performance output data structure, and
inserting the plurality of performance disparity values into the asset performance output data structure includes:
adding, by the processing circuitry, a performance disparity column to the asset performance output data structure, and
updating, by the processing circuitry, one or more rows of the asset performance output data structure to include a respective performance disparity value corresponding to a respective asset at a respective timestamp of the time series.

17. The computer-program product according to claim 1, wherein:
the asset performance output data structure comprises:
a first performance disparity value in a first row associated with a respective asset at a first timestamp of the time series; and
a second performance disparity value in a second row associated with the respective asset at a second timestamp of the time series, and
the one or more alerting thresholds are satisfied when:
the first performance disparity value and the second performance disparity value fall below a performance threshold, and
the first timestamp and the second timestamp satisfy a threshold duration.

18. The computer-program product according to claim 17, wherein:
the asset performance output data structure comprises a respective anomaly score value in the first row associated with the respective asset, and
the one or more alerting thresholds are satisfied when one or more of a first criterion or a second criterion is satisfied, wherein:
the first criterion is satisfied when:
the first performance disparity value and the second performance disparity value fall below the performance threshold; and
the first timestamp and the second timestamp satisfy the threshold duration, and
the second criterion is satisfied when:
the respective anomaly score value exceeds an anomaly threshold.

19. The computer-program product according to claim 18, wherein:
the performance threshold and the threshold duration are extracted from a first file uploaded to a real-time or near real-time event streaming service, and
the anomaly threshold is extracted from a second file, different from the first file, uploaded to the real-time or near real-time event streaming service.

20. The computer-program product according to claim 1, wherein:
a first asset maintenance alert is generated for a respective asset in response to determining that a first row in the asset performance output data structure includes a first performance disparity value or a first anomaly score value that satisfies the one or more alerting thresholds, and
the computer instructions, when executed by the processing circuitry, perform operations comprising:
detecting a second row in the asset performance output data structure corresponds to the respective asset and includes a second respective anomaly score value or a second performance disparity value that satisfies the one or more alerting thresholds,
determining a respective amount of time between a first timestamp of the time series associated with the first row and a second timestamp of the time series associated with the second row, and
generating a second asset maintenance alert for the respective asset if:
the respective amount of time exceeds a predefined alert persistence threshold, and
a number of asset maintenance alerts generated for the respective asset over a specified time interval does not exceed a maximum alert count threshold.

21. The computer-program product according to claim 1, wherein:
a respective performance disparity value in a respective row of the asset performance output data structure satisfies the one or more alerting thresholds, and
generating the asset maintenance alert for a respective asset corresponding to the respective row includes:
extracting, by the processing circuitry, the respective performance disparity value and one or more respective feature values of the plurality of enriched features and the plurality of sensor features from the respective row,
providing, by the processing circuitry, the respective performance disparity value and the one or more respective feature values to a power prediction explainability algorithm,
computing, by the processing circuitry using the power prediction explainability algorithm, a contribution value for the plurality of enriched features and the plurality of sensor features with respect to the respective performance disparity value,
detecting, by the processing circuitry, that the contribution value of a subset of features in the plurality of enriched features and the plurality of sensor features satisfies a contribution threshold, and
adding, to the asset maintenance alert by the processing circuitry, the subset of features identified as contributing to the respective performance disparity value.

22. The computer-program product according to claim 1, wherein:
a respective anomaly score value in a respective row of the asset performance output data structure satisfies the one or more alerting thresholds, and
generating the asset maintenance alert for a respective asset corresponding to the respective row includes:
extracting, by the processing circuitry, the respective anomaly score value and one or more respective feature values of the plurality of enriched features and the plurality of sensor features from the respective row,
providing, by the processing circuitry, the respective anomaly score value and the one or more respective feature values to an anomaly score explainability algorithm,
computing, by the processing circuitry using the anomaly score explainability algorithm, a contribution value for the plurality of enriched features and the plurality of sensor features with respect to the respective anomaly score value,
detecting, by the processing circuitry, that the contribution value of a subset of features in the plurality of enriched features and the plurality of sensor features satisfies a contribution threshold, and
adding, to the asset maintenance alert by the processing circuitry, the subset of features identified as contributing to the respective anomaly score value.

23. The computer-program product according to claim 1, wherein the asset maintenance alert generated for a respective asset is transmitted using an electronic messaging service and includes:
a name of the respective asset,
one or more features of the plurality of enriched features and the plurality of sensor features contributing to the asset maintenance alert, and
a natural language explanation describing why the one or more features are behaving in an abnormal manner.

24. The computer-program product according to claim 1, wherein:
a respective predicted asset performance value of the plurality of predicted asset performance values indicates an expected value for a feature of an asset at a respective time;
a respective row of the asset performance output data structure at least includes:
the respective predicted asset performance value, and
an actual value of the feature at the respective time; and
the computer instructions, when executed by the processing circuitry, perform the operations comprising:
computing a prediction error value between the respective predicted asset performance value and the actual value of the feature,
determining that the prediction error value exceeds a prediction error threshold for a predetermined number of periods, and
in response to determining that the prediction error value exceeds the prediction error threshold for the predetermined number of periods:
designating the asset performance prediction model as requiring retraining, and
retraining the asset performance prediction model based on the designating.

25. The computer-program product according to claim 24, wherein retraining the asset performance prediction model includes updating one or more parameters of the asset performance prediction model using a subset of the feature values included in the respective row as input variables and the actual value of the feature as a target variable.

26. A computer-implemented method, comprising:
receiving, by processing circuitry, sensor data associated with one or more assets in a target asset hierarchy;
computing, by the processing circuitry, a plurality of enriched features for the one or more assets based on a plurality of sensor features included in the sensor data;
generating, by the processing circuitry, an analytical data structure comprising feature values of the plurality of enriched features and the plurality of sensor features for the one or more assets over a time series;
generating, by the processing circuitry using an anomaly detection model, an anomaly output data structure that extends the analytical data structure to include a set of anomaly score values corresponding to the one or more assets over the time series;
generating, by the processing circuitry using an asset performance prediction model, an asset performance output data structure that extends the anomaly output data structure to include a plurality of predicted asset performance values for the one or more assets over the time series;
inserting, into the asset performance output data structure by the processing circuitry, a plurality of performance disparity values computed based on the plurality of predicted asset performance values and the feature values of a respective sensor feature of the plurality of sensor features in the asset performance output data structure;
detecting, by the processing circuitry using the asset performance output data structure, that a subset of the plurality of performance disparity values or a subset of the set of anomaly score values in the asset performance output data structure satisfy one or more alerting thresholds; and
generating, by the processing circuitry, an asset maintenance alert for one or more assets associated with the subset of the plurality of performance disparity values or the subset of the set of anomaly score values in the asset performance output data structure.

27. The computer-implemented method according to claim 26, comprising:
training, by the processing circuitry, the anomaly detection model by:
generating, by the processing circuitry, a plurality of binary decision trees based on a corpus of historical sensor data associated with the one or more assets,
determining, by the processing circuitry, an average path length associated with one or more respective historical sensor records of the corpus across the plurality of binary decision trees, and
assigning, by the processing circuitry, an anomaly score value to the one or more respective historical sensor records based on the average path length of the one or more respective historical sensor records.

28. The computer-implemented method according to claim 27, wherein:
the anomaly score value assigned to a first respective historical sensor record of the one or more respective historical sensor records is higher than the anomaly score value assigned to a second respective historical sensor record of the one or more respective historical sensor records when the average path length of the first respective historical sensor record is shorter than the average path length of the second respective historical sensor record, and
the anomaly score value assigned to the first respective historical sensor record is lower than the anomaly score value assigned to the second respective historical sensor record when the average path length of the first respective historical sensor record is longer than the average path length of the second respective historical sensor record.

29. The computer-implemented method according to claim 27, wherein the average path length of a respective historical sensor record of the one or more respective historical sensor records is determined based on a number of tree node traversals required to assign the respective historical sensor record to a terminal node in each of the plurality of binary decision trees.

30. A computer-implemented system comprising:
processing circuitry;
a memory; and
a computer-readable medium operably coupled to the processing circuitry the computer-readable medium having computer-readable instructions stored thereon that, when executed by the processing circuitry, cause a computing device to perform operations comprising:
receiving, by the processing circuitry, sensor data associated with one or more assets in a target asset hierarchy;
computing, by the processing circuitry, a plurality of enriched features for the one or more assets based on a plurality of sensor features included in the sensor data;
generating, by the processing circuitry, an analytical data structure comprising feature values of the plurality of enriched features and the plurality of sensor features for the one or more assets over a time series;
generating, by the processing circuitry using an anomaly detection model, an anomaly output data structure that extends the analytical data structure to include a set of anomaly score values corresponding to the one or more assets over the time series;
generating, by the processing circuitry using an asset performance prediction model, an asset performance output data structure that extends the anomaly output data structure to include a plurality of predicted asset performance values for the one or more assets over the time series;
inserting, into the asset performance output data structure by the processing circuitry, a plurality of performance disparity values computed based on the plurality of predicted asset performance values and the feature values of a respective sensor feature of the plurality of sensor features in the asset performance output data structure;
detecting, by the processing circuitry using the asset performance output data structure, that a subset of the plurality of performance disparity values or a subset of the set of anomaly score values in the asset performance output data structure satisfy one or more alerting thresholds; and
generating, by the processing circuitry, an asset maintenance alert for one or more assets associated with the subset of the plurality of performance disparity values or the subset of the set of anomaly score values in the asset performance output data structure.
